(19) United States
(12) Patent Application Publication
(10) Pub. No.: US 2024/0333350 A1
(43) Pub. Date: Oct. 3, 2024

(54) MULTIPLE INPUT MULTIPLE OUTPUT CODEBOOKS

(71) Applicant: QUALCOMM Incorporated, San Diego, CA (US)

(72) Inventors: Hyojin LEE, San Diego, CA (US); Yu ZHANG, San Diego, CA (US); Kexin XIAO, Shanghai (CN); Hwan Joon KWON, San Diego, CA (US)

(21) Appl. No.: 18/577,853

(22) PCT Filed: Sep. 6, 2021
(86) PCT No.: PCT/CN2021/116661

§ 371 Date: Jan. 9, 2024

(51) Int. Cl. H04B 7/0456

(52) U.S. Cl. CPC H04B 7/0456

(57) ABSTRACT

Various aspects of the present disclosure generally relate to wireless communication. In some aspects, a wireless communication device may select a codebook for a multiple-input multiple-output (MIMO) communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device. The wireless communication device may transmit or receiving the communication using the codebook. Numerous other aspects are described.

### FIELD OF THE DISCLOSURE

Aspects of the present disclosure generally relate to wireless communication and to techniques and apparatuses for using multiple-input multiple-output codebooks.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a wireless communication device. The method may include selecting a codebook for a multiple-input multiple-output (MIMO) communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device. The method may include transmitting or receiving the communication using the codebook.

Some aspects described herein relate to a wireless communication device for wireless communication. The wireless communication device may include a memory and one or more processors coupled to the memory. The one or more processors may be configured to select a codebook for a MIMO communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device. The one or more processors may be configured to transmit or receiving the communication using the codebook.

Some aspects described herein relate to a non-transitory computer-readable medium that stores a set of instructions for wireless communication by a wireless communication device. The set of instructions, when executed by one or more processors of the wireless communication device, may cause the wireless communication device to select a codebook for a MIMO communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device. The set of instructions, when executed by one or more processors of the wireless communication device, may cause the wireless communication device to transmit or receiving the communication using the codebook.

Some aspects described herein relate to an apparatus for wireless communication. The apparatus may include means for selecting a codebook for a MIMO communication from among one or more codebooks that include one or more of non-coherent codebooks for 6 or 8 antennas of the apparatus, partially-coherent codebooks for multiple paired antennas of the 6 or 8 antennas of the apparatus, or full-coherent codebooks for the 6 or 8 antennas of the apparatus. The apparatus may include means for transmitting or receiving the communication using the codebook.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of antenna ports, in accordance with the present disclosure.

FIG. 4 is a diagram illustrating an example of a legacy 4-antenna Rank 1 codebook, in accordance with the present disclosure.

FIG. 5 is a diagram illustrating an example of transmit precoding matrix indices (TPMIs), in accordance with the present disclosure.

FIG. 6 is a diagram illustrating an example of TPMIs with TPMI changes, in accordance with the present disclosure.

FIG. 7 is a diagram illustrating an example of TPMIs with TPMI changes, in accordance with the present disclosure.

FIG. 8 is a diagram illustrating an example of TPMIs with TPMI changes, in accordance with the present disclosure.

FIG. 9 is a diagram illustrating an example of TPMIs, in accordance with the present disclosure.

FIG. 10 is a diagram illustrating an example of TPMIs, in accordance with the present disclosure.

FIG. 11 is a diagram illustrating an example of TPMIs, in accordance with the present disclosure.

FIG. 12 is a diagram illustrating an example of TPMIs with TPMI changes, in accordance with the present disclosure.

FIG. 13 is a diagram illustrating an example of TPMIs with TPMI changes, in accordance with the present disclosure.

FIG. 14 is a diagram illustrating an example of TPMIs with TPMI changes, in accordance with the present disclosure.

FIG. 15 is a diagram illustrating an example of TPMIs, in accordance with the present disclosure.

FIG. 16 is a diagram illustrating an example of TPMIs with TPMI changes, in accordance with the present disclosure.

FIG. 17 is a diagram illustrating an example of TPMIs with TPMI changes, in accordance with the present disclosure.

FIG. 18 is a diagram illustrating an example of TPMIs, in accordance with the present disclosure.

FIG. 19 is a diagram illustrating an example of TPMIs, in accordance with the present disclosure.

FIG. 20 is a diagram illustrating an example of TPMIs, in accordance with the present disclosure.

FIG. 21 is a diagram illustrating an example process performed, for example, by a wireless communication device, in accordance with the present disclosure.

FIG. 22 is a diagram of an example apparatus for wireless communication, in accordance with the present disclosure.

FIGS. 23-25 show example tables of Rank 2 precoding matrices and corresponding TPMIs for 8 antennas.

FIGS. 26-30 show example tables of Rank 3 precoding matrices and corresponding TPMIs for 8 antennas.

FIGS. 31-32 show example tables of Rank 4 precoding matrices and corresponding TPMIs for 8 antennas.

FIGS. 33A-33B and 34A-34B show example tables of Rank 1 precoding matrices and corresponding TPMIs for 6 antennas.

FIGS. 35A-35B, 36A-36B, 37A-37B, 38A-38B, 39A-39B, and 40A-40B show example tables of Rank 2 precoding matrices and corresponding TPMIs for 6 antennas.

FIGS. 41A-41B, 42A-42B, 43A-43B, 44A-44B, and 45A-45B show example tables of Rank 3 precoding matrices and corresponding TPMIs for 6 antennas.

FIGS. 46A-46B and 47A-47B show example tables of Rank 4 precoding matrices and corresponding TPMIs for 6 antennas.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

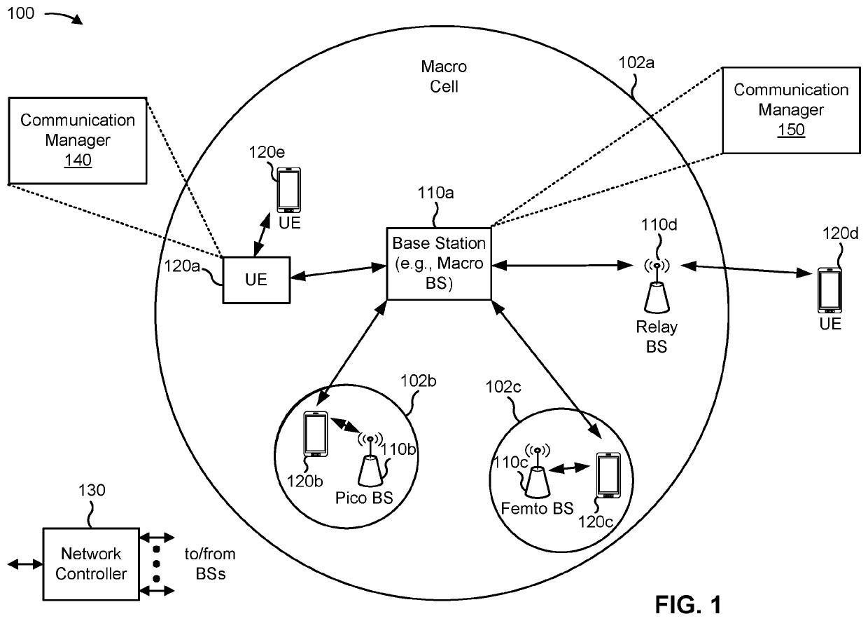

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the wireless communication device may include a communication manager 140 or a communication manager 150. As described in more detail elsewhere herein, the communication manager 140 or the communication manager 150 may select a codebook for a multiple-input multiple-output (MIMO) communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device; and transmit or receiving the communication using the codebook. Additionally, or alternatively, the communication manager 140 or the communication manager 150 may perform one or more other operations described herein. Examples of the one or more codebooks are described herein.

As indicated above, FIG. 1 is provided as an example. Other examples may differ from what is described with regard to FIG. 1.

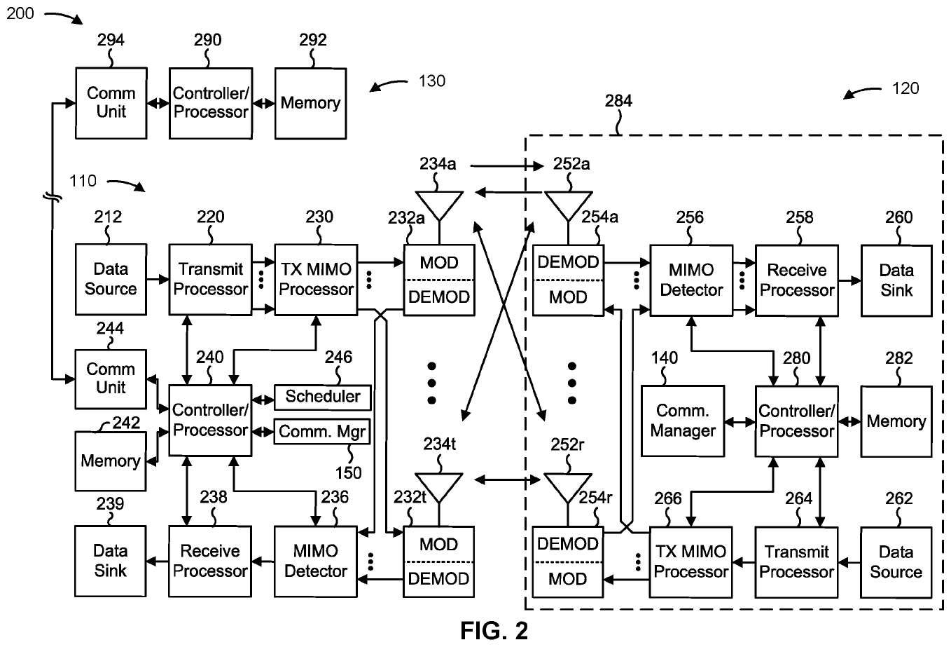

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) MIMO processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

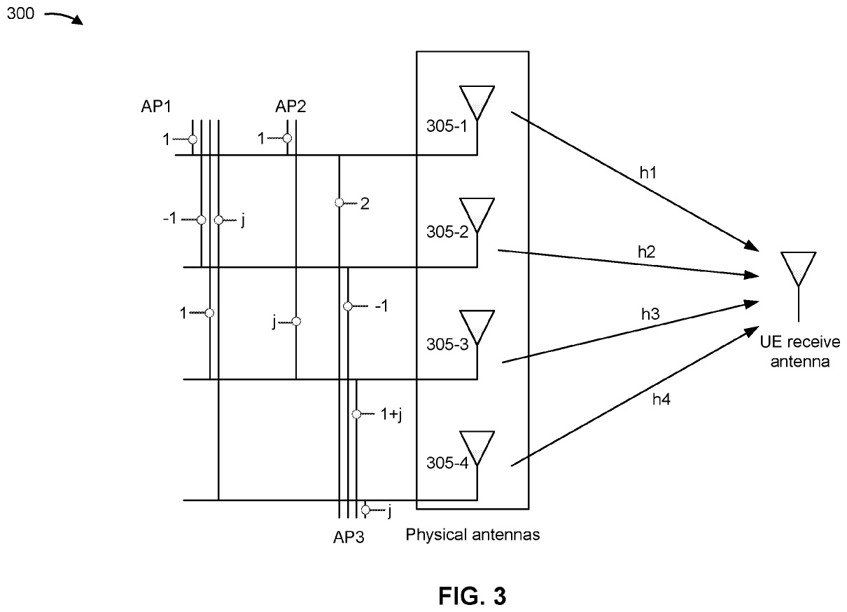

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-47).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-47).

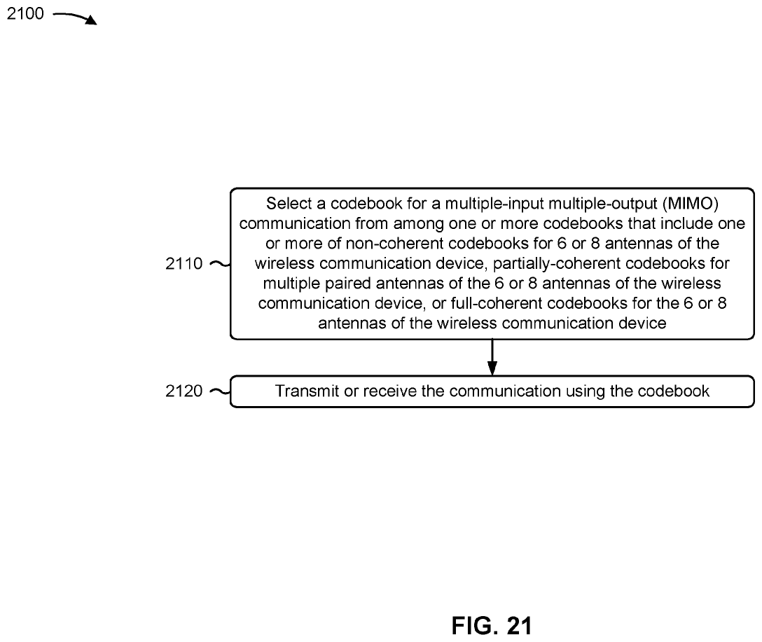

The controller/processor 240 of the base station 110, the controller/processor 280 of the UE 120, and/or any other component(s) of FIG. 2 may perform one or more techniques associated with using MIMO codebooks for 6 or 8 antennas, as described in more detail elsewhere herein. In some aspects, the wireless communication device described herein is the UE 120, is included in the UE 120, or includes one or more components of the UE 120 shown in FIG. 2. In some aspects, the wireless communication device described herein is the base station 110, is included in the base station 110, or includes one or more components of the base station 110 shown in FIG. 2. For example, the controller/processor 240 of the base station 110, the controller/processor 280 of the UE 120, and/or any other component(s) of FIG. 2 may perform or direct operations of, for example, process 2100 of FIG. 21, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 2100 FIG. 21, and/or other processes as described herein. In some examples, executing instructions may include running the instructions, converting the instructions, compiling the instructions, and/or interpreting the instructions, among other examples.

In some aspects, the wireless communication device includes means for selecting a codebook for a MIMO communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device; and/or means for transmitting or receiving the communication using the codebook. In some aspects, the means for the wireless communication device to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246. In some aspects, the means for the wireless communication device to perform operations described herein may include, for example, one or more of communication manager 140, antenna 252, modem 254, MIMO detector 256, receive processor 258, transmit processor 264, TX MIMO processor 266, controller/processor 280, or memory 282. Examples of the one or more codebooks are described herein.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 is a diagram illustrating an example 300 of antenna ports, in accordance with the present disclosure.

UEs may have up to 4 antennas. As shown in FIG. 3, a first physical antenna 305-1 may transmit information via a first channel h1, a second physical antenna 305-2 may transmit information via a second channel h2, a third physical antenna 305-3 may transmit information via a third channel h3, and a fourth physical antenna 305-4 may transmit information via a fourth channel h4. Such information may be conveyed via a logical antenna port, which may represent some combination of the physical antennas and/or channels. In some cases, a UE 120 may not have knowledge of the channels associated with the physical antennas, and the UE 120 may only operate based on knowledge of the channels associated with antenna ports, as defined below.

An antenna port may be defined such that a channel, over which a symbol on the antenna port is conveyed, can be inferred from a channel over which another symbol on the same antenna port is conveyed. In example 300, a channel associated with antenna port 1 (AP1) is represented as h1−h2+h3+j*h4, where channel coefficients (e.g., 1, −1, 1, and j(\sqrt{−1}), in this case) represent weighting factors (e.g., indicating phase and/or gain) applied to each channel. Such weighting factors may be applied to the channels to improve signal power and/or signal quality at one or more receivers. Applying such weighting factors to channel transmissions may be referred to as precoding, and a precoder may refer to a specific set of weighting factors applied to a set of channels.

Similarly, a channel associated with antenna port 2 (AP2) is represented as h1+j*h3, and a channel associated with antenna port 3 (AP3) is represented as 2*h1−h2+(1+j)*h3+j*h4. In this case, antenna port 3 can be represented as the sum of antenna port 1 and antenna port 2 (e.g., AP3=AP1+AP2) because the sum of the expression representing antenna port 1 (h1−h2+h3+j*h4) and the expression representing antenna port 2 (h1+j*h3) equals the expression representing antenna port 3 (2*h1−h2+(1+j)*h3+j*h4). It can also be said that antenna port 3 is related to antenna ports 1 and 2 [AP1,AP2] via the precoder [1,1] because 1 times the expression representing antenna port 1 plus 1 times the expression representing antenna port 2 equals the expression representing antenna port 3.

Some advanced UEs may have more than four antennas (ports). The advanced UEs may also have more relaxed power constraints and better performance than conventional UEs. Advanced UEs may include, for example, smartphones, indoor/outdoor CPEs, tablets, or laptop computers. Further enhancements may include more than 4 downlink layers, more than 4 uplink ports, and new DMRS, sounding reference signal (SRS), or codebook designs.

Precoding is a technique that exploits transmit diversity by multiplying a data stream (layer) with beamforming weights for each antenna prior to transmission. Precoding may include mapping multiple individual layers to multiple antennas. A (precoding matrix) codebook may be a matrix of vector values (channel coefficients) that are used for the precoding. A rank of a codebook may correspond to a quantity of layers. For example, a rank 1 codebook may be for one layer (data stream), while a rank 4 codebook may be for 4 layers.

Since a large number of antennas (e.g., greater than 4 antennas) are being considered for mobile devices and larger sized devices that utilize NR technologies, support for 6 or 8 antennas for uplink transmission may improve NR performance. Thus far, codebooks for 2 or 4 antennas (ranks 1-4) have been supported. Efficient codebook designs for 6 or 8 ports have not been specified.

According to various aspects described herein, a wireless communication device may select a codebook from among one or more codebooks that include non-coherent codebooks for 6 or 8 antennas of the wireless communication device (where 1 antenna is activated), partially-coherent codebooks for multiple paired antennas of the 6 or 8 antennas of the wireless communication device (where 2 or 4 antennas are activated, for example), or full-coherent codebooks for the 6 or 8 antennas of the wireless communication device (where all 6 or 8 antennas are activated). The wireless communication device may transmit or receive a communication using the codebook. In some aspects, codebooks may be designed for various ranks. Example designs for codebooks are provided herein. Such codebooks may provide for high performance and efficient use of resources for wireless communication devices with 6, 8, or more antennas.

In some aspects, antennas ports may be paired or grouped for partially-coherent codebooks. For example, antennas 0-4, 1-5, 2-6, 3-7 may be paired for 8 antennas in a 2-port partially-coherent scenario. Antennas 0-4-1-5 and 2-6-3-7 may be paired for 8 antennas in a 4-port partially coherent scenario. Higher layer signaling may indicate to a UE which antenna ports or antenna port pairs may be used and an indication from the base station (e.g., uplink grant) may specify which antenna ports or antenna port pairs are to be used.

The codebooks in a set of codebooks may be down-selected to a smaller set of codebooks to reduce processing complexity. For example, some codebooks may use only antennas 0, 4, 2, and 6, if such ports output higher powers. In some aspects, the UE may be configured with many (or all) possible codebooks, but may down-select (e.g., by indication in an uplink grant from the base station) the codebooks from which the UE is to select. The UE may select a codebook to use with each uplink grant.

The wireless communication device may use a transmit precoding matrix index (TPMI) to indicate or receive one or more precoding matrices or codebooks. For example, a base station may select a precoding matrix and a corresponding TPMI with a transmit codebook based at least in part on uplink channel estimation (of an SRS). The base station may transmit, to a UE, a physical downlink control channel (PDCCH) communication for an uplink grant, and the PDCCH communication may include a TPMI and rank information. The UE may use the precoding matrix indicated by the TPMI for a communication on a physical downlink shared channel (PDSCH). In some aspects, TPMIs may be designed, and codebooks may be subsampled to reduce TPMI payload sizes. This may include a lower oversampling factor and/or a reduced co-phasing alphabet. Example designs for such TPMIs are provided herein.

As indicated above, FIG. 3 is provided merely as an example. Other examples may differ from what is described with regard to FIG. 3.

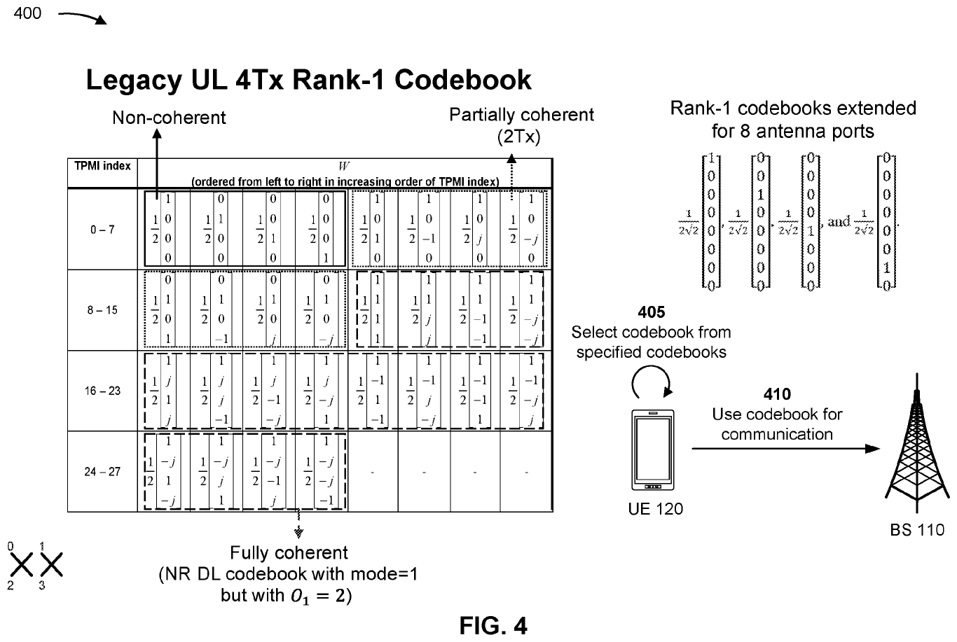

FIG. 4 is a diagram illustrating an example 400 of a legacy 4-antenna Rank 1 codebook, in accordance with the present disclosure. Example 400 shows a legacy uplink (UL) table of codebooks for 4 antennas with Rank 1.

Example 400 shows 4 non-coherent codebooks framed with a solid border, 8 partially-coherent (paired antennas 0 and 2, paired antennas 1 and 3) codebooks framed with a dot border, and 16 codebooks framed with a dash border. A column or vector in a precoding matrix codebook may indicate vector values for each antenna (e.g., 4 vector values in a column for 4 antennas). The vector values may be directional values of 1, −1, j (imaginary value \sqrt{−1}), or −j, which may correspond to phase shifts. A value of 0 means that the antenna is not used. There may be multiple columns for multiple layers (ranks). The table in example 400 includes TPMIs (0-27) that identify each of the codebooks. Oversampling may use a factor O for obtaining a finer granularity in the angular domain than what codebook is able to provide. O₁ and O₂ may represent oversampling factors in horizontal and vertical directions. The table in example 400 is for a downlink oversampling direction O₁ that has a factor of 2.

A non-coherent (precoding matrix) codebook for 4 antennas may include Rank 1 codebooks of:

$$\frac{1}{2} [ \begin{matrix}1 \\ 0 \\ 0 \\ 0\end{matrix} ] , \frac{1}{2} [ \begin{matrix}0 \\ 1 \\ 0 \\ 0\end{matrix} ] , \frac{1}{2} [ \begin{matrix}0 \\ 0 \\ 1 \\ 0\end{matrix} ] , and \frac{1}{2} [ \begin{matrix}0 \\ 0 \\ 0 \\ 1\end{matrix} ] .$$

In some aspects, the codebooks may be extended for 8 antennas. After down selection from 8 precoders for antennas (ports) 0-4-2-6, the Rank 1 codebooks for 8 antennas may include:

$$\frac{1}{2 √ 2} [ \begin{matrix}1 \\ 0 \\ 0 \\ 0 \\ 0 \\ 0 \\ 0 \\ 0\end{matrix} ] , \frac{1}{2 √ 2} [ \begin{matrix}0 \\ 0 \\ 1 \\ 0 \\ 0 \\ 0 \\ 0 \\ 0\end{matrix} ] , \frac{1}{2 √ 2} [ \begin{matrix}0 \\ 0 \\ 0 \\ 0 \\ 1 \\ 0 \\ 0 \\ 0\end{matrix} ] , and \frac{1}{2 √ 2} [ \begin{matrix}0 \\ 0 \\ 0 \\ 0 \\ 0 \\ 0 \\ 1 \\ 0\end{matrix} ] .$$

Rank 2 codebooks for 8 antennas may be down-selected from 28 codebooks to:

$$\frac{1}{2 √ 2} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ] , \frac{1}{2 √ 2} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] , \frac{1}{2 √ 2} [ \begin{matrix}1 & 0 \\ 0 & 0 \\ 0 & 0 \\ 0 & 0 \\ 0 & 0 \\ 0 & 0 \\ 0 & 1 \\ 0 & 0\end{matrix} ] , \\ \frac{1}{2 √ 2} [ \begin{matrix}0 & 0 \\ 0 & 0 \\ 1 & 0 \\ 0 & 0 \\ 0 & 1 \\ 0 & 0 \\ 0 & 0 \\ 0 & 0\end{matrix} ] , \frac{1}{2 √ 2} [ \begin{matrix}0 & 0 \\ 0 & 0 \\ 1 & 0 \\ 0 & 0 \\ 0 & 0 \\ 0 & 0 \\ 0 & 1 \\ 0 & 0\end{matrix} ] , and \frac{1}{2 √ 2} [ \begin{matrix}0 & 0 \\ 0 & 0 \\ 0 & 0 \\ 0 & 0 \\ 1 & 0 \\ 0 & 0 \\ 0 & 1 \\ 0 & 0\end{matrix} ] .$$

Rank 3 codebooks for 8 antennas may be down-selected from 56 precoders to:

$$\frac{1}{2 √ 2} [ \begin{matrix}1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0 \\ 0 & 0 & 0\end{matrix} ] , \frac{1}{2 √ 2} [ \begin{matrix}1 & 0 & 0 \\ 0 & 0 & 0 \\ 0 & 1 & 0 \\ 0 & 0 & 0 \\ 0 & 0 & 0 \\ 0 & 0 & 0 \\ 0 & 0 & 1 \\ 0 & 0 & 0\end{matrix} ] , \frac{1}{2 √ 2} [ \begin{matrix}1 & 0 & 0 \\ 0 & 0 & 0 \\ 0 & 0 & 0 \\ 0 & 0 & 0 \\ 0 & 1 & 0 \\ 0 & 0 & 0 \\ 0 & 0 & 1 \\ 0 & 0 & 0\end{matrix} ] , and \frac{1}{2 √ 2} [ \begin{matrix}0 & 0 & 0 \\ 0 & 0 & 0 \\ 1 & 0 & 0 \\ 0 & 0 & 0 \\ 0 & 1 & 0 \\ 0 & 0 & 0 \\ 0 & 0 & 1 \\ 0 & 0 & 0\end{matrix} ] .$$

Rank 4 codebooks for 8 antennas may be down-selected from 70 precoders to:

$$\frac{1}{2 √ 2} [ \begin{matrix}1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1 \\ 0 & 0 & 0 & 0\end{matrix} ] .$$

Antenna pairing and down-selection may be specified in stored configuration information or indicated from higher layer signaling via a medium access control control element (MAC CE) or a radio resource control (RRC) message.

In some aspects, partially-coherent codebooks for 8 antennas with 2-antenna pairing (e.g., 0-4, 1-5, 2-6, 3-7) may include, for Rank 1:

$$\frac{1}{2 √ 2} [ \begin{matrix}1 \\ 0 \\ 0 \\ 0 \\ 1 \\ 0 \\ 0 \\ 0\end{matrix} ] , \frac{1}{2 √ 2} [ \begin{matrix}1 \\ 0 \\ 0 \\ 0 \\ - 1 \\ 0 \\ 0 \\ 0\end{matrix} ] , \frac{1}{2 √ 2} [ \begin{matrix}1 \\ 0 \\ 0 \\ 0 \\ j \\ 0 \\ 0 \\ 0\end{matrix} ] , \frac{1}{2 √ 2} [ \begin{matrix}1 \\ 0 \\ 0 \\ 0 \\ - j \\ 0 \\ 0 \\ 0\end{matrix} ] , \frac{1}{2 √ 2} [ \begin{matrix}0 \\ 1 \\ 0 \\ 0 \\ 0 \\ 1 \\ 0 \\ 0\end{matrix} ] , \\ \frac{1}{2 √ 2} [ \begin{matrix}0 \\ 1 \\ 0 \\ 0 \\ 0 \\ - 1 \\ 0 \\ 0\end{matrix} ] , \frac{1}{2 √ 2} [ \begin{matrix}0 \\ 1 \\ 0 \\ 0 \\ 0 \\ j \\ 0 \\ 0\end{matrix} ] , \frac{1}{2 √ 2} [ \begin{matrix}0 \\ 1 \\ 0 \\ 0 \\ 0 \\ - j \\ 0 \\ 0\end{matrix} ] , \frac{1}{2 √ 2} [ \begin{matrix}0 \\ 0 \\ 1 \\ 0 \\ 0 \\ 0 \\ 1 \\ 0\end{matrix} ] , \frac{1}{2 √ 2} [ \begin{matrix}0 \\ 0 \\ 1 \\ 0 \\ 0 \\ 0 \\ - 1 \\ 0\end{matrix} ] , \\ \frac{1}{2 √ 2} [ \begin{matrix}0 \\ 0 \\ 1 \\ 0 \\ 0 \\ 0 \\ j \\ 0\end{matrix} ] , \frac{1}{2 √ 2} [ \begin{matrix}0 \\ 0 \\ 1 \\ 0 \\ 0 \\ 0 \\ - j \\ 0\end{matrix} ] , \frac{1}{2 √ 2} [ \begin{matrix}0 \\ 0 \\ 0 \\ 1 \\ 0 \\ 0 \\ 0 \\ 1\end{matrix} ] , \frac{1}{2 √ 2} [ \begin{matrix}0 \\ 0 \\ 0 \\ 1 \\ 0 \\ 0 \\ 0 \\ - 1\end{matrix} ] , \frac{1}{2 √ 2} [ \begin{matrix}0 \\ 0 \\ 0 \\ 1 \\ 0 \\ 0 \\ 0 \\ j\end{matrix} ] , and \frac{1}{2 √ 2} [ \begin{matrix}0 \\ 0 \\ 0 \\ 1 \\ 0 \\ 0 \\ 0 \\ - j\end{matrix} ] .$$

There may be 4 precoders (precoding matrices) per antenna pair. Down-selection may be applied (e.g., 0-4, 2-6) to reduce the 16 codebooks to 8 codebooks. Rank 2 partially-coherent codebooks for 8 antennas may include an antenna pairing of 0-4, 1-5, 2-6, 3-7, antenna grouping of (0-4, 1-5) or (2-6, 3-7), or down-selection to (0-4, 2-6). The Rank 2 codebooks may include:

$$\frac{1}{2 √ 2} [ \begin{matrix}1 & 0 \\ 0 & 0 \\ 0 & 1 \\ 0 & 0 \\ 1 & 0 \\ 0 & 0 \\ 0 & - j \\ 0 & 0\end{matrix} ] , \frac{1}{2 √ 2} [ \begin{matrix}1 & 0 \\ 0 & 0 \\ 0 & 1 \\ 0 & 0 \\ 1 & 0 \\ 0 & 0 \\ 0 & j \\ 0 & 0\end{matrix} ] , \frac{1}{2 √ 2} [ \begin{matrix}1 & 0 \\ 0 & 0 \\ 0 & 1 \\ 0 & 0 \\ - j & 0 \\ 0 & 0 \\ 0 & 1 \\ 0 & 0\end{matrix} ] , \frac{1}{2 √ 2} [ \begin{matrix}1 & 0 \\ 0 & 0 \\ 0 & 1 \\ 0 & 0 \\ - j & 0 \\ 0 & 0 \\ 0 & - 1 \\ 0 & 0\end{matrix} ] , \\ \frac{1}{2 √ 2} [ \begin{matrix}1 & 0 \\ 0 & 0 \\ 0 & 1 \\ 0 & 0 \\ - 1 & 0 \\ 0 & 0 \\ 0 & - j \\ 0 & 0\end{matrix} ] , \frac{1}{2 √ 2} [ \begin{matrix}1 & 0 \\ 0 & 0 \\ 0 & 1 \\ 0 & 0 \\ - 1 & 0 \\ 0 & 0 \\ 0 & j \\ 0 & 0\end{matrix} ] , \frac{1}{2 √ 2} [ \begin{matrix}1 & 0 \\ 0 & 0 \\ 0 & 1 \\ 0 & 0 \\ j & 0 \\ 0 & 0 \\ 0 & 1 \\ 0 & 0\end{matrix} ] , and \frac{1}{2 √ 2} [ \begin{matrix}1 & 0 \\ 0 & 0 \\ 0 & 1 \\ 0 & 0 \\ j & 0 \\ 0 & 0 \\ 0 & - 1 \\ 0 & 0\end{matrix} ] .$$

Partially-coherent codebooks with 4 of 8 antennas for Rank 1 may include, with antenna grouping (0-4-1-5) or (2-6-3-7), or with down-selection to (0-4-2-6):

$$\frac{1}{2 √ 2} [ \begin{matrix}1 \\ 0 \\ 1 \\ 0 \\ 1 \\ 0 \\ 1 \\ 0\end{matrix} ] , \frac{1}{2 √ 2} [ \begin{matrix}1 \\ 0 \\ 1 \\ 0 \\ j \\ 0 \\ j \\ 0\end{matrix} ] , \frac{1}{2 √ 2} [ \begin{matrix}1 \\ 0 \\ 1 \\ 0 \\ - 1 \\ 0 \\ - 1 \\ 0\end{matrix} ] , \frac{1}{2 √ 2} [ \begin{matrix}1 \\ 0 \\ 1 \\ 0 \\ - j \\ 0 \\ - j \\ 0\end{matrix} ] , \frac{1}{2 √ 2} [ \begin{matrix}1 \\ 0 \\ j \\ 0 \\ 1 \\ 0 \\ j \\ 0\end{matrix} ] , \frac{1}{2 √ 2} [ \begin{matrix}1 \\ 0 \\ j \\ 0 \\ j \\ 0 \\ - 1 \\ 0\end{matrix} ] , \\ \frac{1}{2 √ 2} [ \begin{matrix}1 \\ 0 \\ j \\ 0 \\ - 1 \\ 0 \\ - j \\ 0\end{matrix} ] , \frac{1}{2 √ 2} [ \begin{matrix}1 \\ 0 \\ j \\ 0 \\ - j \\ 0 \\ 1 \\ 0\end{matrix} ] , \frac{1}{2 √ 2} [ \begin{matrix}1 \\ 0 \\ - 1 \\ 0 \\ 1 \\ 0 \\ - 1 \\ 0\end{matrix} ] , \frac{1}{2 √ 2} [ \begin{matrix}1 \\ 0 \\ - 1 \\ 0 \\ j \\ 0 \\ - j \\ 0\end{matrix} ] , \frac{1}{2 √ 2} [ \begin{matrix}1 \\ 0 \\ - 1 \\ 0 \\ - 1 \\ 0 \\ 1 \\ 0\end{matrix} ] , \\ \frac{1}{2 √ 2} [ \begin{matrix}1 \\ 0 \\ - 1 \\ 0 \\ - j \\ 0 \\ j \\ 0\end{matrix} ] , \frac{1}{2 √ 2} [ \begin{matrix}1 \\ 0 \\ - j \\ 0 \\ 1 \\ 0 \\ - j \\ 0\end{matrix} ] , \frac{1}{2 √ 2} [ \begin{matrix}1 \\ 0 \\ - j \\ 0 \\ j \\ 0 \\ 1 \\ 0\end{matrix} ] , \frac{1}{2 √ 2} [ \begin{matrix}1 \\ 0 \\ - j \\ 0 \\ - 1 \\ 0 \\ j \\ 0\end{matrix} ] , and \frac{1}{2 √ 2} [ \begin{matrix}1 \\ 0 \\ - j \\ 0 \\ - j \\ 0 \\ - 1 \\ 0\end{matrix} ] .$$

Additional subsampling with O₁=1 and/or binary phase shift keying (BPSK) co-phasing may be considered.

In some aspects, partially-coherent Rank 2 codebooks for 4 of 8 antennas may include an antenna grouping of (0-4-1-5, 2-6-3-7). Such codebooks may include:

$$\frac{1}{2 √ 2} [ \begin{matrix}1 & 0 \\ 1 & 0 \\ 0 & 1 \\ 0 & 1 \\ 1 & 0 \\ 1 & 0 \\ 0 & - 1 \\ 0 & - 1\end{matrix} ] , \frac{1}{2 √ 2} [ \begin{matrix}1 & 0 \\ 1 & 0 \\ 0 & 1 \\ 0 & 1 \\ j & 0 \\ j & 0 \\ 0 & - j \\ 0 & - j\end{matrix} ] , \frac{1}{2 √ 2} [ \begin{matrix}1 & 0 \\ j & 0 \\ 0 & 1 \\ 0 & 1 \\ 1 & 0 \\ j & 0 \\ 0 & - 1 \\ 0 & - j\end{matrix} ] , \frac{1}{2 √ 2} [ \begin{matrix}1 & 0 \\ j & 0 \\ 0 & 1 \\ 0 & j \\ j & 0 \\ - 1 & 0 \\ 0 & - j \\ 0 & 1\end{matrix} ] , \\ \frac{1}{2 √ 2} [ \begin{matrix}1 & 0 \\ - 1 & 0 \\ 0 & 1 \\ 0 & - 1 \\ 1 & 0 \\ - 1 & 0 \\ 0 & - 1 \\ 0 & 1\end{matrix} ] , \frac{1}{2 √ 2} [ \begin{matrix}1 & 0 \\ - 1 & 0 \\ 0 & 1 \\ 0 & - 1 \\ j & 0 \\ - j & 0 \\ 0 & - j \\ 0 & j\end{matrix} ] , \frac{1}{2 √ 2} [ \begin{matrix}1 & 0 \\ - j & 0 \\ 0 & 1 \\ 0 & - j \\ 1 & 0 \\ - j & 0 \\ 0 & - 1 \\ 0 & j\end{matrix} ] , and \frac{1}{2 √ 2} [ \begin{matrix}1 & 0 \\ - j & 0 \\ 0 & 1 \\ 0 & - j \\ j & 0 \\ 1 & 0 \\ 0 & - j \\ 0 & - 1\end{matrix} ] .$$

Partially-coherent Rank 2 codebooks for 4 of 8 antennas may include an antenna grouping of (0-4-2-6, 1-5-3-7). Such codebooks may include:

$$\frac{1}{2 √ 2} [ \begin{matrix}1 & 0 \\ 0 & 1 \\ 1 & 0 \\ 0 & 1 \\ 1 & 0 \\ 0 & - 1 \\ 1 & 0 \\ 0 & - 1\end{matrix} ] , \frac{1}{2 √ 2} [ \begin{matrix}1 & 0 \\ 0 & 1 \\ 1 & 0 \\ 0 & 1 \\ j & 0 \\ 0 & - j \\ j & 0 \\ 0 & - j\end{matrix} ] , \frac{1}{2 √ 2} [ \begin{matrix}1 & 0 \\ 0 & 1 \\ j & 0 \\ 0 & j \\ 1 & 0 \\ 0 & - 1 \\ j & 0 \\ 0 & - j\end{matrix} ] , \frac{1}{2 √ 2} [ \begin{matrix}1 & 0 \\ 0 & 1 \\ j & 0 \\ 0 & j \\ j & 0 \\ 0 & - j \\ - 1 & 0 \\ 0 & 1\end{matrix} ] , \\ \frac{1}{2 √ 2} [ \begin{matrix}1 & 0 \\ 0 & 1 \\ - 1 & 0 \\ 0 & - 1 \\ 1 & 0 \\ 0 & - 1 \\ - 1 & 0 \\ 0 & 1\end{matrix} ] , \frac{1}{2 √ 2} [ \begin{matrix}1 & 0 \\ 0 & 1 \\ - 1 & 0 \\ 0 & - 1 \\ j & 0 \\ 0 & - j \\ - j & 0 \\ 0 & j\end{matrix} ] , \frac{1}{2 √ 2} [ \begin{matrix}1 & 0 \\ 0 & 1 \\ - j & 0 \\ 0 & - j \\ 1 & 0 \\ 0 & - 1 \\ - j & 0 \\ 0 & j\end{matrix} ] and , \frac{1}{2 √ 2} [ \begin{matrix}1 & 0 \\ 0 & 1 \\ - j & 0 \\ 0 & - j \\ j & 0 \\ 0 & - j \\ 1 & 0 \\ 0 & - 1\end{matrix} ] .$$

Partially-coherent Rank 2 codebooks for 4 of 8 antennas may include an antenna down-selection of (0-4-2-6, 0-4-2-6). Such codebooks may include:

$$\frac{1}{4} [ \begin{matrix}1 & 1 \\ 0 & 0 \\ 1 & 1 \\ 0 & 0 \\ 1 & - 1 \\ 0 & 0 \\ 1 & - 1 \\ 0 & 0\end{matrix} ] , \frac{1}{4} [ \begin{matrix}1 & 1 \\ 0 & 0 \\ 1 & 1 \\ 0 & 0 \\ 1 & - j \\ 0 & 0 \\ j & - j \\ 0 & 0\end{matrix} ] , \frac{1}{4} [ \begin{matrix}1 & 1 \\ 0 & 0 \\ j & j \\ 0 & 0 \\ 1 & - 1 \\ 0 & 0 \\ j & - j \\ 0 & 0\end{matrix} ] , \frac{1}{4} [ \begin{matrix}1 & 1 \\ 0 & 0 \\ j & j \\ 0 & 0 \\ j & - j \\ 0 & 0 \\ - 1 & 1 \\ 0 & 0\end{matrix} ] , \\ \frac{1}{4} [ \begin{matrix}1 & 1 \\ 0 & 0 \\ - 1 & - 1 \\ 0 & 0 \\ 1 & - 1 \\ 0 & 0 \\ - 1 & 1 \\ 0 & 0\end{matrix} ] , \frac{1}{4} [ \begin{matrix}1 & 1 \\ 0 & 0 \\ - 1 & - 1 \\ 0 & 0 \\ j & - j \\ 0 & 0 \\ - j & j \\ 0 & 0\end{matrix} ] , \frac{1}{4} [ \begin{matrix}1 & 1 \\ 0 & 0 \\ - j & - j \\ 0 & 0 \\ 1 & - 1 \\ 0 & 0 \\ - j & j \\ 0 & 0\end{matrix} ] and , \frac{1}{4} [ \begin{matrix}1 & 1 \\ 0 & 0 \\ - j & - j \\ 0 & 0 \\ j & - j \\ 0 & 0 \\ 1 & - 1 \\ 0 & 0\end{matrix} ] .$$

In some aspects, full-coherent codebooks may be used for 8 antennas. For example, an NR downlink codebook with mode=1 (codebook used for uplink) and a smaller O₁ value may be:

$$\frac{1}{√ 8} [ \begin{matrix}[ \begin{matrix}1 \\ {e}^{j π {i}_{1} / 4} \\ {e}^{j 2 π {i}_{1} / 4} \\ {e}^{j 3 π {i}_{1} / 4}\end{matrix} ] \\ {e}^{j π {i}_{2} / 2} [ \begin{matrix}1 \\ {e}^{j π {i}_{1} / 4} \\ {e}^{j 2 π {i}_{1} / 4} \\ {e}^{j 3 π {i}_{1} / 4}\end{matrix} ]\end{matrix} ] , \\ where {i}_{1} = 0 , … , 7 , and where {i}_{2} = 0 , 1 , 2 , 3 or {i}_{2} = 0 , 2 .$$

The index i₁ may be for 8 antennas, and the index i₂ may be for antenna grouping and/or downselection. In another example, a codebook may be:

$$\{ \frac{1}{4} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1 , 1}}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & - {e}^{j π i 2 / 2} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ]\end{matrix} ] \} , \\ where {i}_{1} = 0 , … , 7 , and where {i}_{2} = 0 , 1 .$$

In some aspects, codebooks for 4 antennas and co-phasing may be associated with a codebook

$$W = \frac{1}{√ 8} [ \begin{matrix}{W}_{4} \\ φ {W}_{4}\end{matrix} ] ,$$

where co-phasing parameter φ∈{1,j,−1,−j} or {1, −1}, and W₄ includes one or more codebooks from among:

$$[ \begin{matrix}1 \\ 1 \\ 1 \\ 1\end{matrix} ] , [ \begin{matrix}\begin{matrix}1 \\ j \\ - 1\end{matrix} \\ - j\end{matrix} ] , [ \begin{matrix}\begin{matrix}1 \\ - 1 \\ 1\end{matrix} \\ - 1\end{matrix} ] , [ \begin{matrix}\begin{matrix}1 \\ - j \\ - 1\end{matrix} \\ j\end{matrix} ] , [ \begin{matrix}\begin{matrix}1 \\ \frac{1 + j}{√ 2} \\ j\end{matrix} \\ \frac{- 1 + j}{√ 2}\end{matrix} ] , [ \begin{matrix}\begin{matrix}1 \\ \frac{- 1 + j}{√ 2} \\ - j\end{matrix} \\ \frac{1 + j}{√ 2}\end{matrix} ] , [ \begin{matrix}\begin{matrix}1 \\ \frac{- 1 - j}{√ 2} \\ j\end{matrix} \\ \frac{1 - j}{√ 2}\end{matrix} ] , [ \begin{matrix}\begin{matrix}1 \\ \frac{1 - j}{√ 2} \\ j\end{matrix} \\ \frac{- 1 - j}{√ 2}\end{matrix} ] , \\ [ \begin{matrix}\begin{matrix}1 \\ 1 \\ - 1\end{matrix} \\ 1\end{matrix} ] , [ \begin{matrix}\begin{matrix}1 \\ j \\ 1\end{matrix} \\ j\end{matrix} ] , [ \begin{matrix}\begin{matrix}1 \\ - 1 \\ - 1\end{matrix} \\ 1\end{matrix} ] , [ \begin{matrix}\begin{matrix}1 \\ - j \\ 1\end{matrix} \\ - j\end{matrix} ] , [ \begin{matrix}\begin{matrix}1 \\ 1 \\ 1\end{matrix} \\ - 1\end{matrix} ] , [ \begin{matrix}\begin{matrix}1 \\ 1 \\ - 1\end{matrix} \\ 1\end{matrix} ] ,$$

$$[ \begin{matrix}1 \\ - 1 \\ 1 \\ 1\end{matrix} ] , and [ \begin{matrix}1 \\ - 1 \\ - 1 \\ - 1\end{matrix} ] ( for TPMIs 0 - 15 ) ;$$

$$\frac{1}{2} [ \begin{matrix}1 \\ 1 \\ 1 \\ - 1\end{matrix} ] , \frac{1}{2} [ \begin{matrix}1 \\ 1 \\ j \\ j\end{matrix} ] , \frac{1}{2} [ \begin{matrix}1 \\ 1 \\ - 1 \\ 1\end{matrix} ] \frac{1}{2} [ \begin{matrix}1 \\ 1 \\ - j \\ - j\end{matrix} ] , \frac{1}{2} [ \begin{matrix}1 \\ j \\ 1 \\ j\end{matrix} ] , \frac{1}{2} [ \begin{matrix}1 \\ j \\ j \\ 1\end{matrix} ] , \frac{1}{2} [ \begin{matrix}1 \\ j \\ - 1 \\ - j\end{matrix} ] , \frac{1}{2} [ \begin{matrix}1 \\ j \\ - j \\ - 1\end{matrix} ] , \frac{1}{2} [ \begin{matrix}1 \\ - 1 \\ 1 \\ 1\end{matrix} ] , \\ \frac{1}{2} [ \begin{matrix}1 \\ - 1 \\ j \\ - j\end{matrix} ] , \frac{1}{2} [ \begin{matrix}1 \\ - 1 \\ - 1 \\ - 1\end{matrix} ] , \frac{1}{2} [ \begin{matrix}1 \\ - 1 \\ - j \\ j\end{matrix} ] , \frac{1}{2} [ \begin{matrix}1 \\ - j \\ j \\ - 1\end{matrix} ] ,$$

$$\frac{1}{2} [ \begin{matrix}1 \\ - j \\ j \\ - 1\end{matrix} ] , \frac{1}{2} [ \begin{matrix}1 \\ - j \\ - 1 \\ j\end{matrix} ] , and \frac{1}{2} [ \begin{matrix}1 \\ - j \\ - j \\ 1\end{matrix} ] ( for TPMIs 0 - 15 ) ;$$

$$[ \begin{matrix}1 & 1 \\ 1 & - 1 \\ 1 & - 1 \\ 1 & 1\end{matrix} ] , [ \begin{matrix}1 & - j \\ j & - 1 \\ - 1 & - j \\ - j & 1\end{matrix} ] , [ \begin{matrix}1 & - 1 \\ - 1 & 1 \\ 1 & 1 \\ - 1 & - 1\end{matrix} ] , [ \begin{matrix}1 & j \\ - 1 & 1 \\ - 1 & j \\ j & 1\end{matrix} ] , [ \begin{matrix}1 & \frac{- 1 - j}{√ 2} \\ \frac{1 + j}{√ 2} & j \\ j & \frac{- 1 + j}{√ 2} \\ \frac{- 1 + j}{√ 2} & 1\end{matrix} ] , \\ [ \begin{matrix}1 & \frac{1 - j}{√ 2} \\ \frac{- 1 + j}{√ 2} & - j \\ - j & \frac{1 + j}{√ 2} \\ \frac{1 + j}{√ 2} & 1\end{matrix} ] , [ \begin{matrix}1 & - j \\ \frac{- 1 - j}{√ 2} & \frac{1 - j}{√ 2} \\ j & 1 \\ \frac{1 - j}{√ 2} & \frac{1 + j}{√ 2}\end{matrix} ] , [ \begin{matrix}1 & j \\ \frac{1 - j}{√ 2} & \frac{- 1 - j}{√ 2} \\ - j & 1 \\ \frac{- 1 - j}{√ 2} & \frac{- 1 + j}{√ 2}\end{matrix} ] , [ \begin{matrix}1 & 1 \\ 1 & 1 \\ - 1 & 1 \\ - 1 & 1\end{matrix} ] ,$$

$$[ \begin{matrix}1 & - j \\ 1 & - 1 \\ 1 & j \\ j & 1\end{matrix} ] , [ \begin{matrix}1 & - 1 \\ - 1 & - 1 \\ - 1 & 1 \\ 1 & 1\end{matrix} ] , [ \begin{matrix}1 & 1 \\ - j & j \\ 1 & 1 \\ - j & j\end{matrix} ] , [ \begin{matrix}1 & 1 \\ 1 & 1 \\ 1 & - 1 \\ - 1 & 1\end{matrix} ] , [ \begin{matrix}1 & - 1 \\ 1 & 1 \\ - 1 & 1 \\ 1 & 1\end{matrix} ] , \\ [ \begin{matrix}1 & 1 \\ - 1 & 1 \\ 1 & 1 \\ 1 & - 1\end{matrix} ] , and [ \begin{matrix}1 & 1 \\ - 1 & 1 \\ - 1 & - 1 \\ - 1 & - 1\end{matrix} ] ;$$

$$[ \begin{matrix}1 & 1 & 1 \\ 1 & 1 & - 1 \\ 1 & - 1 & - 1 \\ 1 & - 1 & 1\end{matrix} ] , [ \begin{matrix}1 & - j & - 1 \\ j & 1 & j \\ - 1 & j & 1 \\ - j & 1 & - j\end{matrix} ] , [ \begin{matrix}1 & - 1 & 1 \\ - 1 & 1 & 1 \\ 1 & 1 & 1 \\ - 1 & - 1 & 1\end{matrix} ] , [ \begin{matrix}1 & j & - 1 \\ - j & 1 & - j \\ - 1 & j & 1 \\ j & 1 & j\end{matrix} ] , \\ [ \begin{matrix}1 & \frac{1 - j}{√ 2} & \frac{- 1 - j}{√ 2} \\ \frac{1 + j}{√ 2} & 1 & j \\ j & \frac{- 1 - j}{√ 2} & \frac{- 1 + j}{√ 2} \\ \frac{- 1 + j}{√ 2} & - j & 1\end{matrix} ] , [ \begin{matrix}1 & \frac{- 1 - j}{√ 2} & \frac{1 - j}{√ 2} \\ \frac{- 1 + j}{√ 2} & 1 & - j \\ - j & \frac{1 - j}{√ 2} & \frac{1 + j}{√ 2} \\ \frac{1 + j}{√ 2} & j & 1\end{matrix} ] ,$$

$$[ \begin{matrix}1 & - j & \frac{1 + j}{√ 2} \\ \frac{- 1 - j}{√ 2} & \frac{1 - j}{√ 2} & j \\ j & 1 & \frac{1 - j}{√ 2} \\ \frac{1 - j}{√ 2} & \frac{1 + j}{√ 2} & 1\end{matrix} ] , [ \begin{matrix}1 & j & \frac{- 1 + j}{√ 2} \\ \frac{1 - j}{√ 2} & \frac{- 1 - j}{√ 2} & - j \\ - j & 1 & \frac{- 1 - j}{√ 2} \\ \frac{- 1 - j}{√ 2} & \frac{- 1 + j}{√ 2} & 1\end{matrix} ] , [ \begin{matrix}1 & 1 & - 1 \\ 1 & 1 & 1 \\ - 1 & 1 & - 1 \\ - 1 & 1 & 1\end{matrix} ] , \\ [ \begin{matrix}1 & 1 & - j \\ j & - j & - 1 \\ 1 & 1 & j \\ j & - j & 1\end{matrix} ] , [ \begin{matrix}1 & - 1 & - 1 \\ - 1 & 1 & - 1 \\ - 1 & - 1 & 1 \\ 1 & 1 & 1\end{matrix} ] , [ \begin{matrix}1 & 1 & j \\ - j & j & - 1 \\ 1 & 1 & - j \\ - j & j & 1\end{matrix} ] , [ \begin{matrix}1 & 1 & 1 \\ 1 & 1 & - 1 \\ 1 & - 1 & 1 \\ - 1 & 1 & 1\end{matrix} ] ,$$

$$[ \begin{matrix}1 & 1 & - 1 \\ 1 & 1 & 1 \\ - 1 & 1 & 1 \\ 1 & - 1 & 1\end{matrix} ] , [ \begin{matrix}1 & - 1 & 1 \\ - 1 & 1 & 1 \\ 1 & 1 & 1 \\ 1 & 1 & - 1\end{matrix} ] , and [ \begin{matrix}1 & - 1 & - 1 \\ - 1 & 1 & - 1 \\ - 1 & - 1 & 1 \\ - 1 & - 1 & - 1\end{matrix} ] ; or$$

$$[ \begin{matrix}1 & 1 & 1 & 1 \\ 1 & 1 & - 1 & - 1 \\ 1 & - 1 & 1 & - 1 \\ 1 & - 1 & - 1 & 1\end{matrix} ] , [ \begin{matrix}1 & - j & - 1 & j \\ j & 1 & j & 1 \\ - 1 & - j & 1 & j \\ - j & 1 & - j & 1\end{matrix} ] , \\ [ \begin{matrix}1 & - 1 & 1 & - 1 \\ - 1 & 1 & 1 & - 1 \\ 1 & 1 & 1 & 1 \\ - 1 & - 1 & 1 & 1\end{matrix} ] , [ \begin{matrix}1 & j & - 1 & - j \\ - j & 1 & - j & 1 \\ - 1 & j & 1 & - j \\ j & 1 & j & 1\end{matrix} ] ,$$

$$[ \begin{matrix}1 & \frac{1 - j}{√ 2} & - j & \frac{- 1 - j}{√ 2} \\ \frac{1 + j}{√ 2} & 1 & \frac{- 1 + j}{√ 2} & j \\ j & \frac{- 1 - j}{√ 2} & 1 & \frac{- 1 + j}{√ 2} \\ \frac{- 1 + j}{√ 2} & - j & \frac{- 1 - j}{√ 2} & 1\end{matrix} ] , \\ [ \begin{matrix}1 & \frac{- 1 - j}{√ 2} & j & \frac{1 - j}{√ 2} \\ \frac{- 1 + j}{√ 2} & 1 & \frac{1 + j}{√ 2} & - j \\ - j & \frac{1 - j}{√ 2} & 1 & \frac{1 + j}{√ 2} \\ \frac{1 + j}{√ 2} & j & \frac{1 - j}{√ 2} & 1\end{matrix} ] , [ \begin{matrix}1 & - j & \frac{- 1 + j}{√ 2} & \frac{1 + j}{√ 2} \\ \frac{- 1 - j}{√ 2} & \frac{1 - j}{√ 2} & 1 & j \\ j & 1 & \frac{1 + j}{√ 2} & \frac{1 - j}{√ 2} \\ \frac{1 - j}{√ 2} & \frac{1 + j}{√ 2} & - j & 1\end{matrix} ] , \\ [ \begin{matrix}1 & j & \frac{1 + j}{√ 2} & \frac{- 1 + j}{√ 2} \\ \frac{1 - j}{√ 2} & \frac{- 1 - j}{√ 2} & 1 & - j \\ - j & 1 & \frac{- 1 + j}{√ 2} & \frac{- 1 - j}{√ 2} \\ \frac{- 1 - j}{√ 2} & \frac{- 1 + j}{√ 2} & j & 1\end{matrix} ] ,$$

$$[ \begin{matrix}1 & 1 & - 1 & - 1 \\ 1 & 1 & 1 & 1 \\ - 1 & 1 & 1 & - 1 \\ - 1 & 1 & - 1 & 1\end{matrix} ] , [ \begin{matrix}1 & - j & 1 & - j \\ j & 1 & - j & - 1 \\ 1 & j & 1 & j \\ j & - 1 & - j & 1\end{matrix} ] , \\ [ \begin{matrix}1 & - 1 & - 1 & 1 \\ - 1 & - 1 & 1 & 1 \\ - 1 & 1 & - 1 & 1 \\ 1 & 1 & 1 & 1\end{matrix} ] , [ \begin{matrix}1 & 1 & j & j \\ - j & j & 1 & - 1 \\ 1 & 1 & - j & - j \\ - j & j & - 1 & 1\end{matrix} ] ,$$

$$[ \begin{matrix}1 & 1 & 1 & - 1 \\ 1 & 1 & - 1 & 1 \\ 1 & - 1 & 1 & 1 \\ - 1 & 1 & 1 & 1\end{matrix} ] , [ \begin{matrix}1 & - 1 & 1 & 1 \\ 1 & 1 & 1 & - 1 \\ - 1 & 1 & 1 & 1 \\ 1 & 1 & - 1 & 1\end{matrix} ] , \\ [ \begin{matrix}1 & - 1 & 1 & 1 \\ 1 & 1 & - 1 & 1 \\ 1 & 1 & 1 & - 1 \\ - 1 & 1 & 1 & 1\end{matrix} ] , and [ \begin{matrix}1 & - 1 & - 1 & - 1 \\ - 1 & 1 & - 1 & - 1 \\ - 1 & - 1 & 1 & - 1 \\ - 1 & - 1 & - 1 & 1\end{matrix} ] .$$

Co-phasing may include determining phases for selected beams and using co-phasing parameters to rotate the phases for orthogonal beams. The co-phasing may include BPSK co-phasing (32 precoding matrices) or quadrature phase shift keying (QPSK) (64 precoding matrices). Half-subsampling or quarter-subsampling may be used based on evaluating 32 precoding matrices. Half-subsampling of 32 precoding matrices may result in 16 precoding matrices. Quarter-subsampling of the 32 precoding matrices may result in 8 precoding matrices.

As shown by reference number 405, a wireless communication device, such as UE 120, may select a codebook from among codebooks specified for 8 antennas (or another quantity greater than 4). Example 400 shows codebooks that may be specified for 8 antennas and Rank 1. As shown by reference number 410, the UE 120 may use the selected codebook to transmit a communication. The communication may be a MIMO communication in that one or more of multiple configured antennas for the wireless communication device may be used to transmit or receive the communication. The base station 110, being aware of the codebooks (and a TPMI may indicate a selected codebook) may receive the communication. In some aspects, the base station 110 may select and use a codebook from among the codebooks to transmit a communication to the UE 120. Examples of other codebooks that may be specified are described herein.

In some aspects, partially-coherent Rank 3 codebooks for 2 of 8 antennas may include antenna pairings of 0-4, 1-5, 2-6, and 3-7 and include an antenna grouping of (0-4, 1-5, 2-6) or (0-4, 2-6, 3-7). Some codebooks (with down-selection with QPSK combining (0-4, 1-5, 2-6)) may include:

$$\frac{1}{2 √ 2} [ \begin{matrix}1 & 0 & 0 \\ 0 & 1 & 0 \\ 0 & 0 & 1 \\ 0 & 0 & 0 \\ 1 & 0 & 0 \\ 0 & j & 0 \\ 0 & 0 & - 1 \\ 0 & 0 & 0\end{matrix} ] , \frac{1}{2 √ 2} [ \begin{matrix}1 & 0 & 0 \\ 0 & 1 & 0 \\ 0 & 0 & 1 \\ 0 & 0 & 0 \\ j & 0 & 0 \\ 0 & - 1 & 0 \\ 0 & 0 & - j \\ 0 & 0 & 0\end{matrix} ] , \\ \frac{1}{2 √ 2} [ \begin{matrix}1 & 0 & 0 \\ 0 & 1 & 0 \\ 0 & 0 & 1 \\ 0 & 0 & 0 \\ - 1 & 0 & 0 \\ 0 & - j & 0 \\ 0 & 0 & 1 \\ 0 & 0 & 0\end{matrix} ] , and \frac{1}{2 √ 2} [ \begin{matrix}1 & 0 & 0 \\ 0 & 1 & 0 \\ 0 & 0 & 1 \\ 0 & 0 & 0 \\ - j & 0 & 0 \\ 0 & 1 & 0 \\ 0 & 0 & j \\ 0 & 0 & 0\end{matrix} ] .$$

Some codebooks (with down-selection (0-4, 2, 6)) may include:

$$\frac{1}{2 √ 2} [ \begin{matrix}1 & 0 & 0 \\ 0 & 0 & 0 \\ 0 & 1 & 0 \\ 0 & 0 & 0 \\ 1 & 0 & 0 \\ 0 & 0 & 0 \\ 0 & 0 & 1 \\ 0 & 0 & 0\end{matrix} ] and \frac{1}{2 √ 2} [ \begin{matrix}1 & 0 & 0 \\ 0 & 0 & 0 \\ 0 & 1 & 0 \\ 0 & 0 & 0 \\ - 1 & 0 & 0 \\ 0 & 0 & 0 \\ 0 & 0 & 1 \\ 0 & 0 & 0\end{matrix} ]$$

In some aspects, partially-coherent Rank 4 codebooks for 2 of 8 antennas may include antenna pairings of 0-4, 1-5, 2-6, and 3-7. Such codebooks may include:

$$\frac{1}{2 √ 2} [ \begin{matrix}1 & 0 & 0 & 0 \\ 0 & 1 & 0 & 0 \\ 0 & 0 & 1 & 0 \\ 0 & 0 & 1 & 1 \\ 1 & 0 & 0 & 0 \\ 0 & - 1 & 0 & 0 \\ 0 & 0 & 1 & 0 \\ 0 & 0 & 0 & - 1\end{matrix} ] and \frac{1}{2 √ 2} [ \begin{matrix}1 & 0 & 0 & 0 \\ 0 & 1 & 0 & 0 \\ 0 & 0 & 1 & 0 \\ 0 & 0 & 0 & 1 \\ j & 0 & 0 & 0 \\ 0 & - j & 0 & 0 \\ 0 & 0 & j & 0 \\ 0 & 0 & 0 & - j\end{matrix} ] ; or$$

$$\frac{1}{2 √ 2} [ \begin{matrix}1 & 0 & 0 & 0 \\ 0 & 1 & 0 & 0 \\ 1 & 0 & 0 & 0 \\ 0 & 0 & 1 & 0 \\ 1 & 0 & 0 & 0 \\ 0 & - 1 & 0 & 0 \\ 1 & 0 & 0 & 0 \\ 0 & 0 & 0 & 1\end{matrix} ] and \frac{1}{2 √ 2} [ \begin{matrix}1 & 0 & 0 & 0 \\ 0 & 1 & 0 & 0 \\ 1 & 0 & 0 & 0 \\ 0 & 0 & 1 & 0 \\ j & 0 & 0 & 0 \\ 0 & 0 & - j & 0 \\ j & 0 & 0 & 0 \\ 0 & 0 & 0 & 1\end{matrix} ] .$$

With down-selection and QPSK combining, (0-4, 0-4, 2-6, 2-6), codebooks for selection may include:

$$\frac{1}{4} [ \begin{matrix}1 & 1 & 0 & 0 \\ 0 & 0 & 0 & 0 \\ 0 & 0 & 1 & 1 \\ 0 & 0 & 0 & 0 \\ 1 & - 1 & 0 & 0 \\ 0 & 0 & 0 & 0 \\ 0 & 0 & 1 & - 1 \\ 0 & 0 & 0 & 0\end{matrix} ] and \frac{1}{4} [ \begin{matrix}1 & 1 & 0 & 0 \\ 0 & 0 & 0 & 0 \\ 0 & 0 & 1 & 1 \\ 0 & 0 & 0 & 0 \\ j & - j & 0 & 0 \\ 0 & 0 & 0 & 0 \\ 0 & 0 & j & - j \\ 0 & 0 & 0 & 0\end{matrix} ] .$$

In some aspects, partially-coherent Rank 3 codebooks for 4 of 8 antennas may include antenna groupings of (0-4-1-5, 2-6, 3-7), (0-4, 1-5, 2-6-3-7), or (0-4-2-6, 1-5, 3-7). O₁ may be 2, i₁ may be {0, 2}, and i₂ may be 0. Such codebooks may include:

$$\frac{1}{2 √ 2} [ \begin{matrix}1 & 0 & 0 \\ 0 & 1 & 0 \\ 1 & 0 & 0 \\ 0 & 0 & 1 \\ 1 & 0 & 0 \\ 0 & - 1 & 0 \\ 1 & 0 & 0 \\ 0 & 0 & - 1\end{matrix} ] , \frac{1}{2 √ 2} [ \begin{matrix}1 & 0 & 0 \\ 0 & 1 & 0 \\ 1 & 0 & 0 \\ 0 & 0 & 1 \\ j & 0 & 0 \\ 0 & 0 & - j \\ j & 0 & 0 \\ 0 & 0 & - j\end{matrix} ] , \\ \frac{1}{2 √ 2} [ \begin{matrix}1 & 0 & 0 \\ 0 & 1 & 0 \\ - 1 & 0 & 0 \\ 0 & 0 & - 1 \\ 1 & 0 & 0 \\ 0 & - 1 & 0 \\ - 1 & 0 & 0 \\ 0 & 0 & 1\end{matrix} ] , and \frac{1}{2 √ 2} [ \begin{matrix}1 & 0 & 0 \\ 0 & 1 & 0 \\ - 1 & 0 & 0 \\ 0 & 0 & - 1 \\ j & 0 & 0 \\ 0 & - j & 0 \\ - j & 0 & 0 \\ 0 & 0 & j\end{matrix} ] .$$

Other codebooks may include:

$$\frac{1}{2 √ 2} [ \begin{matrix}1 & 0 & 0 \\ 0 & 1 & 0 \\ 0 & 0 & 1 \\ 0 & 0 & 0 \\ 1 & 0 & 0 \\ 0 & j & 0 \\ 0 & 0 & - 1 \\ 0 & 0 & 0\end{matrix} ] , \frac{1}{2 √ 2} [ \begin{matrix}1 & 0 & 0 \\ 0 & 1 & 0 \\ 0 & 0 & 1 \\ 0 & 0 & 0 \\ j & 0 & 0 \\ 0 & - 1 & 0 \\ 0 & 0 & - j \\ 0 & 0 & 0\end{matrix} ] , \frac{1}{2 √ 2} [ \begin{matrix}1 & 0 & 0 \\ 0 & 1 & 0 \\ 0 & 0 & 1 \\ 0 & 0 & 0 \\ - 1 & 0 & 0 \\ 0 & - j & 0 \\ 0 & 0 & 1 \\ 0 & 0 & 0\end{matrix} ] , and \\ \frac{1}{2 √ 2} [ \begin{matrix}1 & 0 & 0 \\ 0 & 1 & 0 \\ 0 & 0 & 1 \\ 0 & 0 & 0 \\ - j & 0 & 0 \\ 0 & 1 & 0 \\ 0 & 0 & j \\ 0 & 0 & 0\end{matrix} ] ; or \frac{1}{2 √ 2} [ \begin{matrix}1 & 0 & 0 \\ 0 & 0 & 0 \\ 0 & 1 & 0 \\ 0 & 0 & 0 \\ 1 & 0 & 0 \\ 0 & 0 & 0 \\ 0 & 0 & 1 \\ 0 & 0 & 0\end{matrix} ] , and \frac{1}{2 √ 2} [ \begin{matrix}1 & 0 & 0 \\ 0 & 0 & 0 \\ 0 & 1 & 0 \\ 0 & 0 & 0 \\ - 1 & 0 & 0 \\ 0 & 0 & 0 \\ 0 & 0 & 1 \\ 0 & 0 & 0\end{matrix} ] .$$

Some partially-coherent Rank 3 codebooks for 4 of 8 antennas may include antenna groupings of (0-4-2-6, 0-4-2-6, 0-4-2-6) for mode=1. Such codebooks may include:

$$\frac{1}{2 √ 6} [ \begin{matrix}1 & 1 & 1 \\ 0 & 0 & 0 \\ 1 & - 1 & 1 \\ 0 & 0 & 0 \\ 1 & 1 & - 1 \\ 0 & 0 & 0 \\ 1 & - 1 & - 1 \\ 0 & 0 & 0\end{matrix} ] , \frac{1}{2 √ 6} [ \begin{matrix}1 & 1 & 1 \\ 0 & 0 & 0 \\ 1 & - 1 & 1 \\ 0 & 0 & 0 \\ j & j & - j \\ 0 & 0 & 0 \\ j & - j & - j \\ 0 & 0 & 0\end{matrix} ] , \\ \frac{1}{2 √ 6} [ \begin{matrix}1 & 1 & 1 \\ 0 & 0 & 0 \\ - 1 & 1 & - 1 \\ 0 & 0 & 0 \\ 1 & 1 & - 1 \\ 0 & 0 & 0 \\ - 1 & 1 & 1 \\ 0 & 0 & 0\end{matrix} ] , and \frac{1}{2 √ 6} [ \begin{matrix}1 & 1 & 1 \\ 0 & 0 & 0 \\ - 1 & 1 & - 1 \\ 0 & 0 & 0 \\ j & j & - j \\ 0 & 0 & 0 \\ - j & j & j \\ 0 & 0 & 0\end{matrix} ] .$$

In some aspects, partially-coherent Rank 4 codebooks for 4 of 8 antennas may include antenna groupings of (0-4-1-5, 2-6, 3-7), (0-4-2-6, 1-5-3-7), or (0-4-2-6, 0-4-2-6). Such codebooks may include:

$$\frac{1}{4} [ \begin{matrix}1 & 1 & 0 & 0 \\ 1 & - 1 & 0 & 0 \\ 0 & 0 & 1 & 1 \\ 0 & 0 & 1 & - 1 \\ 1 & 1 & 0 & 0 \\ 1 & - 1 & 0 & 0 \\ 0 & 0 & - 1 & - 1 \\ 0 & 0 & - 1 & 1\end{matrix} ] and \frac{1}{4} [ \begin{matrix}1 & 1 & 0 & 0 \\ 1 & - 1 & 0 & 0 \\ 0 & 0 & 1 & 1 \\ 0 & 0 & 1 & - 1 \\ j & j & 0 & 0 \\ j & - j & 0 & 0 \\ 0 & 0 & - j & - j \\ 0 & 0 & - j & j\end{matrix} ] ; or \\ \frac{1}{4} [ \begin{matrix}1 & 1 & 0 & 0 \\ 0 & 0 & 0 & 0 \\ 0 & 0 & 1 & 1 \\ 0 & 0 & 0 & 0 \\ 1 & - 1 & 0 & 0 \\ 0 & 0 & 0 & 0 \\ 0 & 0 & 1 & - 1 \\ 0 & 0 & 0 & 0\end{matrix} ] and \frac{1}{4} [ \begin{matrix}1 & 1 & 0 & 0 \\ 0 & 0 & 0 & 0 \\ 0 & 0 & 1 & 1 \\ 0 & 0 & 0 & 0 \\ j & - j & 0 & 0 \\ 0 & 0 & 0 & 0 \\ 0 & 0 & j & - j \\ 0 & 0 & 0 & 0\end{matrix} ] .$$

In some aspects, a Rank 3 full-coherent codebook for 8 antennas may be specified as:

$$\{ \frac{1}{2 √ 6} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & - {e}^{j π i 2 / 2} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ]\end{matrix} ] \} , \\ where {i}_{1} = 0 , … , 7 , and where {i}_{2} = 0 , 1.$$

This may be for mode=1 but with O₁=2. N₁O₁×(quantity of co-phasing values (i₂)) may result in 16 precoding matrices. After subsampling with O₁=1 (or different subsampling methods for O₁=2 and i₁={0, 1, 2, 3}), there may be 8 precoders, such as:

$$\frac{1}{2 \sqrt{6}} [ \begin{matrix}1 & 1 & 1 \\ 1 & j & 1 \\ 1 & - 1 & 1 \\ 1 & - j & 1 \\ 1 & 1 & - 1 \\ 1 & j & - 1 \\ 1 & - 1 & - 1 \\ 1 & - j & - 1\end{matrix} ] ,$$

$$\frac{1}{2 \sqrt{6}} [ \begin{matrix}1 & 1 & 1 \\ 1 & j & 1 \\ 1 & - 1 & 1 \\ 1 & - j & 1 \\ j & j & - j \\ j & - 1 & - j \\ j & - j & - j \\ j & 1 & - j\end{matrix} ] ,$$

$$\frac{1}{2 \sqrt{6}} [ \begin{matrix}1 & 1 & 1 \\ j & - 1 & j \\ - 1 & 1 & - 1 \\ - j & - 1 & - j \\ 1 & 1 & - 1 \\ j & - 1 & - j \\ - 1 & 1 & 1 \\ - j & - 1 & j\end{matrix} ] ,$$

$$\frac{1}{2 \sqrt{6}} [ \begin{matrix}1 & 1 & 1 \\ j & - 1 & j \\ - 1 & 1 & - 1 \\ - j & - 1 & - j \\ j & j & - j \\ - 1 & - j & 1 \\ - j & j & j \\ 1 & - j & - 1\end{matrix} ] ,$$

$$\frac{1}{2 \sqrt{6}} [ \begin{matrix}1 & 1 & 1 \\ - 1 & - j & - 1 \\ 1 & - 1 & 1 \\ - 1 & j & - 1 \\ 1 & 1 & - 1 \\ - 1 & - j & 1 \\ 1 & - 1 & - 1 \\ - 1 & j & 1\end{matrix} ] ,$$

$$\frac{1}{2 \sqrt{6}} [ \begin{matrix}1 & 1 & 1 \\ - 1 & - j & - 1 \\ 1 & - 1 & 1 \\ - 1 & j & - 1 \\ j & j & - j \\ - j & 1 & j \\ j & - j & - j \\ - j & - 1 & j\end{matrix} ] ,$$

$$\frac{1}{2 \sqrt{6}} [ \begin{matrix}1 & 1 & 1 \\ - j & 1 & - j \\ - 1 & 1 & - 1 \\ j & 1 & j \\ 1 & 1 & - 1 \\ - j & 1 & j \\ - 1 & 1 & 1 \\ j & 1 & - j\end{matrix} ] ,$$

$$and$$

$$\frac{1}{2 \sqrt{6}} [ \begin{matrix}1 & 1 & 1 \\ - j & 1 & - j \\ - 1 & 1 & - 1 \\ j & 1 & j \\ j & j & - j \\ 1 & j & - 1 \\ - j & j & j \\ - 1 & j & 1\end{matrix} ] .$$

In some aspects, a Rank 4 full-coherent codebook for 8 antennas may be specified as:

$$\{ \frac{1}{4 \sqrt{2}} [ \text{} \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & - {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & - {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ]\end{matrix} ] \} ,$$

$$where$$

$${i}_{1} = 0 , … , 7 ,$$

$$and where$$

$${i}_{2} = 0 , 1.$$

This may be for O₁0=2. For O₁=1, Rank 4 precoders may be specified as:

$$\frac{1}{4 \sqrt{2}} [ \begin{matrix}1 & 1 & 1 & 1 \\ 1 & j & 1 & j \\ 1 & - 1 & 1 & j \\ 1 & - j & 1 & - j \\ 1 & 1 & - 1 & 1 \\ 1 & j & - 1 & - j \\ 1 & - 1 & - 1 & 1 \\ 1 & - j & - 1 & j\end{matrix} ] ,$$

$$\frac{1}{4 \sqrt{2}} [ \begin{matrix}1 & 1 & 1 & 1 \\ 1 & j & 1 & j \\ 1 & - 1 & 1 & - 1 \\ 1 & - j & 1 & - j \\ j & j & - j & - j \\ j & - 1 & - j & - 1 \\ j & - j & - j & - j \\ j & 1 & - j & 1\end{matrix} ] ,$$

$$\frac{1}{4 \sqrt{2}} [ \begin{matrix}1 & 1 & 1 & 1 \\ j & - 1 & j & - 1 \\ - 1 & 1 & - 1 & 1 \\ - j & - 1 & - j & - 1 \\ 1 & 1 & - 1 & - 1 \\ j & - 1 & - j & 1 \\ - 1 & 1 & 1 & - 1 \\ - j & - 1 & j & 1\end{matrix} ] ,$$

$$\frac{1}{4 \sqrt{2}} [ \begin{matrix}1 & 1 & 1 & 1 \\ - 1 & - j & - 1 & - 1 \\ - 1 & 1 & - 1 & - 1 \\ - j & - 1 & - j & - 1 \\ j & j & - j & - j \\ - 1 & - j & 1 & j \\ - j & j & j & - j \\ 1 & - j & - 1 & j\end{matrix} ] ,$$

$$\frac{1}{4 \sqrt{2}} [ \begin{matrix}1 & 1 & 1 & 1 \\ - 1 & - j & - 1 & - j \\ 1 & - 1 & 1 & - 1 \\ - 1 & j & - 1 & j \\ 1 & 1 & - 1 & - 1 \\ - 1 & - j & 1 & j \\ 1 & - 1 & - 1 & 1 \\ - 1 & j & 1 & - j\end{matrix} ] ,$$

$$\frac{1}{4 \sqrt{2}} [ \begin{matrix}1 & 1 & 1 & 1 \\ - 1 & - j & - 1 & - j \\ 1 & - 1 & 1 & 1 \\ - 1 & j & - 1 & j \\ j & j & - j & - j \\ - j & 1 & j & - 1 \\ j & - j & - j & j \\ - j & - 1 & j & 1\end{matrix} ] ,$$

$$\frac{1}{4 \sqrt{2}} [ \begin{matrix}1 & 1 & 1 & 1 \\ - j & 1 & - j & 1 \\ - 1 & 1 & - 1 & 1 \\ j & 1 & j & 1 \\ 1 & 1 & - 1 & - 1 \\ - j & 1 & j & - 1 \\ - 1 & 1 & 1 & - 1 \\ j & 1 & - j & - 1\end{matrix} ] ,$$

$$and$$

$$\frac{1}{4 \sqrt{2}} [ \begin{matrix}1 & 1 & 1 & 1 \\ - j & 1 & - j & 1 \\ - 1 & 1 & - 1 & 1 \\ j & 1 & j & 1 \\ j & j & - j & - j \\ 1 & - j & - 1 & - j \\ - j & j & j & - j \\ - 1 & j & 1 & - j\end{matrix} ] .$$

In some aspects, codebooks and TPMI payload sizes may be designed for 6 antennas. Antenna grouping for 6 antennas may include 0-3, 1-4, and 2-5 for 2-antenna partially-coherent codebooks and 0-3-1-6 and 2-5 for 4-antenna partially-coherent codebooks. Down-selection may be used to allow for only ports 0, 3, 4, and 5, for example. These ports may have a higher output power. Lower oversampling and a reduced co-phasing alphabet may also be used. For example, Rank 1 partially-coherent codebooks for 2 of 6 antennas may be specified as:

$$\frac{1}{\sqrt{6}} [ \begin{matrix}1 \\ 0 \\ 0 \\ 1 \\ 0 \\ 0\end{matrix} ] ,$$

$$\frac{1}{\sqrt{6}} [ \begin{matrix}1 \\ 0 \\ 0 \\ j \\ 0 \\ 0\end{matrix} ] ,$$

$$\frac{1}{\sqrt{6}} [ \begin{matrix}1 \\ 0 \\ 0 \\ - 1 \\ 0 \\ 0\end{matrix} ] ,$$

$$\frac{1}{\sqrt{6}} [ \begin{matrix}1 \\ 0 \\ 0 \\ - j \\ 0 \\ 0\end{matrix} ] ,$$

$$\frac{1}{\sqrt{6}} [ \begin{matrix}0 \\ 0 \\ 1 \\ 0 \\ 0 \\ 1\end{matrix} ] ,$$

$$\frac{1}{\sqrt{6}} [ \begin{matrix}0 \\ 0 \\ 1 \\ 0 \\ 0 \\ j\end{matrix} ] ,$$

$$\frac{1}{\sqrt{6}} [ \begin{matrix}0 \\ 0 \\ 1 \\ 0 \\ 0 \\ - 1\end{matrix} ] ,$$

$$and$$

$$\frac{1}{\sqrt{6}} [ \begin{matrix}0 \\ 0 \\ 1 \\ 0 \\ 0 \\ - j\end{matrix} ] .$$

Antenna pairs 0-3 and 2-5 are used considering unequal power outputs (power output for 0-3-2-5 may be higher than power output for 1-4). In some aspects, other antenna pairs may be used when considering power outputs of the antennas. Subsampling may be used to reduce the quantity of the precoding matrices to 4 with BPSK co-phasing.

In some aspects, Rank 1 partially-coherent codebooks for 4 of 6 antennas may include (with down-selection (0-3-2-5), mode=1, and O₁=2):

$$\frac{1}{\sqrt{6}} [ \begin{matrix}1 \\ 0 \\ 1 \\ 1 \\ 0 \\ 1\end{matrix} ] ,$$

$$\frac{1}{\sqrt{6}} [ \begin{matrix}1 \\ 0 \\ 1 \\ j \\ 0 \\ j\end{matrix} ] ,$$

$$\frac{1}{\sqrt{6}} [ \begin{matrix}1 \\ 0 \\ 1 \\ - 1 \\ 0 \\ - 1\end{matrix} ] ,$$

$$\frac{1}{\sqrt{6}} [ \begin{matrix}1 \\ 0 \\ 1 \\ - j \\ 0 \\ - j\end{matrix} ] ,$$

$$\frac{1}{\sqrt{6}} [ \begin{matrix}1 \\ 0 \\ j \\ 1 \\ 0 \\ j\end{matrix} ] ,$$

$$\frac{1}{\sqrt{6}} [ \begin{matrix}1 \\ 0 \\ j \\ j \\ 0 \\ - 1\end{matrix} ] ,$$

$$\frac{1}{\sqrt{6}} [ \begin{matrix}1 \\ 0 \\ j \\ - 1 \\ 0 \\ - j\end{matrix} ] ,$$

$$\frac{1}{\sqrt{6}} [ \begin{matrix}1 \\ 0 \\ j \\ - j \\ 0 \\ 1\end{matrix} ] ,$$

$$\frac{1}{\sqrt{6}} [ \begin{matrix}1 \\ 0 \\ - 1 \\ 1 \\ 0 \\ - 1\end{matrix} ] ,$$

$$\frac{1}{\sqrt{6}} [ \begin{matrix}1 \\ 0 \\ - 1 \\ j \\ 0 \\ - j\end{matrix} ] ,$$

$$\frac{1}{\sqrt{6}} [ \begin{matrix}1 \\ 0 \\ - 1 \\ - 1 \\ 0 \\ 1\end{matrix} ] ,$$

$$\frac{1}{\sqrt{6}} [ \begin{matrix}1 \\ 0 \\ - j \\ 1 \\ 0 \\ - j\end{matrix} ] ,$$

$$\frac{1}{\sqrt{6}} [ \begin{matrix}1 \\ 0 \\ - j \\ j \\ 0 \\ 1\end{matrix} ] ,$$

$$\frac{1}{\sqrt{6}} [ \begin{matrix}1 \\ 0 \\ - j \\ - 1 \\ 0 \\ j\end{matrix} ] ,$$

$$and$$

$$\frac{1}{\sqrt{6}} [ \begin{matrix}1 \\ 0 \\ - j \\ - j \\ 0 \\ - 1\end{matrix} ] .$$

Subsampling with O₁=1 may include precoding matrices 0, 1, 2, 3, 8, 9, 10, 11. Subsampling with BPSK co-phasing (i₂∈{0,1}) may include precoding matrices 0, 2, 4, 6, 8, 10, 12, and 14. Subsampling with i₁=0, 1 may include precoding matrices 0, 1, 2, 3, 4, 5, 6, and 7. Down-selection may also involve (0-3-1-4).

In some aspects, a Rank 1 fully coherent codebook for 6 antennas may be specified as:

$$\{ \frac{1}{\sqrt{6}} [ \begin{matrix}[ \begin{matrix}1 \\ {e}^{j \frac{π}{3} {i}_{1}} \\ {e}^{j \frac{2 π}{3} {i}_{1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} ,$$

$$where$$

$${i}_{1} = 0 , … , 5 ,$$

$$and where$$

$${i}_{2} = 0 , 1 , 2 , 3$$

$$or$$

$${i}_{2} = 0 , 2.$$

The quantity of i₂ values A. A TPMI may correspond to Ai₁+i₂. This may be for O₁=2. N₁O₁×(quantity of co-phasing values (i₂)) may result in 24 precoding matrices. After subsampling with O₁=1 (or different subsampling methods for O₁=2 and i₁∈{0, 1, 2}), there may be 12 precoders. With i₁∈{0, 1}), there may be 8 precoders.

In some aspects, a Rank 2 fully coherent codebook for 6 antennas may be specified as:

$$\{ \frac{1}{2 \sqrt{3}} [ \begin{matrix}[ \begin{matrix}1 \\ {e}^{j \frac{π}{3} {i}_{1}} \\ {e}^{j \frac{2 π}{3} {i}_{1 , 1}}\end{matrix} ] & [ \begin{matrix}1 \\ {e}^{j \frac{π}{3} {i}_{1}} \\ {e}^{j \frac{2 π}{3} {i}_{1 , 1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} .$$

The TPMI may correspond to 2i₁+i₂. This may be for O₁=2. N₁O₁×(quantity of co-phasing values (i₂)) may result in 12 precoding matrices. After subsampling with O₁=1 (or different subsampling methods for O₁=2 and i₁∈{0, 1, 2}), there may be 6 precoders. With i₁∈{0, 1}, there may be 4 precoders.

In some aspects, a Rank 3 fully coherent codebook for 6 antennas may be specified as:

$$\{ \frac{1}{3 \sqrt{2}} [ \begin{matrix}[ \begin{matrix}1 \\ {e}^{j \frac{π}{3} {i}_{1}} \\ {e}^{j \frac{2 π}{3} {i}_{1}}\end{matrix} ] & [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & [ \begin{matrix}1 \\ {e}^{j \frac{π}{3} {i}_{1}} \\ {e}^{j \frac{2 π}{3} {i}_{1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} .$$

This may be for mode=1 and O₁=2. N₁O₁×(quantity of co-phasing values (i₂)) may result in 12 precoding matrices. After subsampling with O₁=1 or i₁∈{0, 1, 2}, there may be 6 precoders. For i₁∈{0, 1} or {0,2}, there may be 4 precoders.

In some aspects, a Rank 4 fully coherent codebook for 6 antennas may be specified as:

$$\{ \frac{1}{2 \sqrt{6}} [ \text{} \begin{matrix}[ \begin{matrix}1 \\ {e}^{j \frac{π}{3} {i}_{1}} \\ {e}^{j \frac{2 π}{3} {i}_{1}}\end{matrix} ] & [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & [ \begin{matrix}1 \\ {e}^{j \frac{π}{3} {i}_{1}} \\ {e}^{j \frac{2 π}{3} {i}_{1}}\end{matrix} ] & [ \begin{matrix}1 \\ {e}^{j \frac{π}{3} ( {i}_{1} + 2 )} \\ {e}^{j \frac{2 π}{3} ( {i}_{1} + 2 )}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & - {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ]\end{matrix} ] \} .$$

This may be for mode=1 and O₁=2. N₁O₁×(quantity of co-phasing values (i₂)) may result in 12 precoding matrices. After subsampling with O₁=1 (or different subsampling methods for O₁=2 and i₁∈{0, 1, 2}), there may be 6 precoders.

In some aspects, Rank 2 non-coherent codebooks may include:

$$\frac{1}{\sqrt{6}} [ \begin{matrix}1 & 0 \\ 0 & 1 \\ 0 & 0 \\ 0 & 0 \\ 0 & 0 \\ 0 & 0\end{matrix} ] ,$$

$$\frac{1}{\sqrt{6}} [ \begin{matrix}1 & 0 \\ 0 & 0 \\ 0 & 1 \\ 0 & 0 \\ 0 & 0 \\ 0 & 0\end{matrix} ] ,$$

$$\frac{1}{\sqrt{6}} [ \begin{matrix}1 & 0 \\ 0 & 0 \\ 0 & 0 \\ 0 & 1 \\ 0 & 0 \\ 0 & 0\end{matrix} ] ,$$

and so forth for

$$( \begin{matrix}6 \\ 2\end{matrix} )$$

precoders. In some aspects, Rank 2 partially-coherent codebooks for 2 of 6 antennas may include (with down-selection 0-3, 2-5):

$$\frac{1}{\sqrt{6}} [ \begin{matrix}1 & 0 \\ 0 & 0 \\ 0 & 1 \\ 1 & 0 \\ 0 & 0 \\ 0 & - j\end{matrix} ] ,$$

$$\frac{1}{\sqrt{6}} [ \begin{matrix}1 & 0 \\ 0 & 0 \\ 0 & 1 \\ 1 & 0 \\ 0 & 0 \\ 0 & j\end{matrix} ] ,$$

$$\frac{1}{\sqrt{6}} [ \begin{matrix}1 & 0 \\ 0 & 0 \\ 0 & 1 \\ - j & 0 \\ 0 & 0 \\ 0 & 1\end{matrix} ] ,$$

$$\frac{1}{\sqrt{6}} [ \begin{matrix}1 & 0 \\ 0 & 0 \\ 0 & 1 \\ - j & 0 \\ 0 & 0 \\ 0 & - 1\end{matrix} ] ,$$

$$\frac{1}{\sqrt{6}} [ \begin{matrix}1 & 0 \\ 0 & 0 \\ 0 & 1 \\ - 1 & 0 \\ 0 & 0 \\ 0 & - j\end{matrix} ] ,$$

$$\frac{1}{\sqrt{6}} [ \begin{matrix}1 & 0 \\ 0 & 0 \\ 0 & 1 \\ - 1 & 0 \\ 0 & 0 \\ 0 & j\end{matrix} ] ,$$

$$\frac{1}{\sqrt{6}} [ \begin{matrix}1 & 0 \\ 0 & 0 \\ 0 & 1 \\ j & 0 \\ 0 & 0 \\ 0 & 1\end{matrix} ] ,$$

$$and$$

$$\frac{1}{\sqrt{6}} [ \begin{matrix}1 & 0 \\ 0 & 0 \\ 0 & 1 \\ j & 0 \\ 0 & 0 \\ 0 & - 1\end{matrix} ] .$$

This may be with mode=1 but with O₁=2. In some aspects, Rank 2 partially-coherent codebooks for 4 of 6 antennas may include (0-3-1-4, 2-5):

$$\frac{1}{\sqrt{6}} [ \begin{matrix}1 & 0 \\ 1 & 0 \\ 0 & 1 \\ 1 & 0 \\ 1 & 0 \\ 0 & - 1\end{matrix} ] ,$$

$$\frac{1}{\sqrt{6}} [ \begin{matrix}1 & 0 \\ 1 & 0 \\ 0 & 1 \\ j & 0 \\ j & 0 \\ 0 & - j\end{matrix} ] ,$$

$$\frac{1}{\sqrt{6}} [ \begin{matrix}1 & 0 \\ j & 0 \\ 0 & 1 \\ 1 & 0 \\ j & 0 \\ 0 & - 1\end{matrix} ] ,$$

$$\frac{1}{\sqrt{6}} [ \begin{matrix}1 & 0 \\ j & 0 \\ 0 & 1 \\ j & 0 \\ - 1 & 0 \\ 0 & - j\end{matrix} ] ,$$

$$\frac{1}{\sqrt{6}} [ \begin{matrix}1 & 0 \\ - 1 & 0 \\ 0 & 1 \\ 1 & 0 \\ - 1 & 0 \\ 0 & - 1\end{matrix} ] ,$$

$$\frac{1}{\sqrt{6}} [ \begin{matrix}1 & 0 \\ - 1 & 0 \\ 0 & 1 \\ j & 0 \\ - j & 0 \\ 0 & - j\end{matrix} ] ,$$

$$\frac{1}{\sqrt{6}} [ \begin{matrix}1 & 0 \\ - j & 0 \\ 0 & 1 \\ 1 & 0 \\ - j & 0 \\ 0 & - 1\end{matrix} ] ,$$

$$and$$

$$\frac{1}{\sqrt{6}} [ \begin{matrix}1 & 0 \\ - j & 0 \\ 0 & 1 \\ j & 0 \\ 1 & 0 \\ 0 & - j\end{matrix} ] .$$

In some aspects, Rank 2 partially-coherent codebooks for 4 of 6 antennas may include (0-3-2-5, 1-4):

$$\frac{1}{\sqrt{6}} [ \begin{matrix}1 & 0 \\ 0 & 1 \\ 1 & 0 \\ 1 & 0 \\ 0 & - 1 \\ 1 & 0\end{matrix} ] ,$$

$$\frac{1}{\sqrt{6}} [ \begin{matrix}1 & 0 \\ 0 & 1 \\ 1 & 0 \\ j & 0 \\ 0 & - j \\ j & 0\end{matrix} ] ,$$

$$\frac{1}{\sqrt{6}} [ \begin{matrix}1 & 0 \\ 0 & 1 \\ j & 0 \\ 1 & 0 \\ 0 & - 1 \\ j & 0\end{matrix} ] ,$$

$$\frac{1}{\sqrt{6}} [ \begin{matrix}1 & 0 \\ 0 & 1 \\ j & 0 \\ j & 0 \\ 0 & - j \\ - 1 & 0\end{matrix} ] ,$$

$$\frac{1}{\sqrt{6}} [ \begin{matrix}1 & 0 \\ 0 & 1 \\ - 1 & 0 \\ 1 & 0 \\ 0 & - 1 \\ - 1 & 0\end{matrix} ] ,$$

$$\frac{1}{\sqrt{6}} [ \begin{matrix}1 & 0 \\ 0 & 1 \\ - 1 & 0 \\ j & 0 \\ 0 & - j \\ - j & 0\end{matrix} ] ,$$

$$\frac{1}{\sqrt{6}} [ \begin{matrix}1 & 0 \\ 0 & 1 \\ - j & 1 \\ 1 & 0 \\ 0 & - 1 \\ - j & 0\end{matrix} ] ,$$

$$and$$

$$\frac{1}{\sqrt{6}} [ \begin{matrix}1 & 0 \\ 0 & 1 \\ - j & 0 \\ j & 0 \\ 0 & - j \\ 1 & 0\end{matrix} ] .$$

In some aspects, Rank 2 partially-coherent codebooks for 4 of 6 antennas may include (0-3-2-5, 0-3-2-5):

$$\frac{1}{2 \sqrt{3}} [ \begin{matrix}1 & 1 \\ 0 & 0 \\ 1 & 1 \\ 1 & - 1 \\ 0 & 0 \\ 1 & - 1\end{matrix} ] ,$$

$$\frac{1}{2 \sqrt{3}} [ \begin{matrix}1 & 1 \\ 0 & 0 \\ 1 & 1 \\ j & - j \\ 0 & 0 \\ j & - j\end{matrix} ] ,$$

$$\frac{1}{2 \sqrt{3}} [ \begin{matrix}1 & 1 \\ 0 & 0 \\ j & j \\ 1 & - 1 \\ 0 & 0 \\ j & - j\end{matrix} ] ,$$

$$\frac{1}{2 \sqrt{3}} [ \begin{matrix}1 & 1 \\ 0 & 0 \\ j & j \\ j & - j \\ 0 & 0 \\ - 1 & 1\end{matrix} ] ,$$

$$\frac{1}{2 \sqrt{3}} [ \begin{matrix}1 & 1 \\ 0 & 0 \\ - 1 & - 1 \\ 1 & - 1 \\ 0 & 0 \\ - 1 & 1\end{matrix} ] ,$$

$$\frac{1}{2 \sqrt{3}} [ \begin{matrix}1 & 1 \\ 0 & 0 \\ - 1 & - 1 \\ j & - j \\ 0 & 0 \\ - j & j\end{matrix} ] ,$$

$$\frac{1}{2 \sqrt{3}} [ \begin{matrix}1 & 1 \\ 0 & 0 \\ - j & - j \\ 1 & - 1 \\ 0 & 0 \\ - j & j\end{matrix} ] ,$$

$$and$$

$$\frac{1}{2 \sqrt{3}} [ \begin{matrix}1 & 1 \\ 0 & 0 \\ - j & - j \\ j & - j \\ 0 & 0 \\ 1 & - 1\end{matrix} ] .$$

In some aspects, Rank 3 non-coherent codebooks may include:

$$\frac{1}{\sqrt{6}} [ \begin{matrix}1 & 0 & 0 \\ 0 & 1 & 0 \\ 0 & 0 & 1 \\ 0 & 0 & 0 \\ 0 & 0 & 0 \\ 0 & 0 & 0\end{matrix} ] ,$$

$$\frac{1}{\sqrt{6}} [ \begin{matrix}1 & 0 & 0 \\ 0 & 0 & 0 \\ 0 & 1 & 0 \\ 0 & 0 & 1 \\ 0 & 0 & 0 \\ 0 & 0 & 0\end{matrix} ] ,$$

and so forth for

$$( \begin{matrix}6 \\ 3\end{matrix} )$$

precoders. In some aspects, Rank 3 partially-coherent codebooks for 2 of 6 antennas may include (with down-selection 0-3, 2-5):

$$\frac{1}{\sqrt{6}} [ \begin{matrix}1 & 0 & 0 \\ 0 & 1 & 0 \\ 0 & 0 & 1 \\ 1 & 0 & 0 \\ 0 & j & 0 \\ 0 & 0 & - 1\end{matrix} ] ,$$

$$\frac{1}{\sqrt{6}} [ \begin{matrix}1 & 0 & 0 \\ 0 & 1 & 0 \\ 0 & 0 & 1 \\ j & 0 & 0 \\ 0 & - 1 & 0 \\ 0 & 0 & - j\end{matrix} ] ,$$

$$\frac{1}{\sqrt{6}} [ \begin{matrix}1 & 0 & 0 \\ 0 & 1 & 0 \\ 0 & 0 & 1 \\ - 1 & 0 & 0 \\ 0 & - j & 0 \\ 0 & 0 & 1\end{matrix} ] ,$$

$$and$$

$$\frac{1}{\sqrt{6}} [ \begin{matrix}1 & 0 & 0 \\ 0 & 1 & 0 \\ 0 & 0 & 1 \\ - j & 0 & 0 \\ 0 & 1 & 0 \\ 0 & 0 & j\end{matrix} ] ;$$

$$or$$

$$\frac{1}{\sqrt{6}} [ \begin{matrix}1 & 0 & 0 \\ 0 & 0 & 0 \\ 0 & 1 & 0 \\ 1 & 0 & 0 \\ 0 & 0 & 0 \\ 0 & 0 & 1\end{matrix} ]$$

$$and$$

$$\frac{1}{\sqrt{6}} [ \begin{matrix}1 & 0 & 0 \\ 0 & 0 & 0 \\ 0 & 1 & 0 \\ - 1 & 0 & 0 \\ 0 & 0 & 0 \\ 0 & 0 & 1\end{matrix} ] .$$

In some aspects, Rank 3 partially-coherent codebooks for 4 of 6 antennas may include, with down-selection (0-3-1-4, 2, 5) or (0-3-2-5, 1, 4):

$$\frac{1}{\sqrt{6}} [ \begin{matrix}1 & 0 & 0 \\ 1 & 0 & 0 \\ 0 & 1 & 0 \\ 1 & 0 & 0 \\ 1 & 0 & 0 \\ 0 & 0 & 1\end{matrix} ] ,$$

$$\frac{1}{\sqrt{6}} [ \begin{matrix}1 & 0 & 0 \\ 1 & 0 & 0 \\ 0 & 1 & 0 \\ - 1 & 0 & 0 \\ - 1 & 0 & 0 \\ 0 & 0 & 1\end{matrix} ] ,$$

$$\frac{1}{\sqrt{6}} [ \begin{matrix}1 & 0 & 0 \\ j & 0 & 0 \\ 0 & 1 & 0 \\ 1 & 0 & 0 \\ j & 0 & 0 \\ 0 & 0 & 1\end{matrix} ] ,$$

$$and$$

$$\frac{1}{\sqrt{6}} [ \begin{matrix}1 & 0 & 0 \\ j & 0 & 0 \\ 0 & 1 & 0 \\ - 1 & 0 & 0 \\ - j & 0 & 0 \\ 0 & 0 & 1\end{matrix} ] ;$$

$$or$$

$$\frac{1}{\sqrt{6}} [ \begin{matrix}1 & 0 & 0 \\ 0 & 1 & 0 \\ 1 & 0 & 0 \\ 1 & 0 & 0 \\ 0 & 0 & 1 \\ 1 & 0 & 0\end{matrix} ] ,$$

$$\frac{1}{\sqrt{6}} [ \begin{matrix}1 & 0 & 0 \\ 0 & 1 & 0 \\ 1 & 0 & 0 \\ - 1 & 0 & 0 \\ 0 & 0 & 1 \\ - 1 & 0 & 0\end{matrix} ] ,$$

$$\frac{1}{\sqrt{6}} [ \begin{matrix}1 & 0 & 0 \\ 0 & 1 & 0 \\ j & 0 & 0 \\ 1 & 0 & 0 \\ 0 & 0 & 1 \\ j & 0 & 0\end{matrix} ] ,$$

$$and$$

$$\frac{1}{\sqrt{6}} [ \begin{matrix}1 & 0 & 0 \\ 0 & 1 & 0 \\ j & 0 & 0 \\ - 1 & 0 & 0 \\ 0 & 0 & 1 \\ - j & 0 & 0\end{matrix} ] .$$

In some aspects, Rank 3 partially-coherent codebooks for 4 of 6 antennas may include, with down-selection (0-3-2-5, 0-3-2-5, 0-3-2-5):

$$\frac{1}{3 \sqrt{2}} [ \begin{matrix}1 & 1 & 1 \\ 0 & 0 & 0 \\ 1 & - 1 & 1 \\ 1 & 1 & - 1 \\ 0 & 0 & 0 \\ 1 & - 1 & - 1\end{matrix} ] ,$$

$$\frac{1}{3 \sqrt{2}} [ \begin{matrix}1 & 1 & 1 \\ 0 & 0 & 0 \\ 1 & - 1 & 1 \\ j & j & - j \\ 0 & 0 & 0 \\ j & - j & - j\end{matrix} ] ,$$

$$\frac{1}{3 \sqrt{2}} [ \begin{matrix}1 & 1 & 1 \\ 0 & 0 & 0 \\ - 1 & 1 & - 1 \\ 1 & 1 & - 1 \\ 0 & 0 & 0 \\ - 1 & 1 & 1\end{matrix} ] ,$$

$$and$$

$$\frac{1}{3 \sqrt{2}} [ \begin{matrix}1 & 1 & 1 \\ 0 & 0 & 0 \\ - 1 & 1 & - 1 \\ j & j & - j \\ 0 & 0 & 0 \\ - j & j & j\end{matrix} ] .$$

This may be for O₁=2, i₁∈{0, 2}, and i_{1,3}=0. Parameter i_{1,3} may be associated with a downlink precoding matrix indicator (PMI) for clarifying the beam separation between different layers. Parameter i_{1,3}=0 may be used for uplink.

In some aspects, Rank 4 non-coherent codebooks may include:

$$\frac{1}{\sqrt{6}} [ \begin{matrix}1 & 0 & 0 & 0 \\ 0 & 0 & 0 & 0 \\ 0 & 1 & 0 & 0 \\ 0 & 0 & 1 & 0 \\ 0 & 0 & 0 & 0 \\ 0 & 0 & 0 & 1\end{matrix} ]$$

and so forth for

$$( \begin{matrix}6 \\ 4\end{matrix} )$$

precoders. In some aspects, Rank 4 partially-coherent codebooks for 2 of 6 antennas may include, with down-selection (0-3, 1-4, 2-5), (0-3, 2-5, 1, 4), or (0-3-2-5):

$$\{ \frac{1}{\sqrt{6}} [ \begin{matrix}1 & 0 & 0 & 0 \\ 0 & 1 & 0 & 0 \\ 0 & 0 & 1 & 0 \\ 1 & 0 & 0 & 0 \\ 0 & - 1 & 0 & 0 \\ 0 & 0 & 0 & 1\end{matrix} ] , \frac{1}{\sqrt{6}} [ \begin{matrix}1 & 0 & 0 & 0 \\ 0 & 1 & 0 & 0 \\ 0 & 0 & 1 & 0 \\ j & 0 & 0 & 0 \\ 0 & - j & 0 & 0 \\ 0 & 0 & 0 & 1\end{matrix} ] \}$$

$$or$$

$$\{ \frac{1}{2 \sqrt{3}} [ \begin{matrix}1 & 1 & 0 & 0 \\ 0 & 0 & 0 & 0 \\ 0 & 0 & 1 & 1 \\ 1 & - 1 & 0 & 0 \\ 0 & 0 & 0 & 0 \\ 0 & 0 & 1 & - 1\end{matrix} ] , \frac{1}{2 \sqrt{3}} [ \begin{matrix}1 & 1 & 0 & 0 \\ 0 & 0 & 0 & 0 \\ 0 & 0 & 1 & 1 \\ j & - j & 0 & 0 \\ 0 & 0 & 0 & 0 \\ 0 & 0 & j & - j\end{matrix} ] \} .$$

In some aspects, Rank 4 partially-coherent codebooks for 4 of 6 antennas may include, with down-selection (0-3, 1-4, 2-5) or (0-3-2-5):

$$\{ \frac{1}{2 \sqrt{3}} [ \begin{matrix}1 & 1 & 0 & 0 \\ 1 & - 1 & 0 & 0 \\ 0 & 0 & 1 & 1 \\ 1 & 1 & 0 & 0 \\ 1 & - 1 & 0 & 0 \\ 0 & 0 & 1 & - 1\end{matrix} ] , \frac{1}{2 \sqrt{3}} [ \begin{matrix}1 & 1 & 0 & 0 \\ 0 & - 1 & 0 & 0 \\ 0 & 0 & 1 & 1 \\ j & j & 0 & 0 \\ j & - j & 0 & 0 \\ 0 & 0 & j & - j\end{matrix} ] \}$$

$$or$$

$$\{ \frac{1}{2 \sqrt{6}} [ \begin{matrix}1 & 1 & 1 & 1 \\ 0 & 0 & 0 & 0 \\ 1 & - 1 & 1 & - 1 \\ 1 & 1 & - 1 & - 1 \\ 0 & 0 & 0 & 0 \\ 1 & - 1 & - 1 & 1\end{matrix} ] , \frac{1}{2 \sqrt{6}} [ \begin{matrix}1 & 1 & 1 & 1 \\ 0 & 0 & 0 & 0 \\ 1 & - 1 & 1 & - 1 \\ j & j & - j & - j \\ 0 & 0 & 0 & 0 \\ j & - j & - j & j\end{matrix} ] \} .$$

As indicated above, FIG. 4 is provided as an example. Other examples may differ from what is described with regard to FIG. 4.

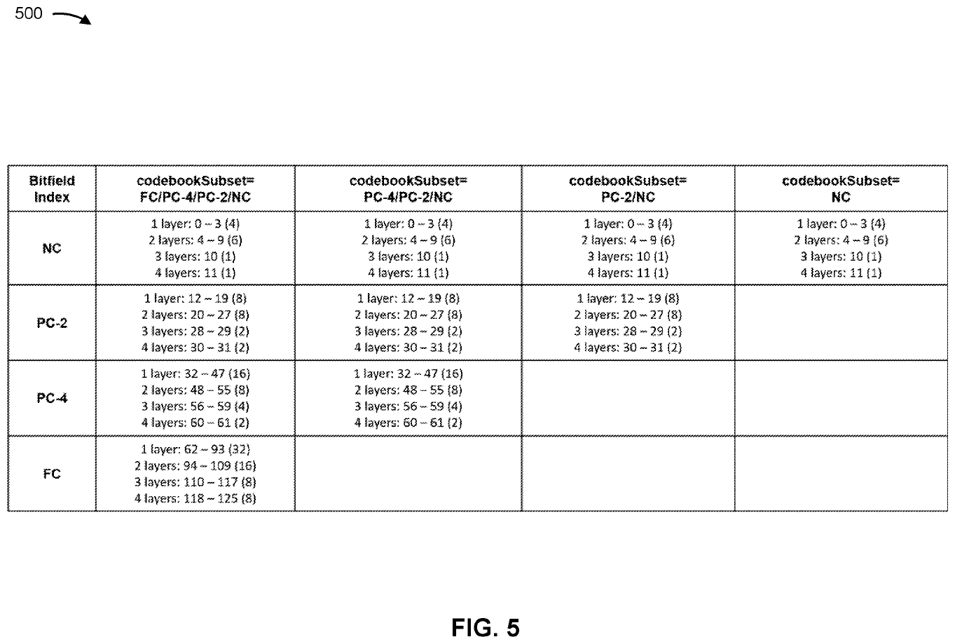

FIG. 5 is a diagram illustrating an example 500 of TPMIs, in accordance with the present disclosure.

There may be a large quantity of TPMIs (codepoints) for indicating codebooks for 8 antennas and for multiple ranks. In some aspects, the quantity of TPMIs used for indicating codebooks may be reduced. For example, in a scenario of Rank 1, there may be 8 possible precoding matrices for non-coherent codebooks, and this quantity may be down-selected (0, 4, 2, 6) to 4 precoding matrices. There may be 16 possible precoding matrices for partially-coherent (2-antenna) codebooks, and this quantity may be down-selected (0-4, 2-6) to 8 (or 4) precoding matrices (with half-subsampling and/or changing from QPSK to BPSK). There may be 32 possible precoding matrices for partially-coherent (4-antenna) codebooks, and this quantity may be down-selected (0-4-2-6) to 16 (or 8 or 4) precoding matrices (with half-subsampling or quarter-subsampling, changing from QPSK to BPSK, and/or changing oversampling factors from 2 to 1). There may be 32 possible precoding matrices for full-coherent codebooks, and this quantity may remain as 32 precoding matrices (or down-selected to 16 or 8 with half-subsampling or quarter-subsampling, changing from QPSK to BPSK, and/or changing oversampling factors from 2 to 1).

In some aspects, the quantity of TPMIs used for indicating codebooks may be reduced in a scenario of Rank 2. There may be 28 possible precoding matrices for non-coherent codebooks, and this quantity may be down-selected (0, 4, 2, 6) to 6 precoding matrices. There may be 16 possible precoding matrices for partially-coherent (2-antenna) codebooks, and this quantity may be down-selected (0-4, 2-6) to 8 (or 4) precoding matrices (with half-subsampling and/or reducing co-phasing cases). There may be 8 possible precoding matrices for partially-coherent (4-antenna) codebooks, and this quantity may be 8 precoding matrices (or down-selected to 4 precoding matrices with half-subsampling and/or changing oversampling factors from 2 to 1). There may be 16 possible precoding matrices for full-coherent codebooks, and this quantity may remain as 16 precoding matrices (or down-selected to 8 with half-subsampling and/or changing oversampling factors from 2 to 1).

In some aspects, the quantity of TPMIs used for indicating codebooks may be reduced in a scenario of Rank 3. There may be 56 possible precoding matrices for non-coherent codebooks, and this quantity may be down-selected (0, 4, 2, 6) to 4 or 1 precoding matrices with subsampling. There may be 8 possible precoding matrices for partially-coherent (2-antenna) codebooks, and this quantity may be down-selected (0-4, 1-5, 2-6) to 4 or 2 precoding matrices with subsampling. There may be 8 possible precoding matrices for partially-coherent (4-antenna) codebooks, and this quantity may be down-selected to 4 (or 2) precoding matrices with half-subsampling and/or changing oversampling factors from 2 to 1. There may be 16 possible precoding matrices for full-coherent codebooks, and this quantity may be down-selected to 8 (or 4) precoding matrices with changing oversampling factors from 2 to 1 and/or half-subsampling, quarter subsampling, or other subsampling.

In some aspects, the quantity of TPMIs used for indicating codebooks may be reduced in a scenario of Rank 4. There may be 70 possible precoding matrices for non-coherent codebooks, and this quantity may be down-selected (0, 4, 2, 6) to 1 precoding matrix. There may be 2 possible precoding matrices for partially-coherent (2-antenna) codebooks, and this quantity may remain as 2 precoding matrices. There may be 8 possible precoding matrices for partially-coherent (4-antenna) codebooks, and this quantity may be down-selected to 2 precoding matrices. There may be 16 possible precoding matrices for full-coherent codebooks, and this quantity may be down-selected to 8 (or 4) precoding matrices with changing oversampling factors from 2 to 1 and/or half-subsampling, quarter subsampling, or other subsampling.

Example 500 shows a table of precoding matrices for Rank 2, 3, or 4 that are available for non-coherent (NC), partially-coherent with 2 antennas (PC-2), partially-coherent with 4 antennas (PC-4), and full-coherent (FC) bitfield TPMIs. The quantity of bits may be 4, 5, 6, or 7. The table in example 500 shows no change in the TPMIs with each codebook subset restriction (CSR) step from a full-coherent codebook set, to a partially-coherent 4-antenna codebook subset, to a partially-coherent 2-antenna codebook subset, to a non-coherent codebook subset. In some aspects, this table may be used for 8 antennas.

As indicated above, FIG. 5 is provided as an example. Other examples may differ from what is described with regard to FIG. 5.

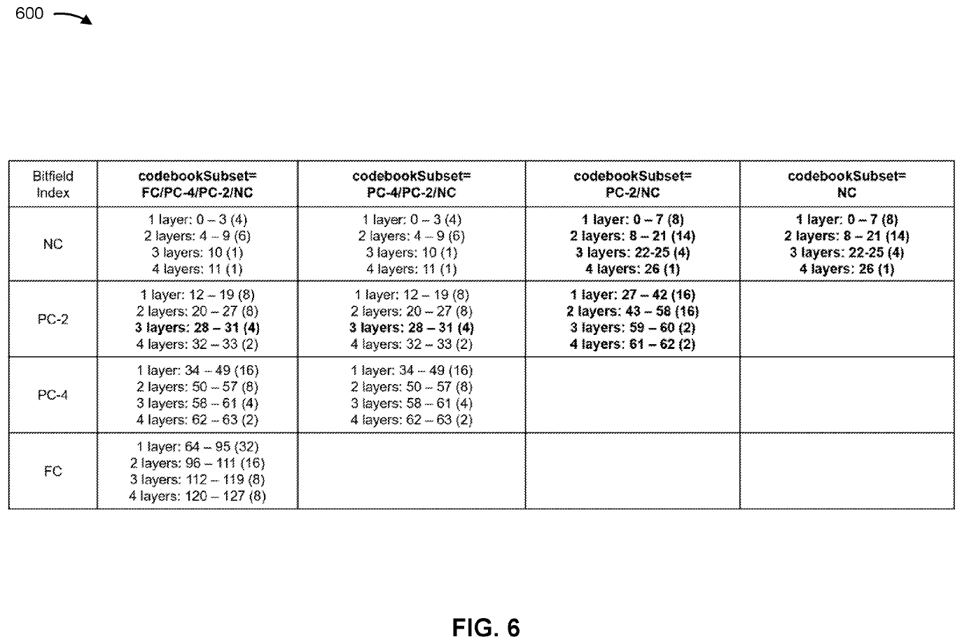

FIG. 6 is a diagram illustrating an example 600 of TPMIs with TPMI changes, in accordance with the present disclosure.

Example 600 shows a table, similar to the table in example 500, where there are differences in the TPMIs (and the quantity of TPMIs and corresponding precoding matrices). The differences in the table of example 600 over the table in example 500 are shown in bold. The quantity of bits may be 5, 6, 6, or 7. In some aspects, the table of example 600 may be used for 8 antennas.

As indicated above, FIG. 6 is provided as an example. Other examples may differ from what is described with regard to FIG. 6.

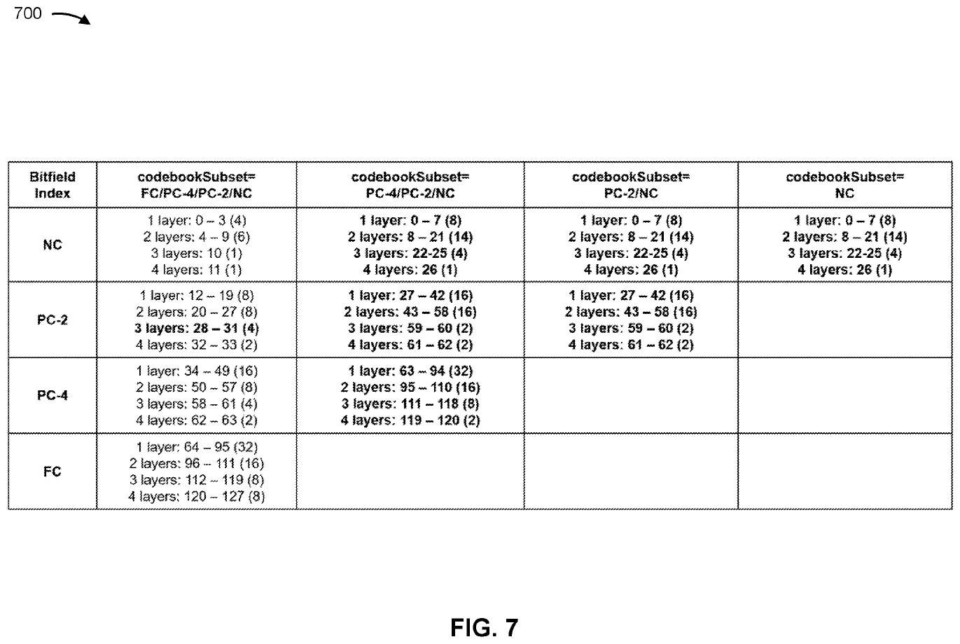

FIG. 7 is a diagram illustrating an example 700 of TPMIs with TPMI changes, in accordance with the present disclosure.

Example 700 shows a table, similar to the table in example 500, where there are differences in the TPMIs (and the quantity of TPMIs and corresponding precoding matrices). The differences in the table of example 700 over the table in example 500 are shown in bold. The quantity of bits may be 5, 6, 7, or 7. In some aspects, the table of example 700 may be used for 8 antennas.

A large codebook may be defined without considering port down-selection and subsampling. The quantity of DCI bits for TPMI indication may be fixed for different CSRs (e.g., to 4-5-6-7 bits). Higher-layer signaling (RRC and/or MAC CE) may be used to select antennas or precoding matrix codebooks for a TPMI field.

In some aspects, non-coherent codebooks for 8 antennas may be reduced for TPMI mapping. For example, for Rank 1, 8 precoders may be reduced to 4 precoders for TPMI mapping. For Rank 2, 28 precoders may be reduced to 6 precoders. For Rank 3, 56 precoders may be reduced to 4 precoders. Fore Rank 4, 70 precoders may be reduced to 1 precoder.

As indicated above, FIG. 7 is provided as an example. Other examples may differ from what is described with regard to FIG. 7.

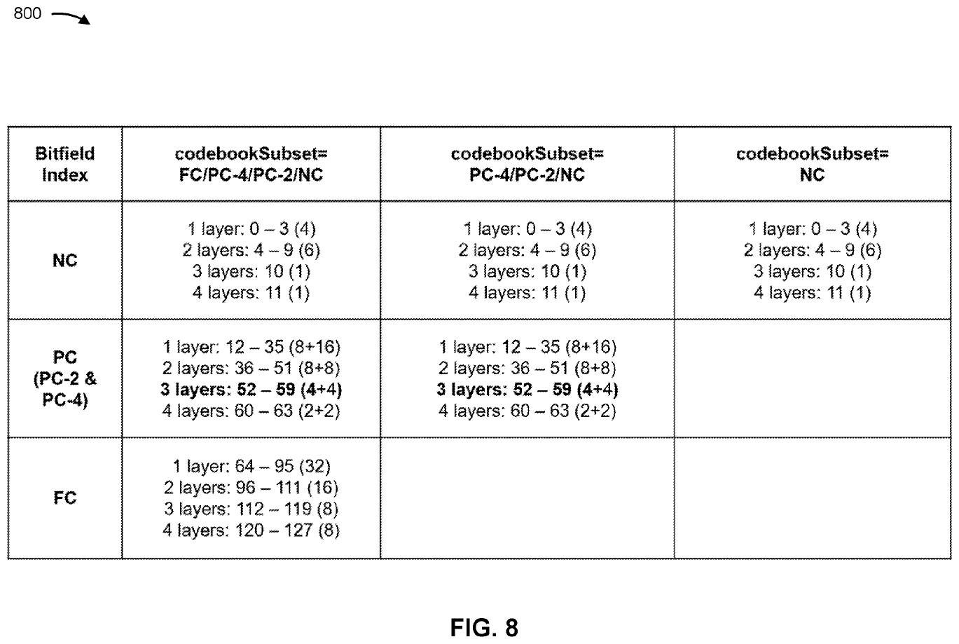

FIG. 8 is a diagram illustrating an example 800 of TPMIs with TPMI changes, in accordance with the present disclosure.

Example 800 shows a table, similar to the table in example 500, where there are differences in the TPMIs (and the quantity of TPMIs and corresponding precoding matrices). The differences in the table of example 800 over the table in example 500 are shown in bold. The quantity of bits may be 4, 6 and 7. In some aspects, the table of example 800 may be used for 8 antennas.

As indicated above, FIG. 8 is provided as an example. Other examples may differ from what is described with regard to FIG. 8.

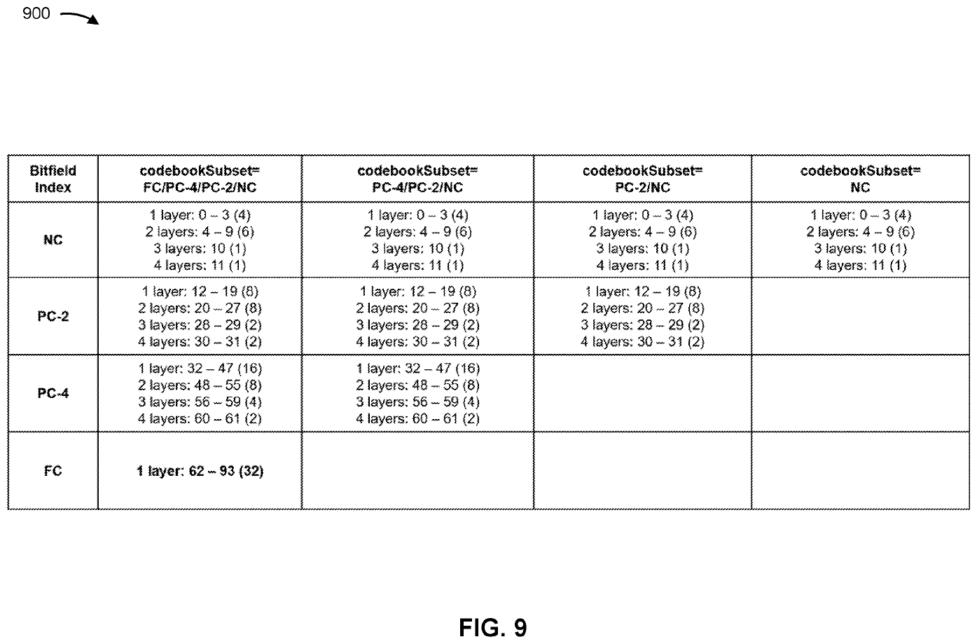

FIG. 9 is a diagram illustrating an example 900 of TPMIs, in accordance with the present disclosure.

8 antenna uplink codebooks may be used for DFT-s-OFDM. For Rank 1, the design of the codebooks may be the same as used for cyclic prefix OFDM (CP-OFDM). For Ranks 2-4, the design of the codebooks may be the same as used for CP-OFDM, except that for Rank 4, new codebooks for partially-coherent 4-antenna may be specified as:

$$\frac{1}{2 \sqrt{2}} [ \begin{matrix}1 & 0 & 0 & 0 \\ 0 & 1 & 0 & 0 \\ 1 & 0 & 0 & 0 \\ 0 & 0 & 1 & 0 \\ 1 & 0 & 0 & 0 \\ 0 & - 1 & 0 & 0 \\ 1 & 0 & 0 & 0 \\ 0 & 0 & 0 & 1\end{matrix} ]$$

$$and$$

$$\frac{1}{2 \sqrt{2}} [ \begin{matrix}1 & 0 & 0 & 0 \\ 0 & 1 & 0 & 0 \\ 1 & 0 & 0 & 0 \\ 0 & 0 & 1 & 0 \\ j & 0 & 0 & 0 \\ 0 & - j & 0 & 0 \\ j & 0 & 0 & 0 \\ 0 & 0 & 0 & 1\end{matrix} ] .$$

Example 900 shows a table, similar to the table in example 500, where there are differences in the TPMIs (and the quantity of TPMIs and corresponding precoding matrices). The difference in the table of example 900 over the table in example 500 is shown for full-coherent codebooks, where the quantity of precoding matrices may be the same as for CP-OFDM except for full-coherent codebooks. There may be 32 possible precoding matrices for full-coherent codebooks. The quantity of bits may be 4, 5, 6 and 7. In some aspects, the table of example 900 may be used for 8 antennas.

As indicated above, FIG. 9 is provided as an example. Other examples may differ from what is described with regard to FIG. 9.

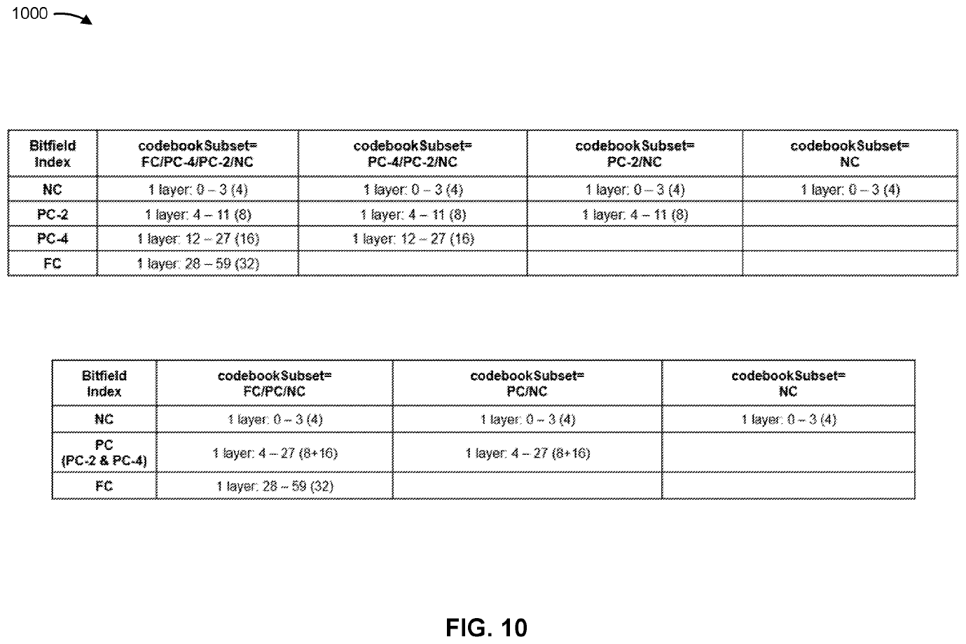

FIG. 10 is a diagram illustrating an example 1000 of TPMIs, in accordance with the present disclosure.

Example 1000 shows two tables for Rank 1. The quantity of bits for the first table may be 2, 4, 5, and 6 bits. The quantity of bits for the second table may be 2, 5, and 6 bits. In some aspects, the tables of example 1000 may be used for 8 antennas.

As indicated above, FIG. 10 is provided as an example. Other examples may differ from what is described with regard to FIG. 10.

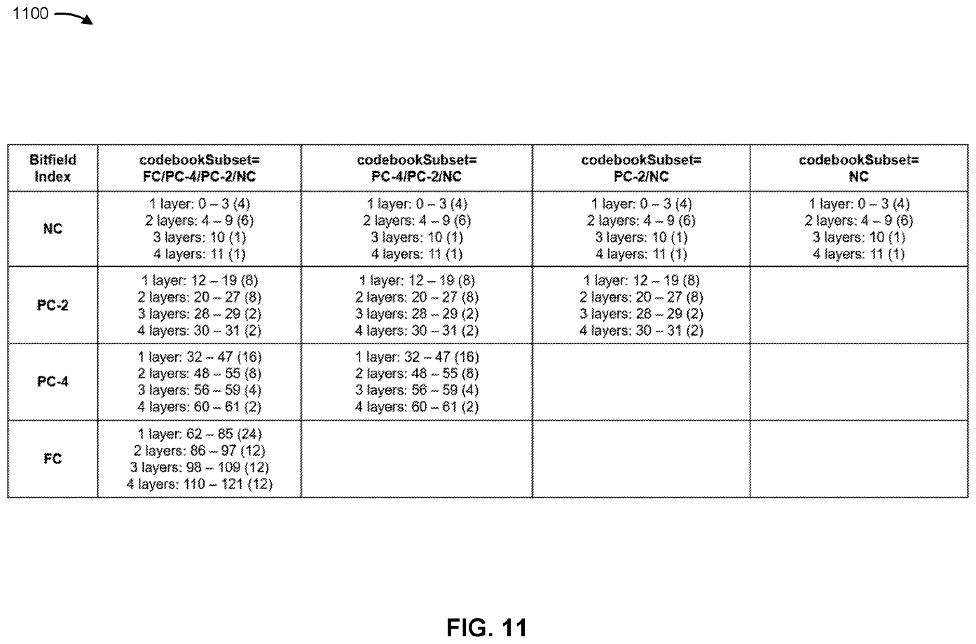

FIG. 11 is a diagram illustrating an example 1100 of TPMIs, in accordance with the present disclosure.

There may be a large quantity of TPMIs (codepoints) for indicating codebooks for 6 antennas and for multiple ranks. In some aspects, the quantity of TPMIs used for indicating codebooks may be reduced. For example, in a scenario of Rank 1, there may be 6 possible precoding matrices for non-coherent codebooks, and this quantity may be down-selected (0, 3, 2, 5) to 4 precoding matrices. There may be 12 possible precoding matrices (0-3, 1-4, 2-5) for partially-coherent (2-antenna) codebooks, and this quantity may be down-selected (0-3, 2-5) to 8 (or 4) precoding matrices (with half-subsampling and/or changing from QPSK to BPSK). There may be 16 possible precoding matrices for partially-coherent (4-antenna) codebooks after down-selection (0-3-2-5) (or 8 or 4) precoding matrices (with half-subsampling or quarter-subsampling, changing from QPSK to BPSK, changing oversampling factors from 2 to 1, and/or i₁=0 or 1). There may be 24 possible precoding matrices for full-coherent codebooks, and this quantity may remain as 24 precoding matrices (or down-selected to 12 or 8 with half-subsampling or quarter-subsampling, changing from QPSK to BPSK, changing oversampling factors from 2 to 1, and/or i₁=0, 1 or 2).

In some aspects, the quantity of TPMIs used for indicating codebooks may be reduced in a scenario of Rank 2. There may be 15 possible precoding matrices for non-coherent codebooks, and this quantity may be down-selected (0, 3, 2, 5) to 6 precoding matrices. There may be 24 possible precoding matrices (0-3, 1-4, 2-5) for partially-coherent (2-antenna) codebooks, and this quantity may be down-selected (0-3, 2-5) to 8 (or 4) precoding matrices (with half-subsampling and/or reducing co-phasing cases). There may be 8 possible precoding matrices (0-3-1-4, 2-5) for partially-coherent (4-antenna) codebooks, and this quantity may be 8 precoding matrices (or down-selected (0-3-2-5, 0-3-2-5) to 4 precoding matrices with half-subsampling, changing oversampling factors from 2 to 1, and/or i₁=0 or 1). There may be 12 possible precoding matrices for full-coherent codebooks, and this quantity may remain as 12 precoding matrices (or down-selected to 6 or 4 with half-subsampling, changing oversampling factors from 2 to 1, and/or i₁=0, 1 or 2).

In some aspects, the quantity of TPMIs used for indicating codebooks may be reduced in a scenario of Rank 3. There may be 20 possible precoding matrices for non-coherent codebooks, and this quantity may be down-selected (0, 3, 2, 5) to 4 or 1 precoding matrices with subsampling (1 for (0,3,2)). There may be 4 possible precoding matrices (0-3, 1-4, 2-5) for partially-coherent (2-antenna) codebooks, and this quantity may remain at 4 precoding matrices or be down-selected (0-3, 2, 5) to 2 precoding matrices. There may be 4 possible precoding matrices (0-3-1-4, 2, 5) for partially-coherent (4-antenna) codebooks, and this quantity may remain at 4 precoding matrices or be down-selected (0-3-2-5, 0-3-2-5, 0-3-2-5) to 2 precoding matrices with subsampling (2). There may be 12 possible precoding matrices for full-coherent codebooks, and this quantity may remain at 12 or be down-selected to 6 (or 4) precoding matrices with changing oversampling factors from 2 to 1 and/or half-subsampling, third-subsampling, or other subsampling.

In some aspects, the quantity of TPMIs used for indicating codebooks may be reduced in a scenario of Rank 4. There may be 15 possible precoding matrices for non-coherent codebooks, and this quantity may be down-selected (0, 3, 2, 5) to 1 precoding matrix. There may be 2 possible precoding matrices (0-3, 1-4, 2, 5 or 0-3, 2-5, 1, 4) for partially-coherent (2-antenna) codebooks, and this quantity may remain as 2 precoding matrices. There may be down-selection to (0-3, 0-3, 2-5, 2-5). There may be 2 possible precoding matrices (0-3-1-4, 0-3-1-4, 2-6, 2-6) for partially-coherent (4-antenna) codebooks, and this quantity may be down-selected (0-3-2-5) to 2 precoding matrices. There may be 12 possible precoding matrices for full-coherent codebooks, and this quantity may remain at 12 precoding matrices or may be down-selected to 6 (or 4) precoding matrices with changing oversampling factors from 2 to 1 and/or half-subsampling, third-subsampling, or other subsampling.

Example 1100 shows a table of precoding matrices for Rank 2, 3, or 4 that are available for non-coherent (NC), partially-coherent with 2 antennas (PC-2), partially-coherent with 4 antennas (PC-4), and full-coherent (FC) bitfield TPMIs. The quantity of bits may be 4, 5, 6, or 7. The table in example 1100 shows no change in the TPMIs with each CSR step from a full-coherent codebook set, to a partially-coherent 4-antenna codebook subset, to a partially-coherent 2-antenna codebook subset, to a non-coherent codebook subset. In some aspects, this table may be used for 6 antennas.

As indicated above, FIG. 11 is provided as an example. Other examples may differ from what is described with regard to FIG. 11.

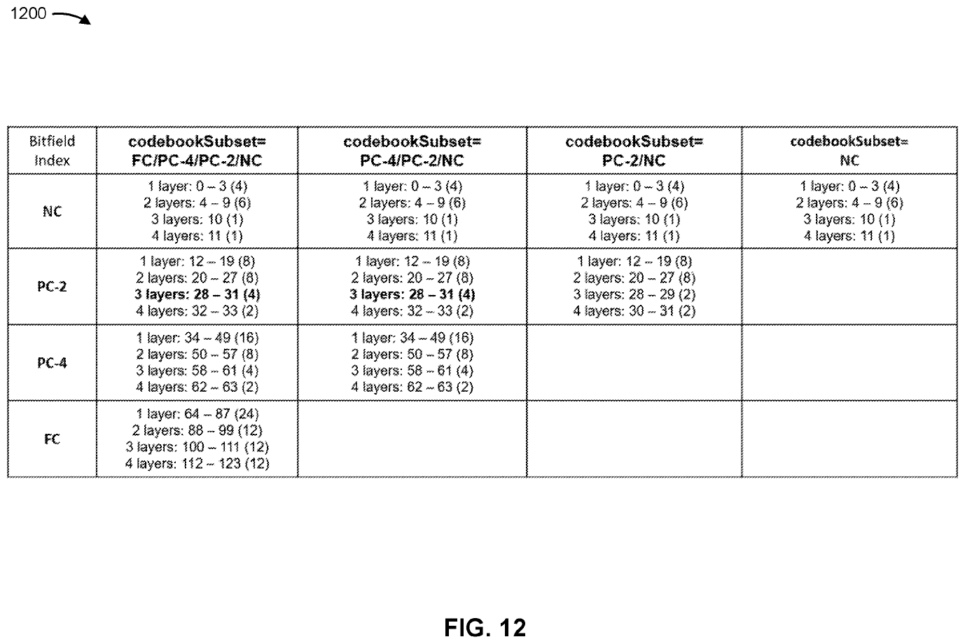

FIG. 12 is a diagram illustrating an example 1200 of TPMIs with TPMI changes, in accordance with the present disclosure.

Example 1200 shows a table, similar to the table in example 1100, where there are differences in the TPMIs (and the quantity of TPMIs and corresponding precoding matrices). The differences in the table of example 1200 over the table in example 1100 are shown in bold. In some aspects, the table of example 1200 may be used for 6 antennas.

As indicated above, FIG. 12 is provided as an example. Other examples may differ from what is described with regard to FIG. 12.

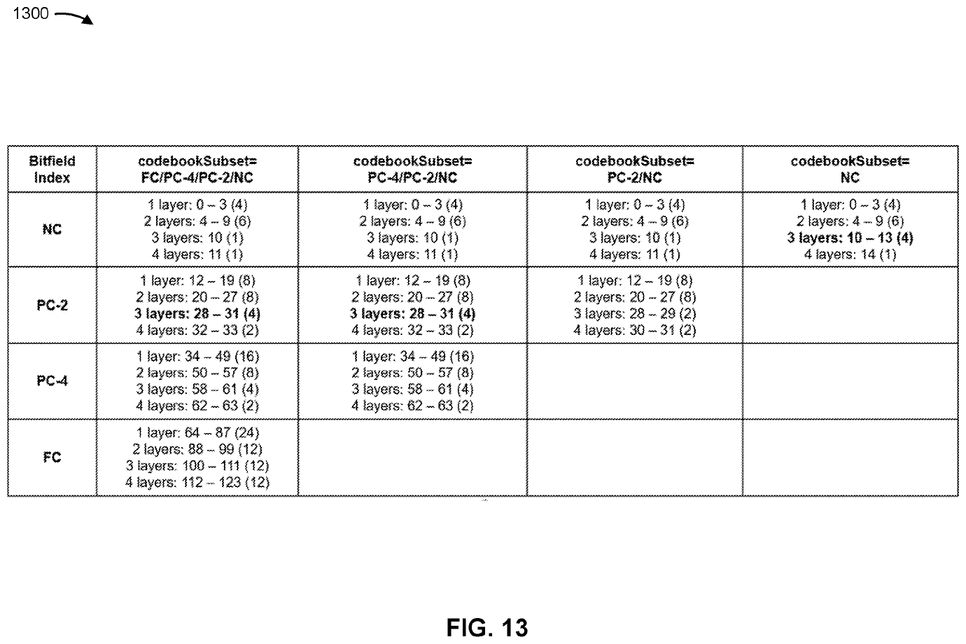

FIG. 13 is a diagram illustrating an example 1300 of TPMIs with TPMI changes, in accordance with the present disclosure.

Example 1300 shows a table, similar to the table in example 1100, where there are differences in the TPMIs (and the quantity of TPMIs and corresponding precoding matrices). The differences in the table of example 1300 over the table in example 1100 are shown in bold. In some aspects, the table of example 1300 may be used for 6 antennas.

As indicated above, FIG. 13 is provided as an example. Other examples may differ from what is described with regard to FIG. 13.

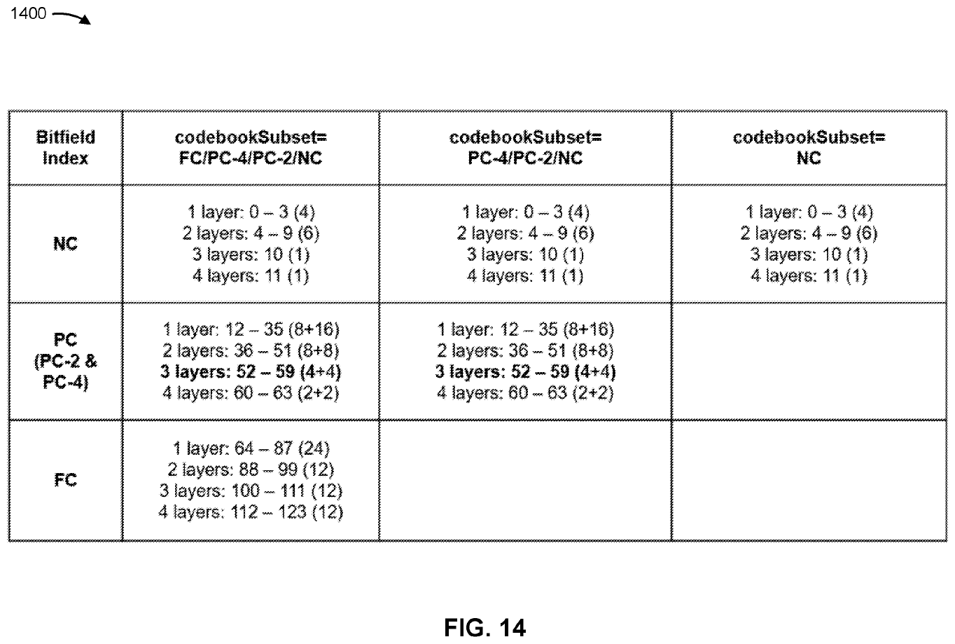

FIG. 14 is a diagram illustrating an example 1400 of TPMIs with TPMI changes, in accordance with the present disclosure.

Example 1400 shows a table where there are differences in the TPMIs (and the quantity of TPMIs and corresponding precoding matrices). The differences in the table of example 1400 over the table in example 1100 are shown in bold. The quantity of bits may be 4, 6 and 7. In some aspects, the table of example 1400 may be used for 6 antennas.

As indicated above, FIG. 14 is provided as an example. Other examples may differ from what is described with regard to FIG. 14.

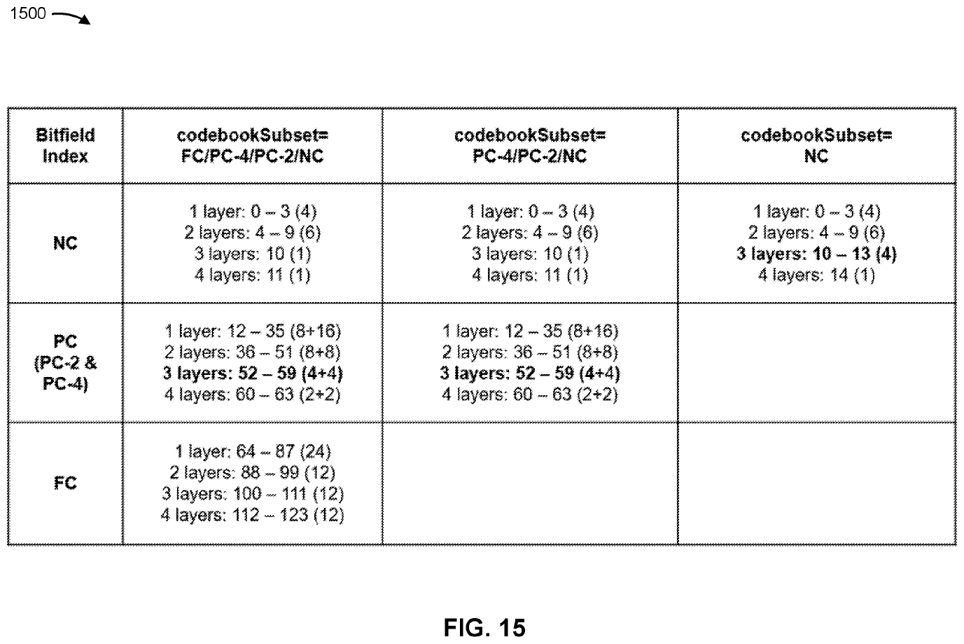

FIG. 15 is a diagram illustrating an example 1500 of TPMIs, in accordance with the present disclosure. Example 1500 shows a table with TPMIs for Rank 2, 3, and 4. In some aspects, the table of example 1500 may be used for 6 antennas. FIG. 15 is provided as an example. Other examples may differ from what is described with regard to FIG. 15.

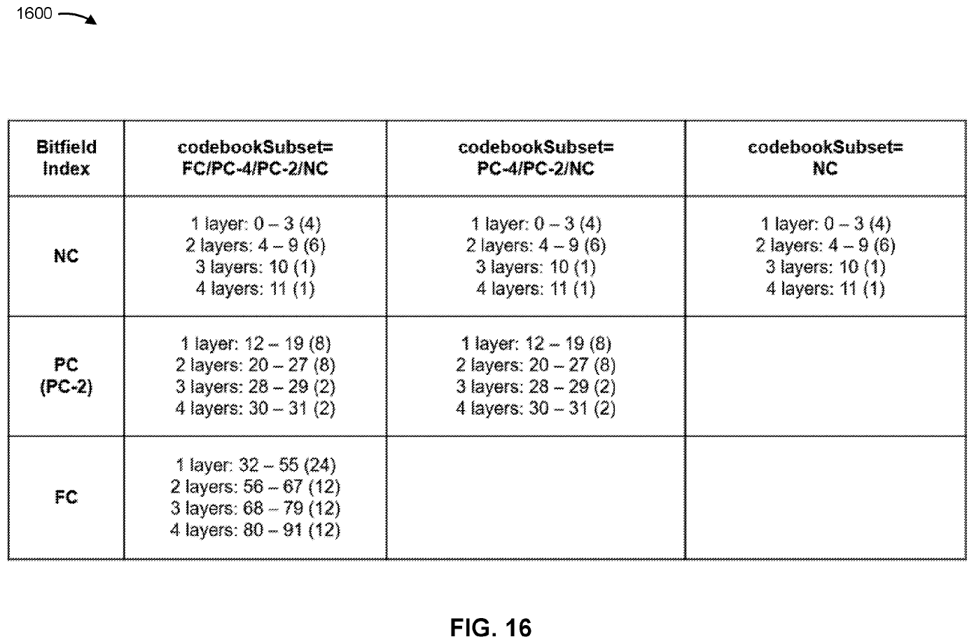

FIG. 16 is a diagram illustrating an example 1600 of TPMIs with TPMI changes, in accordance with the present disclosure. Example 1600 shows a table with TPMIs for Rank 2, 3, and 4. The quantity of bits may be 4, 5 or 7 bits. In some aspects, the table of example 1600 may be used for 6 antennas. FIG. 16 is provided as an example. Other examples may differ from what is described with regard to FIG. 16.

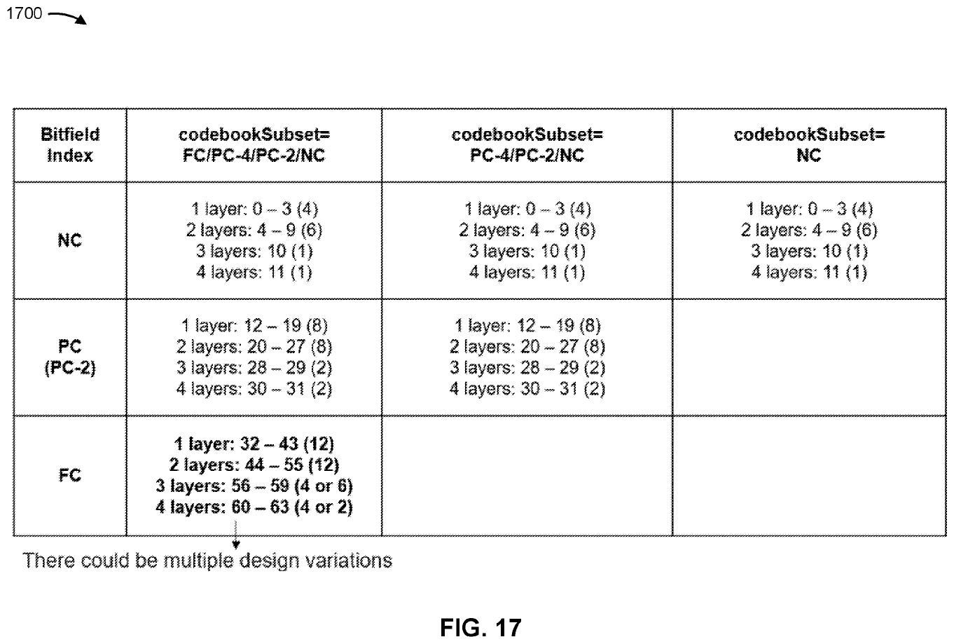

FIG. 17 is a diagram illustrating an example 1700 of TPMIs with TPMI changes, in accordance with the present disclosure.

Example 1700 shows a table, similar to the table in example 1600, where there are differences in the TPMIs (and the quantity of TPMIs and corresponding precoding matrices). The differences in the table of example 1600 over the table in example 1600 are shown in bold. In some aspects, the table of example 1700 may be used for 6 antennas.

As indicated above, FIG. 17 is provided as an example. Other examples may differ from what is described with regard to FIG. 17.

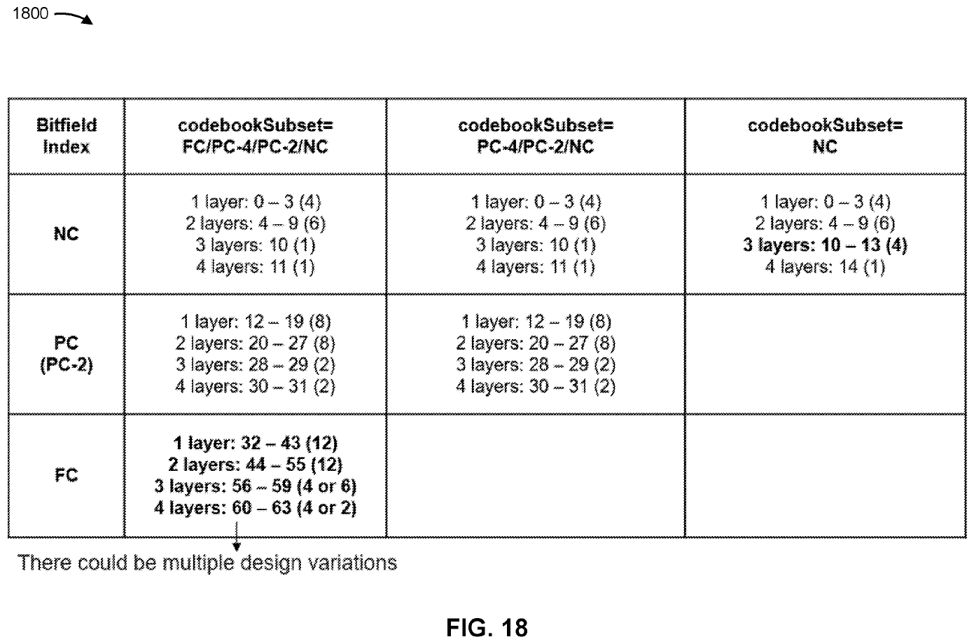

FIG. 18 is a diagram illustrating an example 1800 of TPMIs, in accordance with the present disclosure. Example 1800 shows a table with TPMIs for Rank 2, 3, or 4. There may be 4, 5, or 6 bits. In some aspects, the table of example 1800 may be used for 6 antennas. FIG. 18 is provided as an example. Other examples may differ from what is described with regard to FIG. 18.

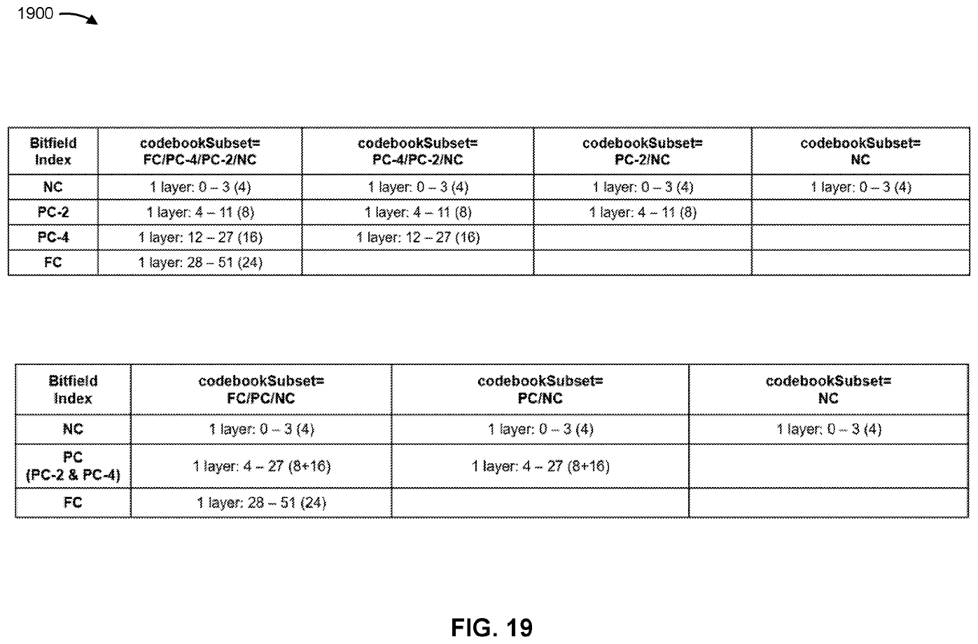

FIG. 19 is a diagram illustrating an example 1900 of TPMIs, in accordance with the present disclosure. Example 1900 shows tables with TPMIs for Rank 1. The quantity of bits may be 2, 4, 5 or 6 bits for the first table and 2, 5, or 6 bits for the second table. In some aspects, the tables of example 1900 may be used for 6 antennas. FIG. 19 is provided as an example. Other examples may differ from what is described with regard to FIG. 19.

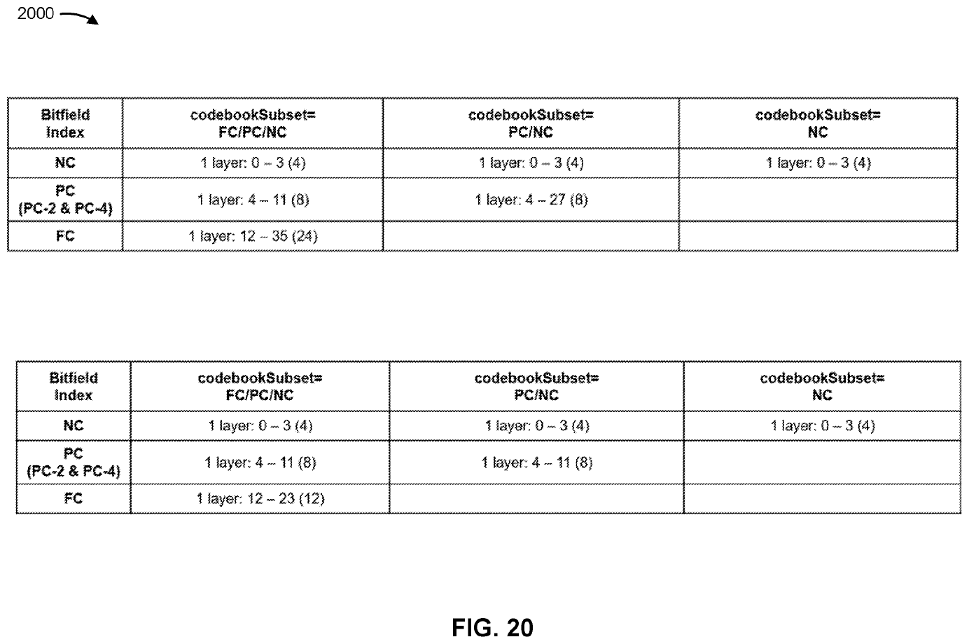

FIG. 20 is a diagram illustrating an example 2000 of TPMIs, in accordance with the present disclosure. Example 2000 shows other tables with TPMIs for Rank 1. The quantity of bits may be 2, 4, or 6 bits for the first table and 2, 4, or 5 bits for the second table. In some aspects, the tables of example 2000 may be used for 6 antennas. FIG. 20 is provided as an example. Other examples may differ from what is described with regard to FIG. 20.

FIG. 21 is a diagram illustrating an example process 2100 performed, for example, by a wireless communication device, in accordance with the present disclosure. Example process 2100 is an example where the wireless communication device (e.g., UE 120, base station 110) performs operations associated with using MIMO codebooks designed for a wireless communication device configured with 6 or 8 antennas.

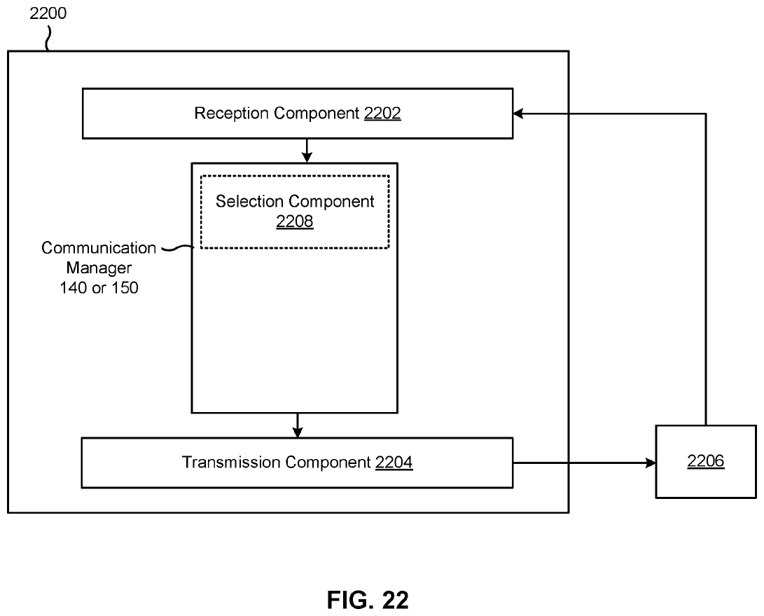

As shown in FIG. 21, in some aspects, process 2100 may include selecting a codebook for a MIMO communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device (block 2110). For example, the wireless communication device (e.g., using communication manager 140 or communication manager 150 and/or selection component 2208 depicted in FIG. 22) may select a codebook for a MIMO communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device, as described above.

As further shown in FIG. 21, in some aspects, process 2100 may include transmitting or receiving the communication using the codebook (block 2120). For example, the wireless communication device (e.g., using communication manager 140 or communication manager 150 and/or transmission component 2204 depicted in FIG. 22) may transmit or receive the communication using the codebook, as described above.

Process 2100 may include additional aspects, such as any single aspect or any combination of aspects described below and/or in connection with one or more other processes described elsewhere herein.

In a first aspect, the wireless communication device is configured with 8 antennas for the communication, and process 2100 includes transmitting or receiving a TPMI field that indicates one of 12 precoding matrices for use with 1 antenna, one of 20 precoding matrices for use with 2 antennas, one of 30 precoding matrices for use with 4 antennas, or one of 64 precoding matrices for use with 8 antennas.

In a second aspect, alone or in combination with the first aspect, the wireless communication device is configured with 8 antennas for the communication, and process 2100 includes transmitting or receiving a TPMI field that indicates one of 27 precoding matrices for use with 1 antenna, one of 36 precoding matrices for use with 2 antennas, one of 30 precoding matrices for use with 4 antennas, or one of 64 precoding matrices for use with 8 antennas.

In a third aspect, alone or in combination with one or more of the first and second aspects, the wireless communication device is configured with 8 antennas for the communication, and process 2100 includes transmitting or receiving a TPMI field that indicates one of 27 precoding matrices for use with 1 antenna, one of 36 precoding matrices for use with 2 antennas, one of 58 precoding matrices for use with 4 antennas, or one of 64 precoding matrices for use with 8 antennas.

In a fourth aspect, alone or in combination with one or more of the first through third aspects, the wireless communication device is configured with 8 antennas for the communication, and process 2100 includes transmitting or receiving a TPMI field that includes 4 bits to indicate a precoder for use with 1 antenna, 5 bits to indicate a precoder for use with 2 antennas, 6 bits to indicate a precoder for use with 4 antennas, or 7 bits to indicate a precoder for use with 8 antennas.

In a fifth aspect, alone or in combination with one or more of the first through fourth aspects, the wireless communication device is configured with 8 antennas for the communication, and process 2100 includes transmitting or receiving a TPMI field that indicates one of 12 precoding matrices for use with 1 antenna, one of 52 precoding matrices for use with 2 antennas or 4 antennas, or one of 64 precoding matrices for use with 8 antennas.

In a sixth aspect, alone or in combination with one or more of the first through fifth aspects, one or more codebooks may be specified as described herein or shown in the figures.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram of an example apparatus 2200 for wireless communication. The apparatus 2200 may be a wireless communication device (e.g., UE 120, base station 110), or a wireless communication device may include the apparatus 2200. In some aspects, the apparatus 2200 includes a reception component 2202 and a transmission component 2204, which may be in communication with one another (for example, via one or more buses and/or one or more other components). As shown, the apparatus 2200 may communicate with another apparatus 2206 (such as a UE, a base station, or another wireless communication device) using the reception component 2202 and the transmission component 2204. As further shown, the apparatus 2200 may include the communication manager 140 or the communication manager 150. The communication manager 140 or the communication manager 150 may include a selection component 2208, among other examples.

In some aspects, the apparatus 2200 may be configured to perform one or more operations described herein in connection with FIGS. 1-20. Additionally, or alternatively, the apparatus 2200 may be configured to perform one or more processes described herein, such as process 2100 of FIG. 21. In some aspects, the apparatus 2200 and/or one or more components shown in FIG. 22 may include one or more components of the wireless communication device described in connection with FIG. 2. Additionally, or alternatively, one or more components shown in FIG. 22 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2202 may receive communications, such as reference signals, control information, data communications, or a combination thereof, from the apparatus 2206. The reception component 2202 may provide received communications to one or more other components of the apparatus 2200. In some aspects, the reception component 2202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2200. In some aspects, the reception component 2202 may include one or more antennas, a modem, a demodulator, a MIMO detector, a receive processor, a controller/processor, a memory, or a combination thereof, of the wireless communication device described in connection with FIG. 2.

The transmission component 2204 may transmit communications, such as reference signals, control information, data communications, or a combination thereof, to the apparatus 2206. In some aspects, one or more other components of the apparatus 2200 may generate communications and may provide the generated communications to the transmission component 2204 for transmission to the apparatus 2206. In some aspects, the transmission component 2204 may perform signal processing on the generated communications (such as filtering, amplification, modulation, digital-to-analog conversion, multiplexing, interleaving, mapping, or encoding, among other examples), and may transmit the processed signals to the apparatus 2206. In some aspects, the transmission component 2204 may include one or more antennas, a modem, a modulator, a transmit MIMO processor, a transmit processor, a controller/processor, a memory, or a combination thereof, of the wireless communication device described in connection with FIG. 2. In some aspects, the transmission component 2204 may be co-located with the reception component 2202 in a transceiver.

The selection component 2208 may select a codebook for a MIMO communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device. The transmission component 2204 may transmit or receiving the communication using the codebook.

The number and arrangement of components shown in FIG. 22 are provided as an example. In practice, there may be additional components, fewer components, different components, or differently arranged components than those shown in FIG. 22. Furthermore, two or more components shown in FIG. 22 may be implemented within a single component, or a single component shown in FIG. 22 may be implemented as multiple, distributed components. Additionally, or alternatively, a set of (one or more) components shown in FIG. 22 may perform one or more functions described as being performed by another set of components shown in FIG. 22.

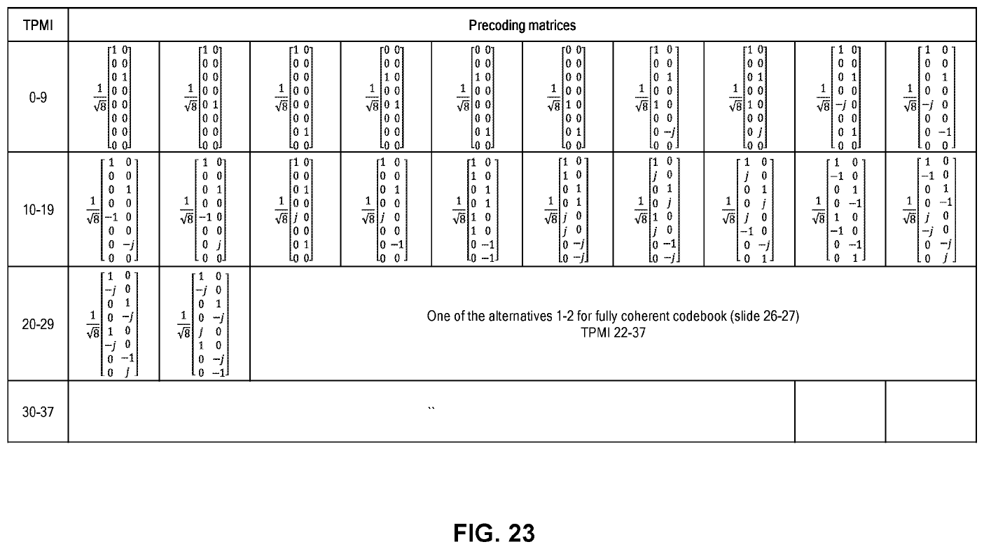

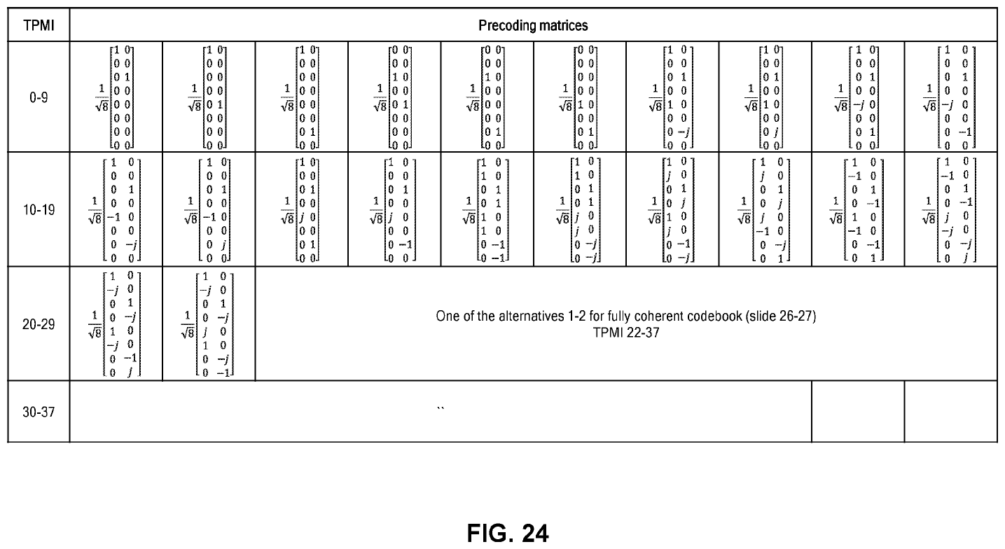

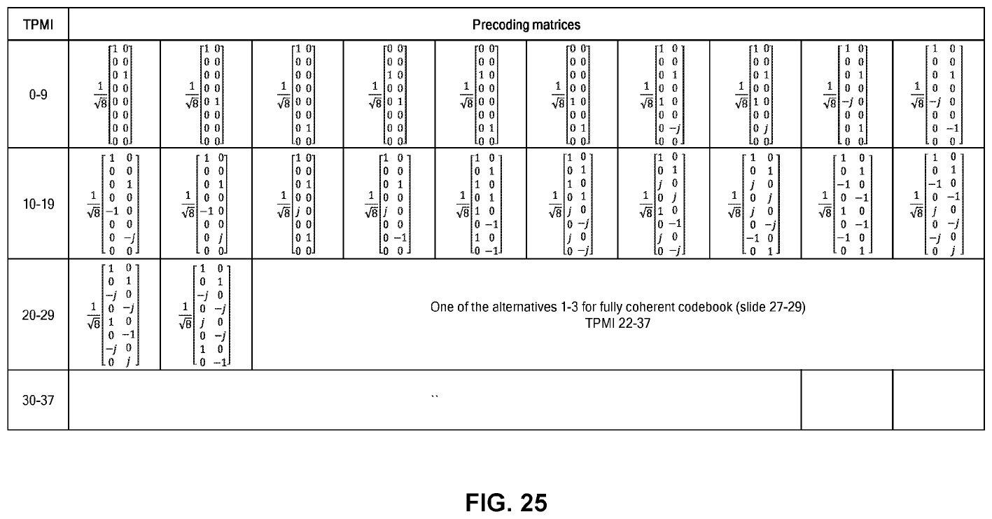

There may be TPMIs assigned to precoding matrices. FIGS. 23-47B provide tables with examples of TPMIs for precoding matrices for 6 or 8 antennas. A wireless communication device may be configured to select a codebook from one or more codebooks as specified in any of the tables in FIGS. 23-47B. FIG. 23 shows an example table of Rank 2 precoding matrices and corresponding TPMIs for 8 antennas. FIG. 24 shows another example table of Rank 2 precoding matrices and corresponding TPMIs for 8 antennas. FIG. 25 shows another example table of Rank 2 precoding matrices and corresponding TPMIs for 8 antennas.

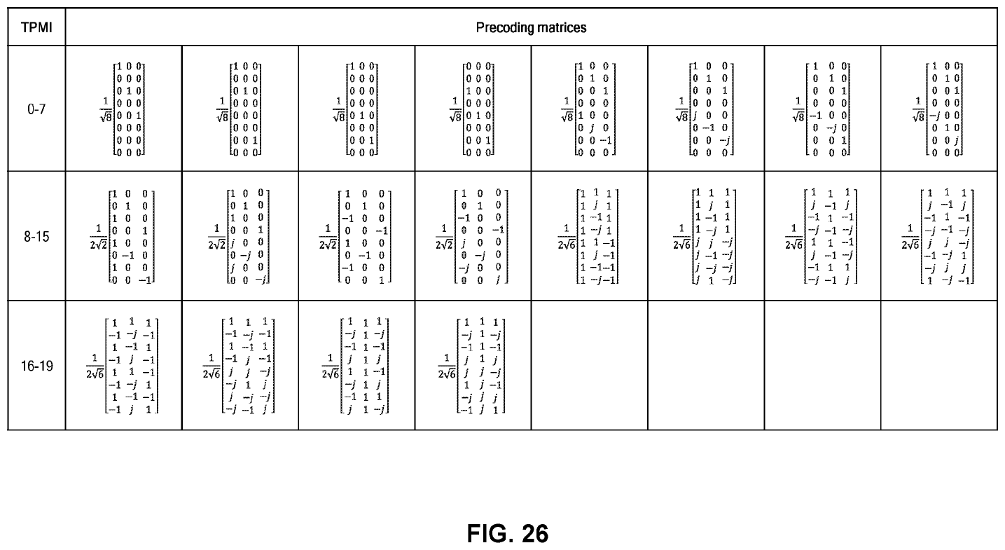

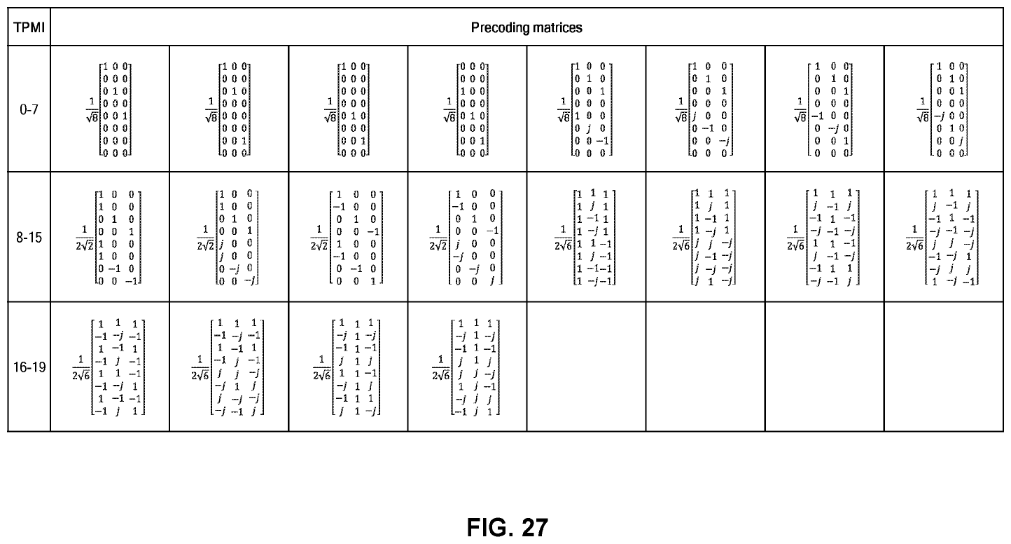

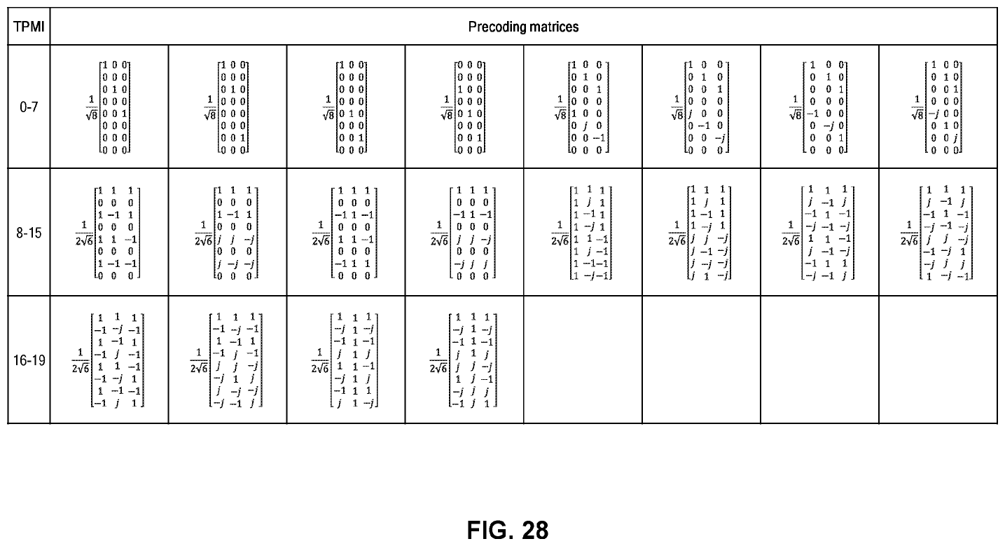

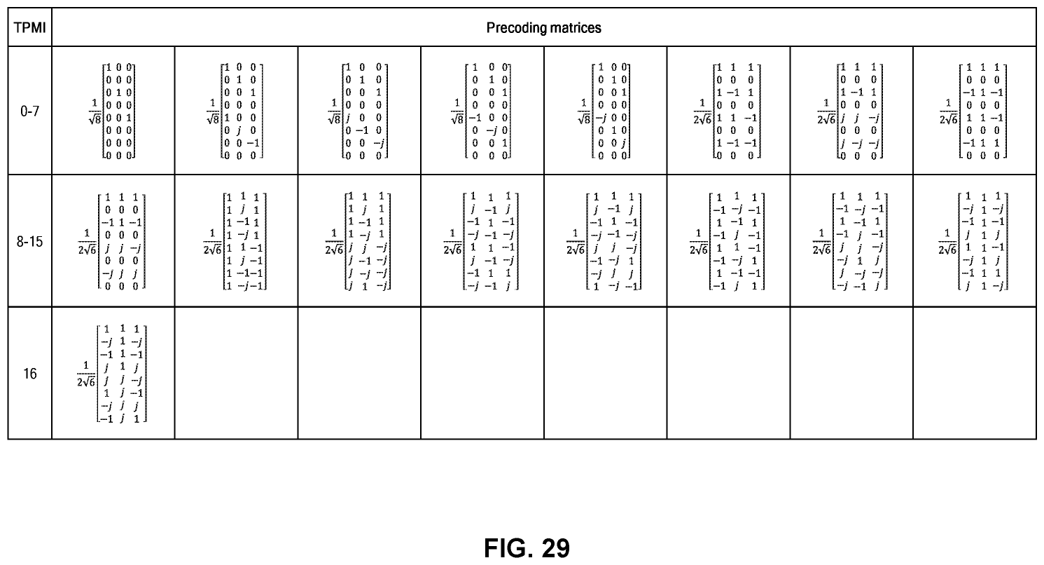

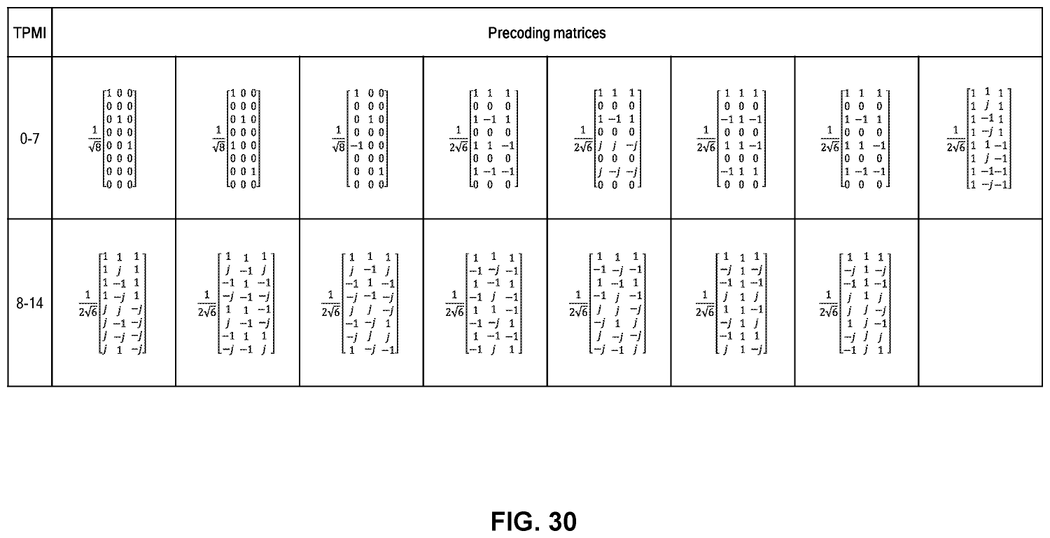

FIG. 26 shows an example table of Rank 3 precoding matrices and corresponding TPMIs for 8 antennas. FIG. 27 shows another example table of Rank 3 precoding matrices and corresponding TPMIs for 8 antennas. FIG. 28 shows another example table of Rank 3 precoding matrices and corresponding TPMIs for 8 antennas. FIG. 29 shows another example table of Rank 3 precoding matrices and corresponding TPMIs for 8 antennas (with reduced overhead). FIG. 30 shows another example table of Rank 3 precoding matrices and corresponding TPMIs for 8 antennas (with further reduced overhead).

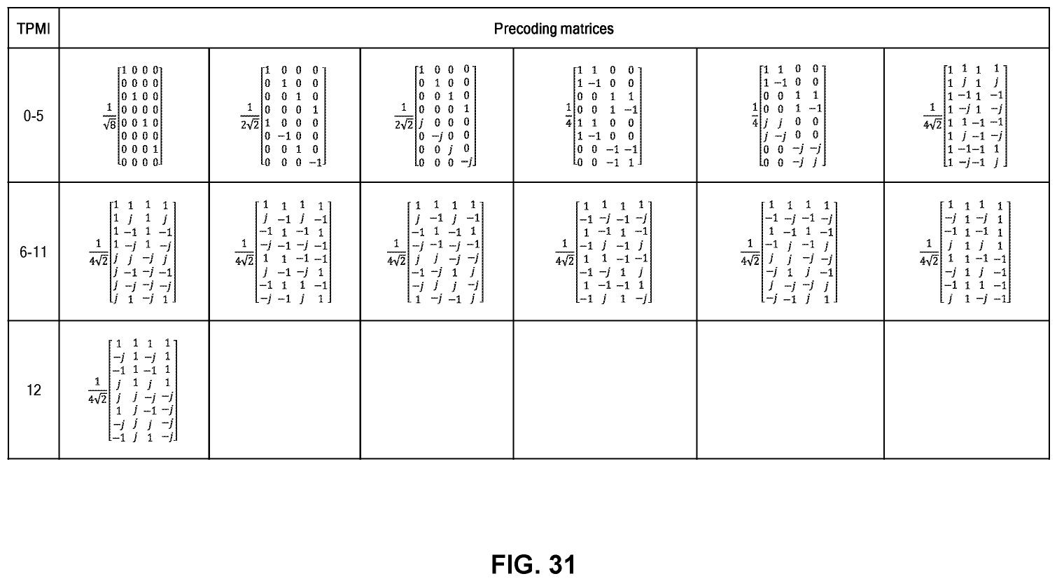

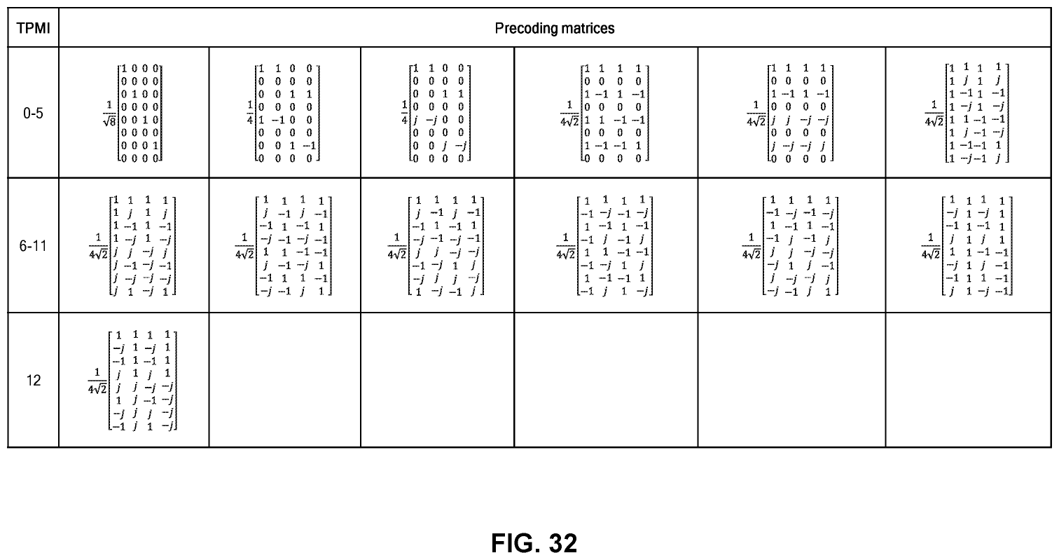

FIG. 31 shows an example table of Rank 4 precoding matrices and corresponding TPMIs for 8 antennas. FIG. 32 shows another example table of Rank 4 precoding matrices and corresponding TPMIs for 8 antennas.

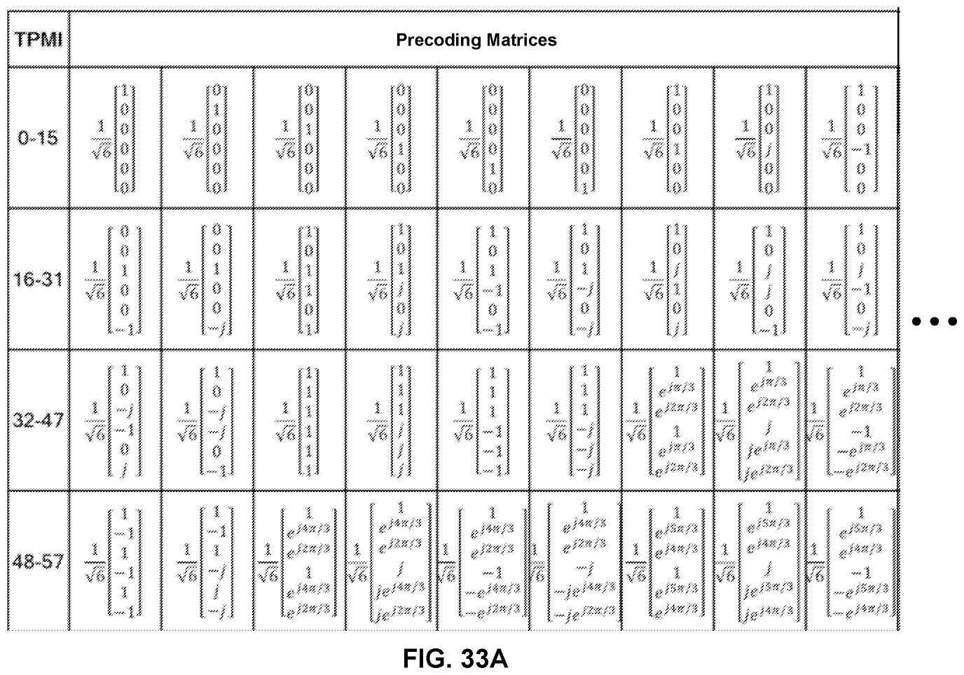

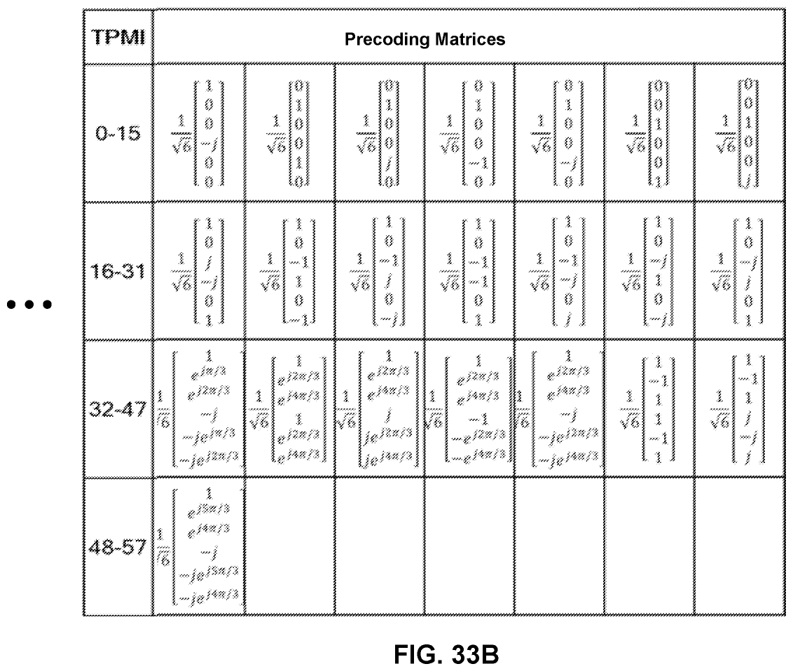

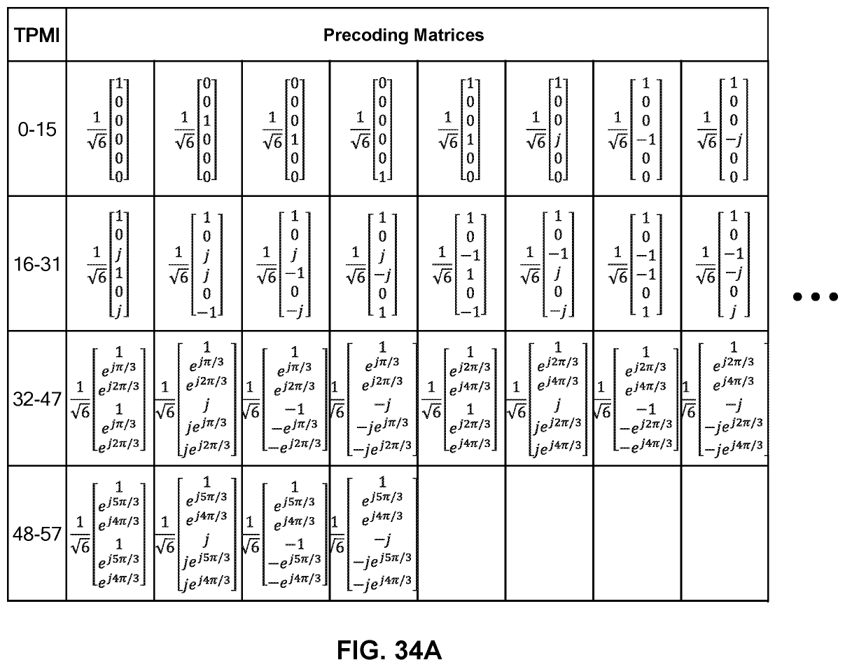

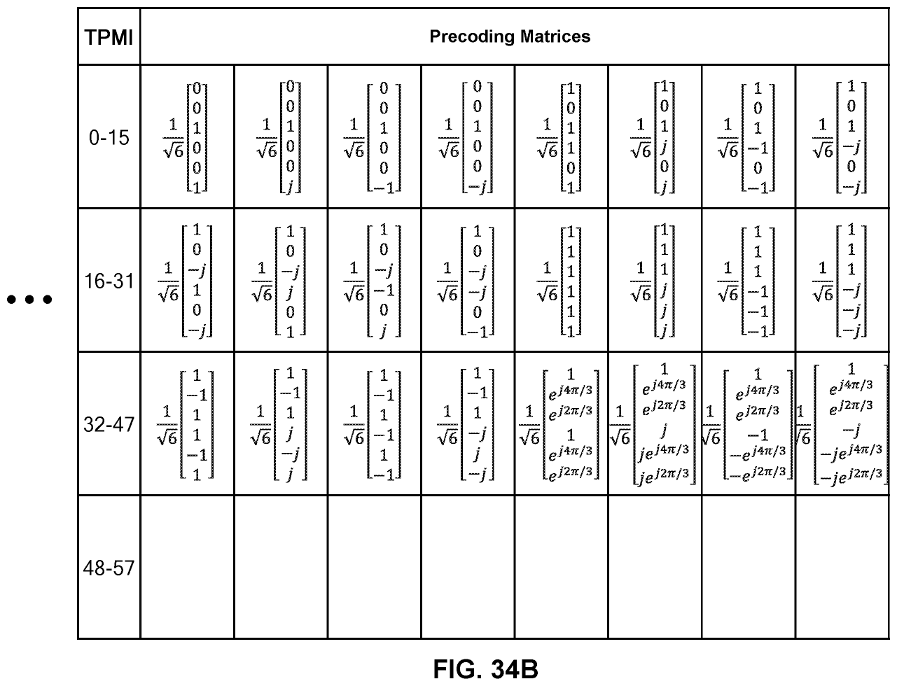

FIGS. 33A-33B show an example table of Rank 1 precoding matrices and corresponding TPMIs for 6 antennas. FIGS. 34A-34B show another example table of Rank 1 precoding matrices and corresponding TPMIs for 6 antennas (with some down-selection).

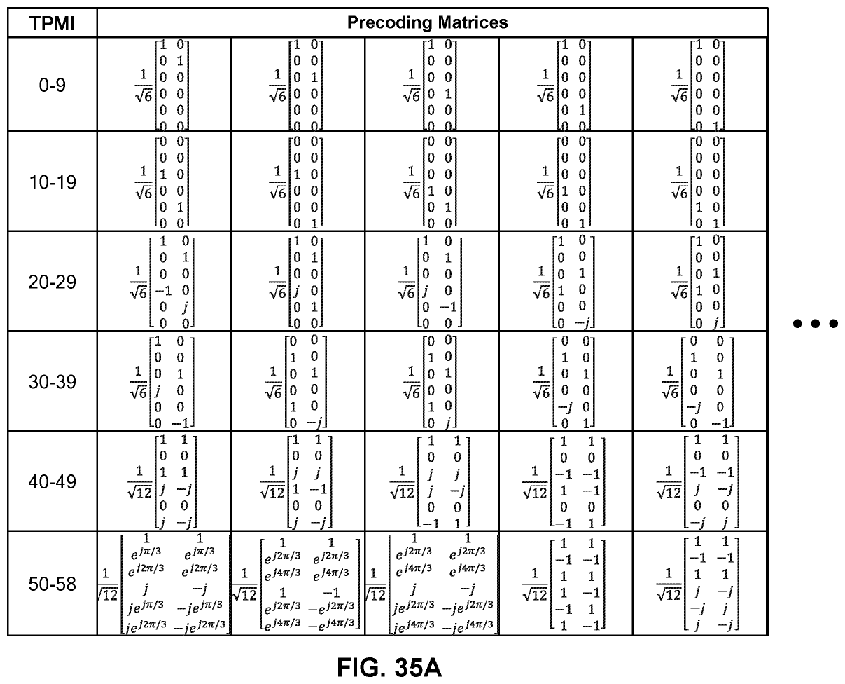

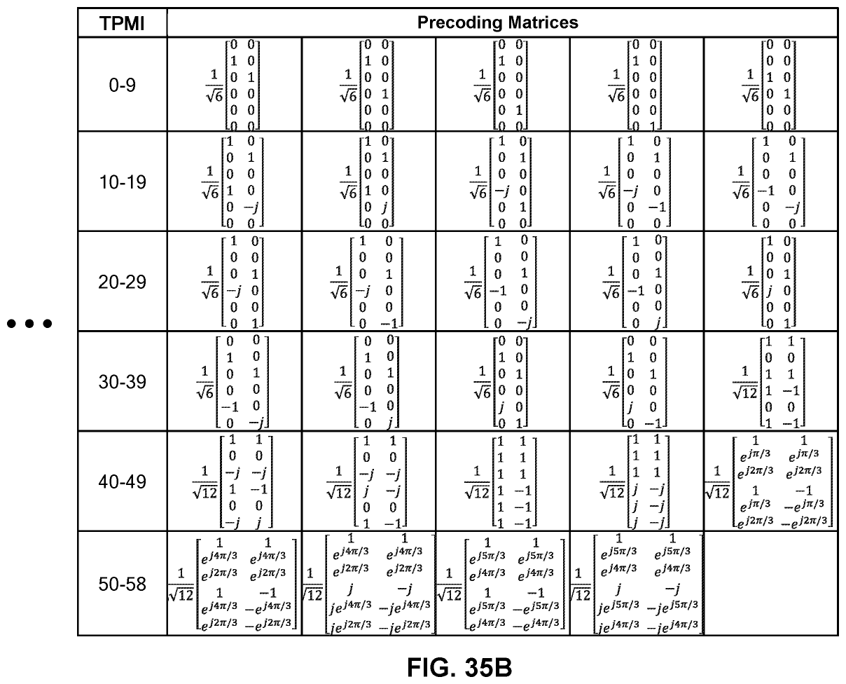

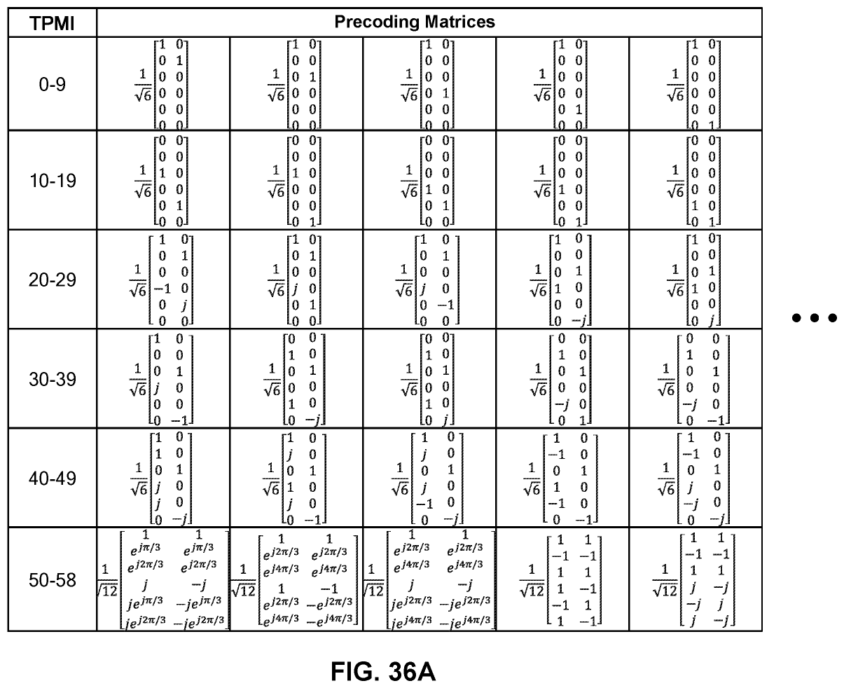

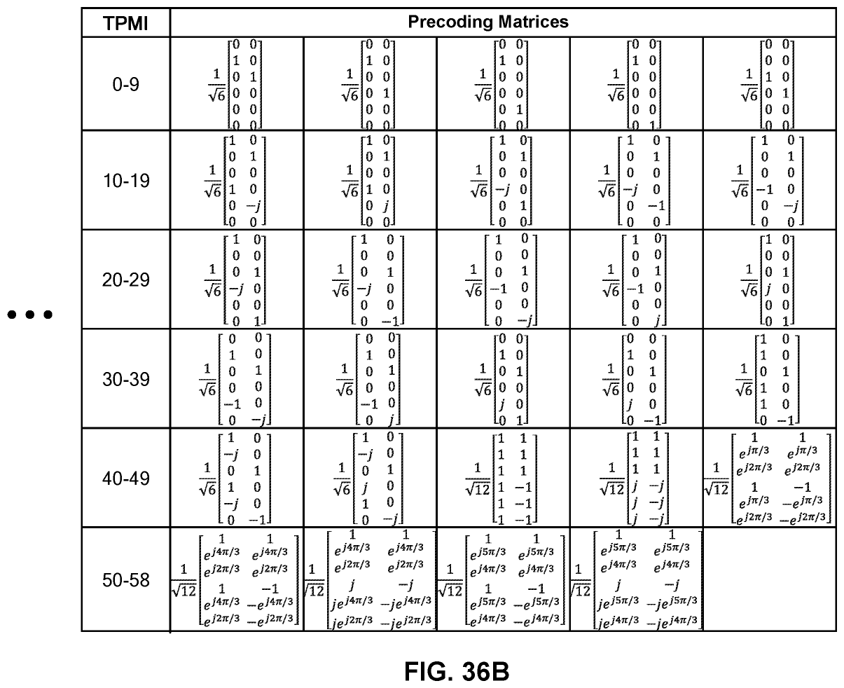

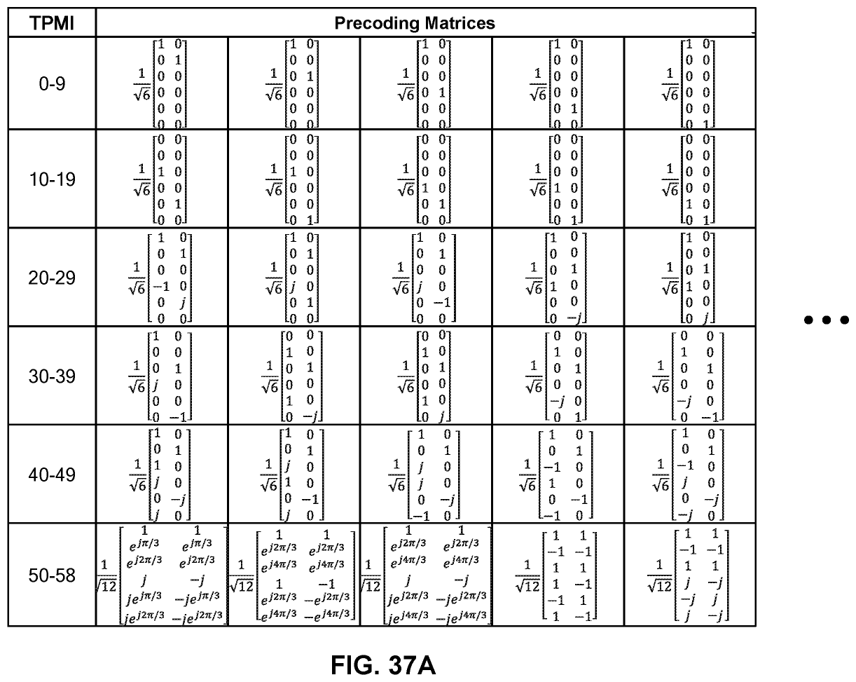

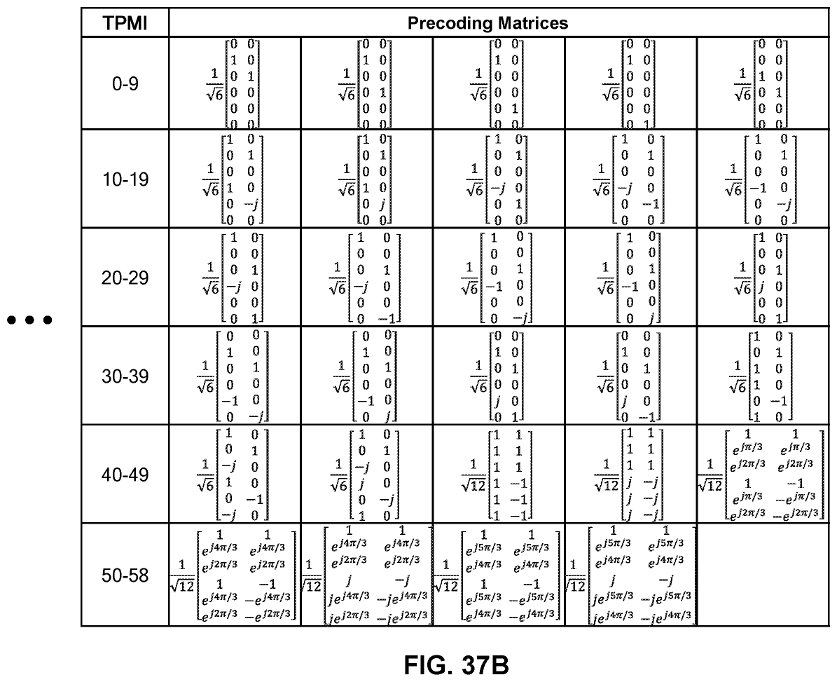

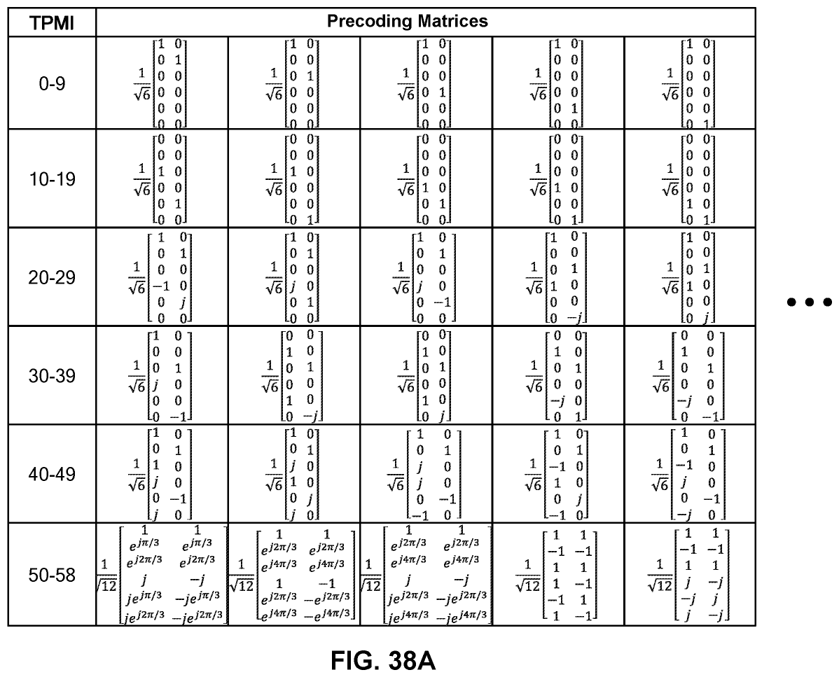

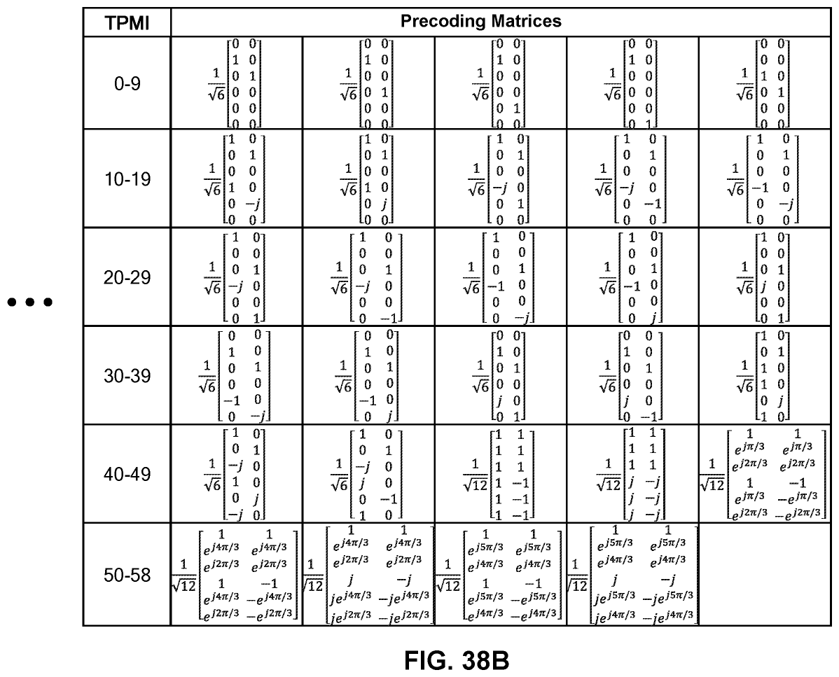

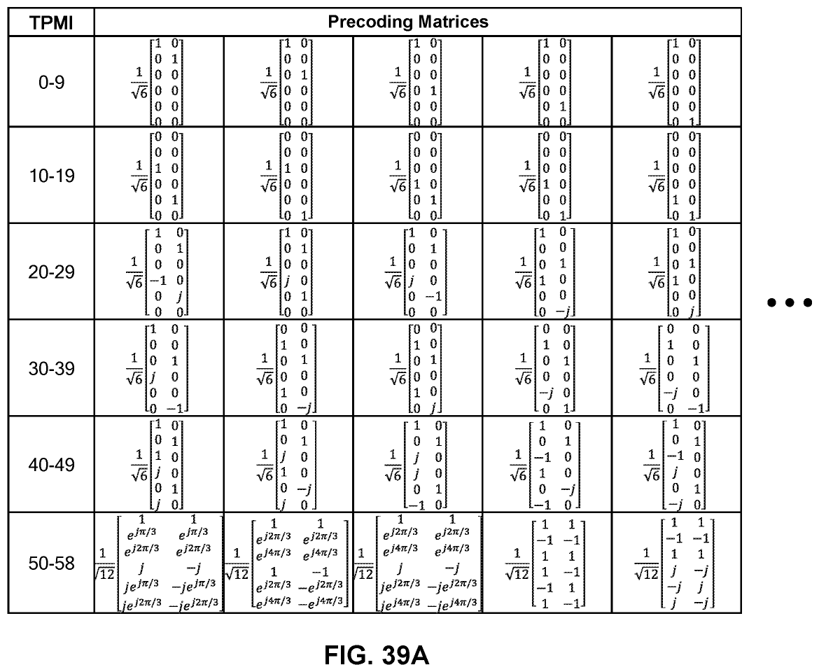

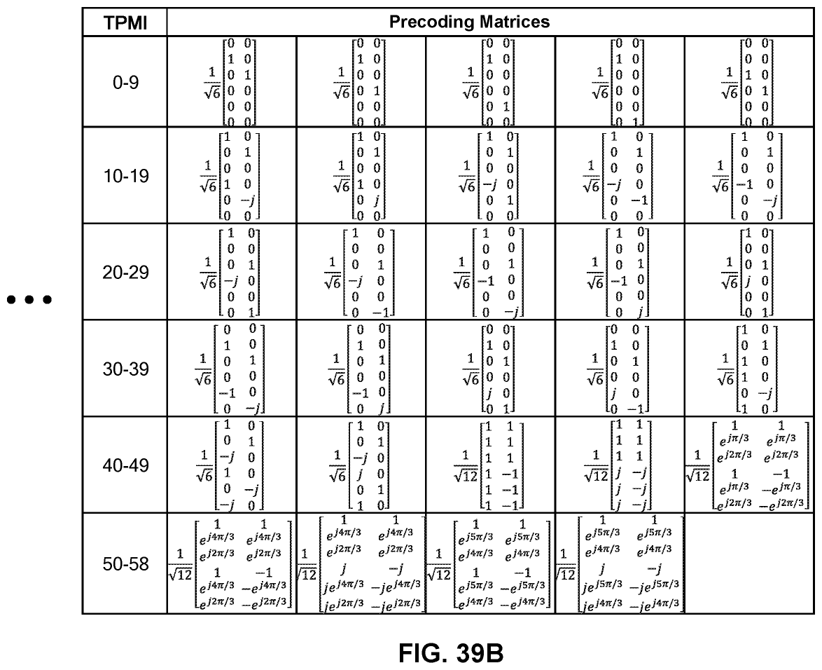

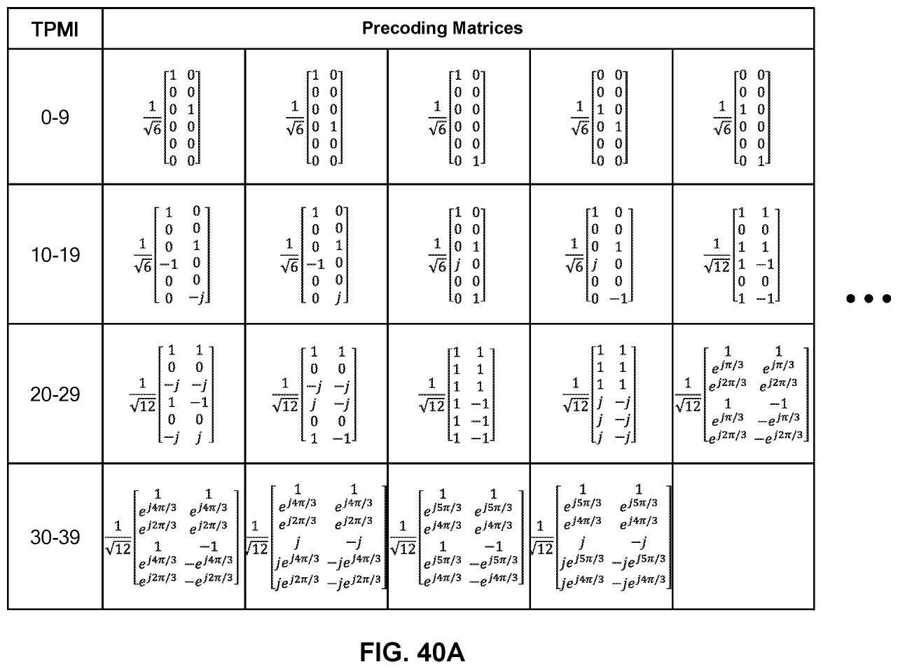

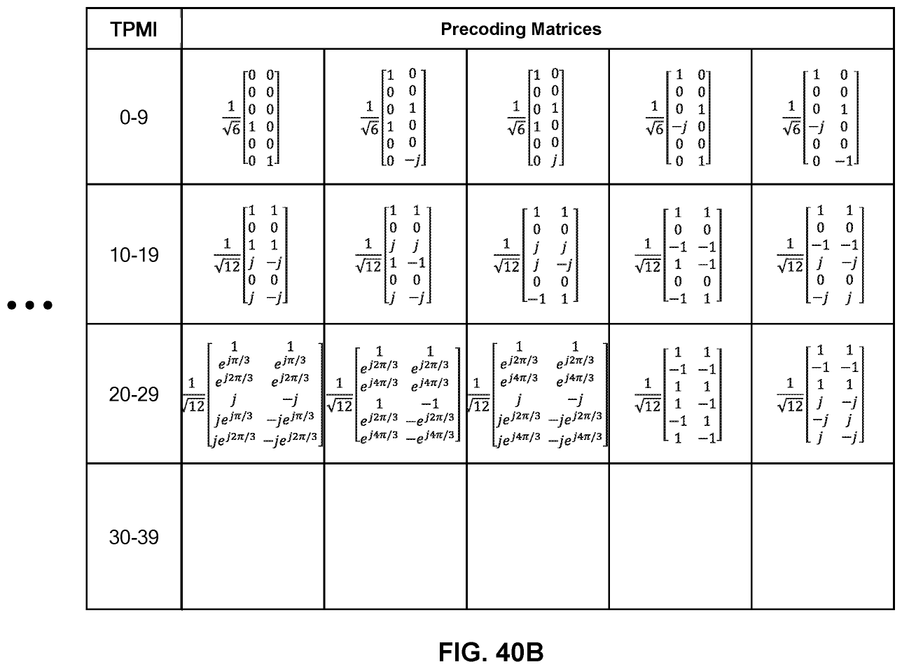

FIGS. 35A-35B show an example table of Rank 2 precoding matrices and corresponding TPMIs for 6 antennas. FIGS. 36A-36B show another example table of Rank 2 precoding matrices and corresponding TPMIs for 6 antennas. FIGS. 37A-37B show another example table of Rank 2 precoding matrices and corresponding TPMIs for 6 antennas. FIGS. 38A-38B show another example table of Rank 2 precoding matrices and corresponding TPMIs for 6 antennas. FIGS. 39A-39B show another example table of Rank 2 precoding matrices and corresponding TPMIs for 6 antennas. FIGS. 40A-40B show another example table of Rank 2 precoding matrices and corresponding TPMIs for 6 antennas.

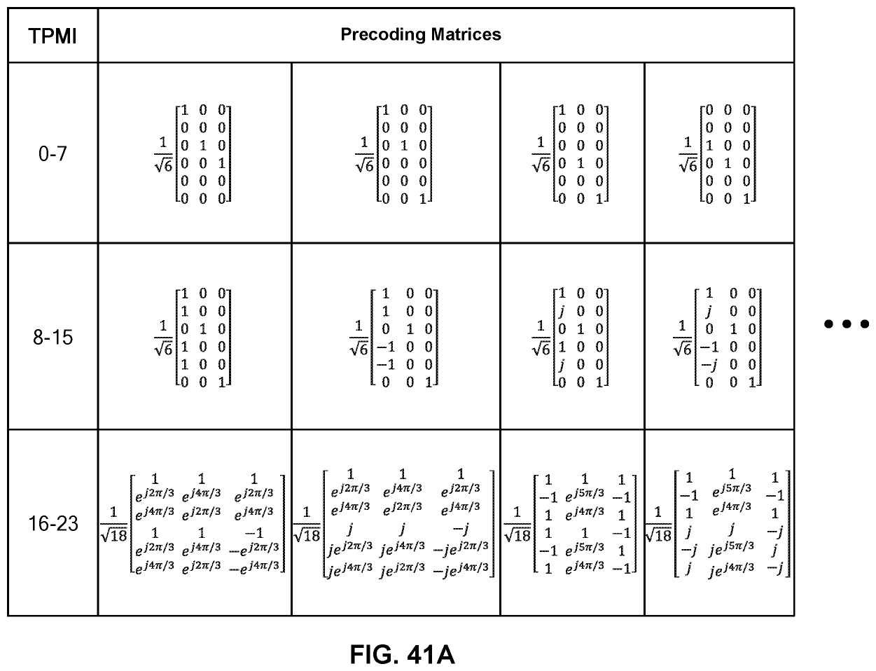

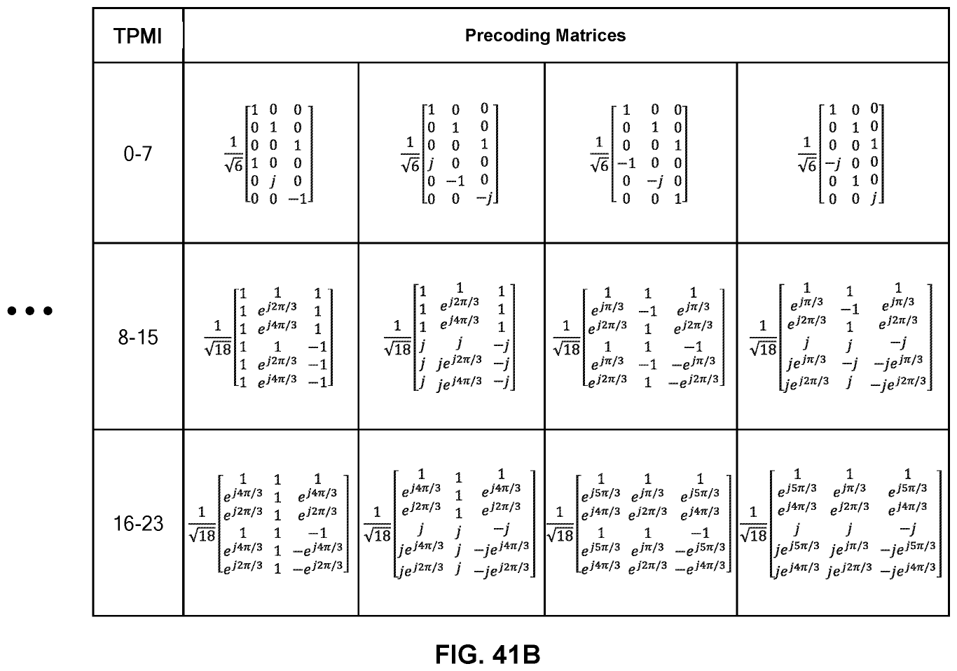

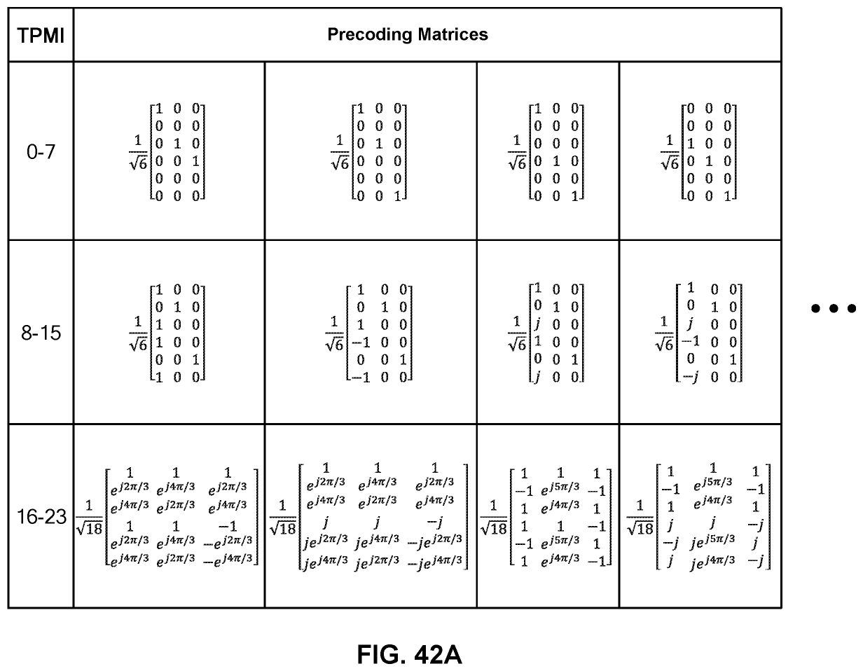

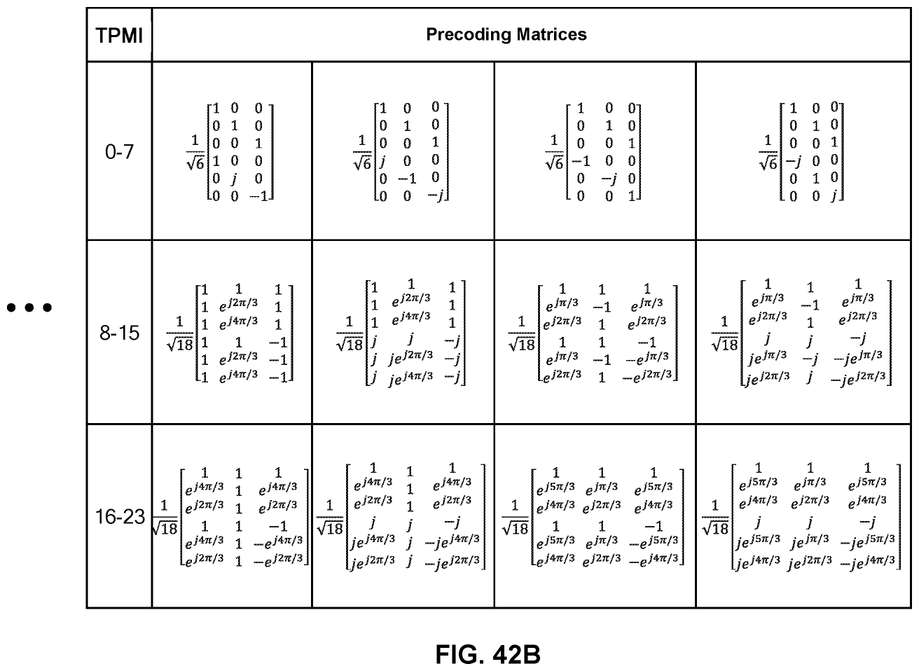

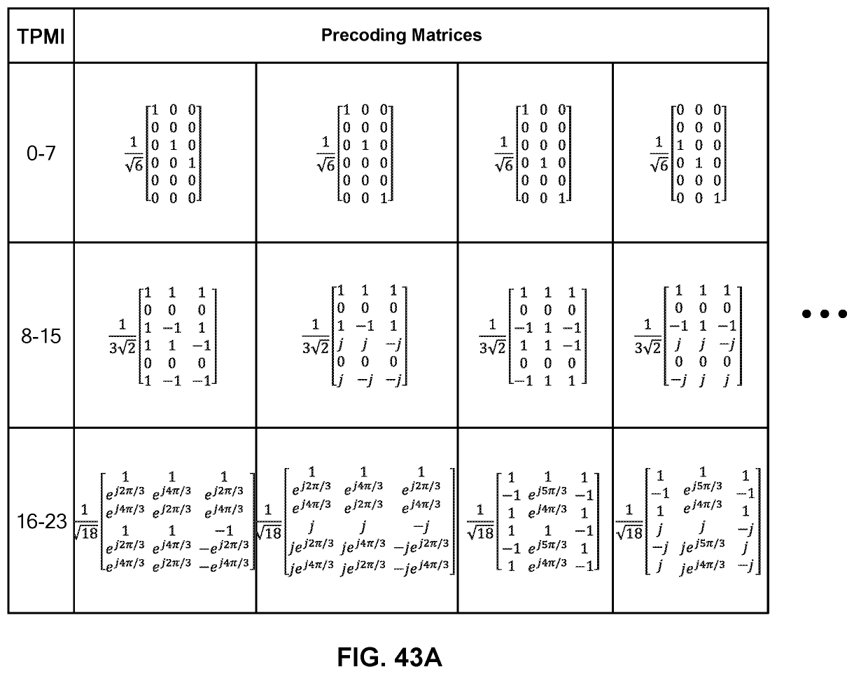

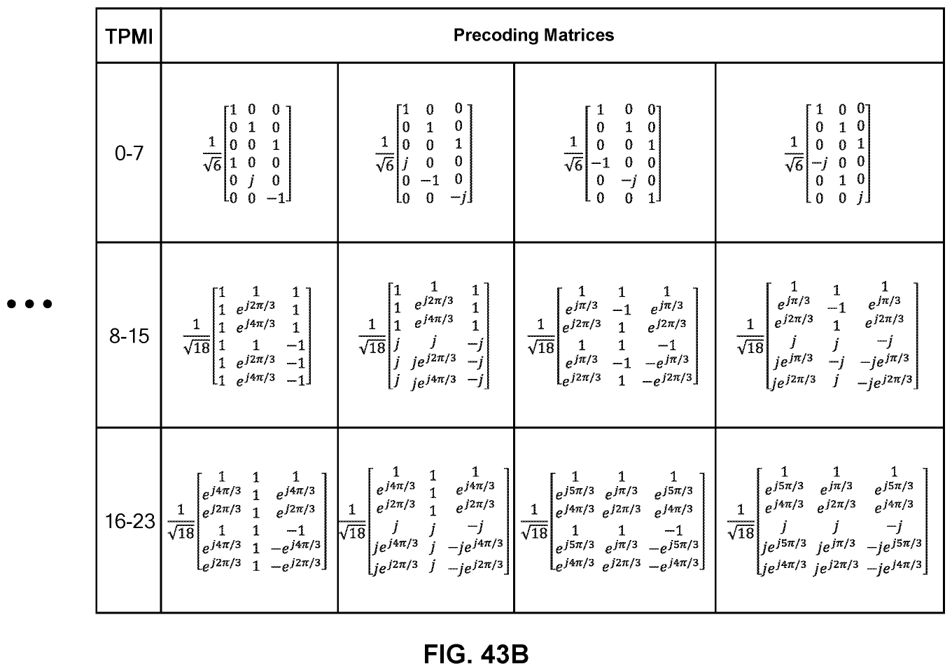

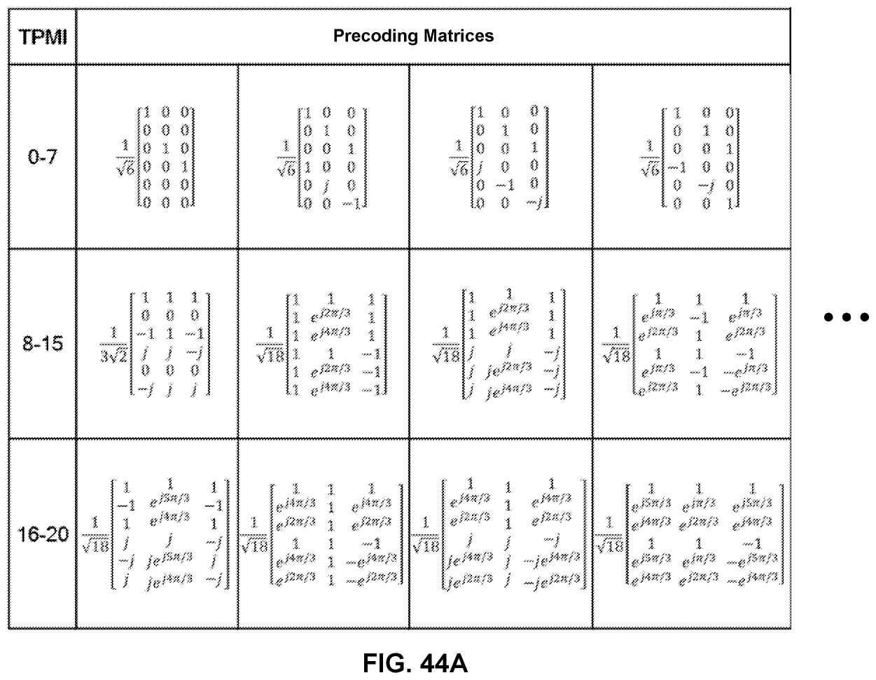

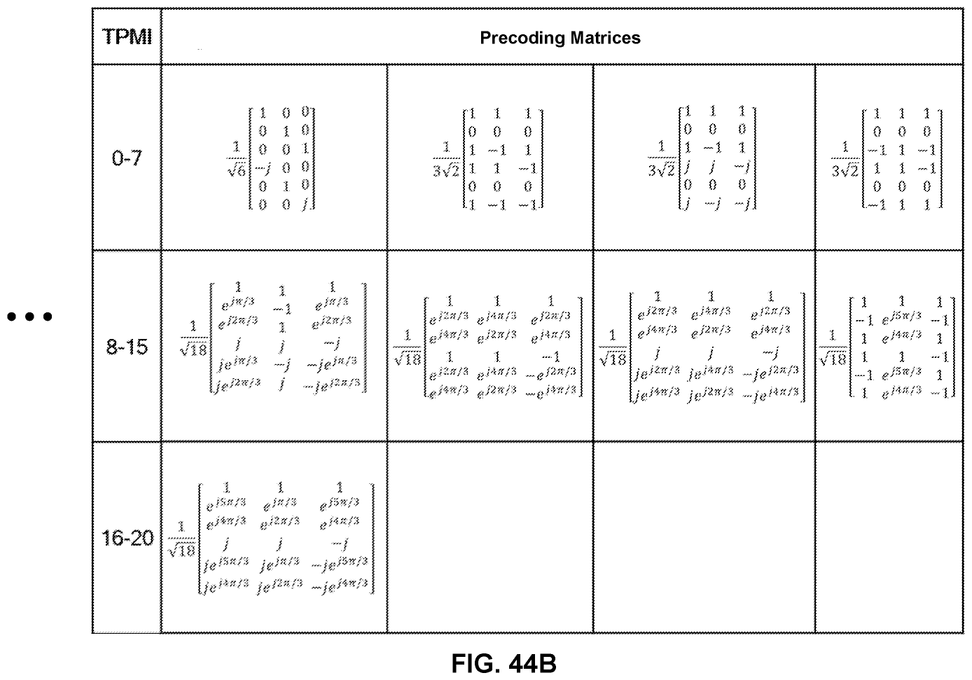

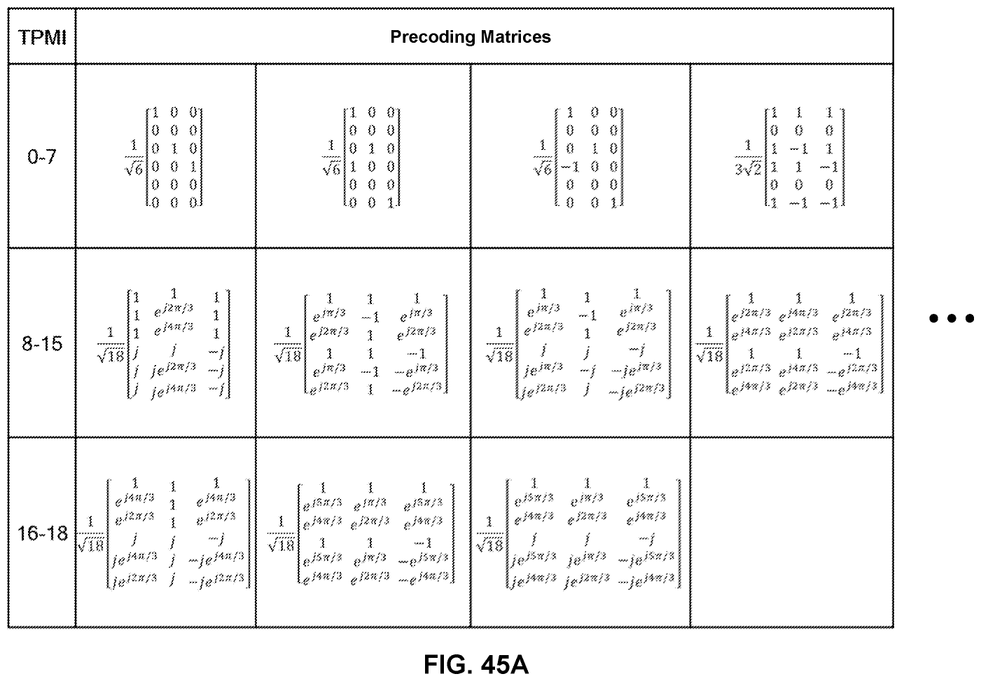

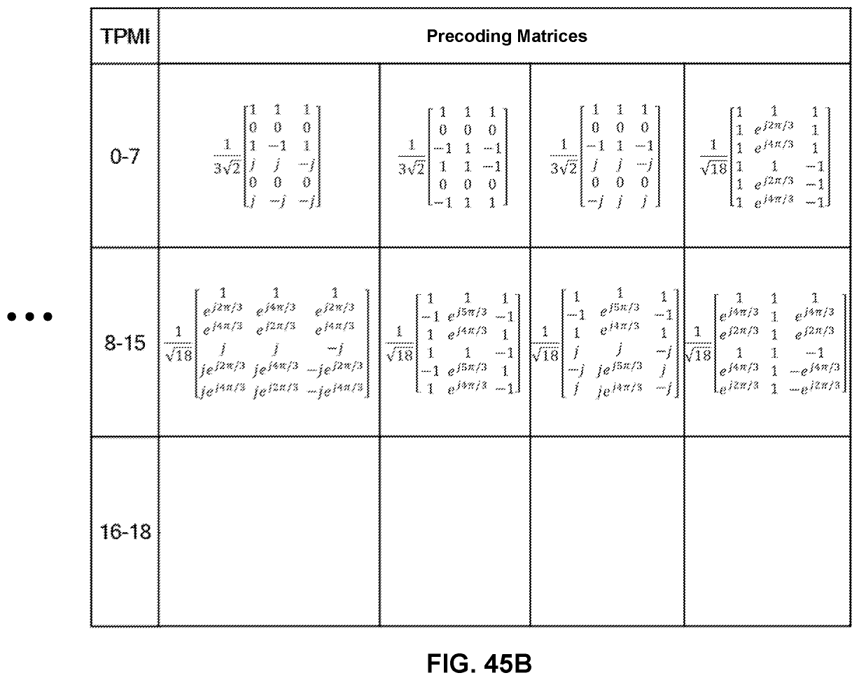

FIGS. 41A-41B show an example table of Rank 3 precoding matrices and corresponding TPMTs for 6 antennas. FIGS. 42A-43B show another example table of Rank 3 precoding matrices and corresponding TPMIs for 6 antennas. FIGS. 43A-43B show another example table of Rank 3 precoding matrices and corresponding TPMIs for 6 antennas. FIGS. 44A-44B show another example table of Rank 3 precoding matrices and corresponding TPMIs for 6 antennas. FIGS. 45A-45B show another example table of Rank 3 precoding matrices and corresponding TPMIs for 6 antennas.

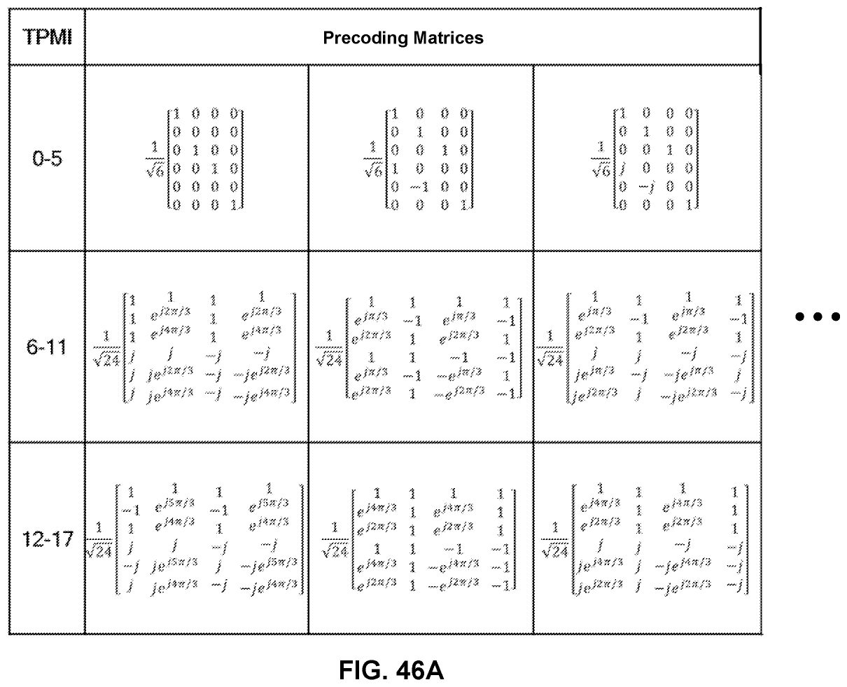

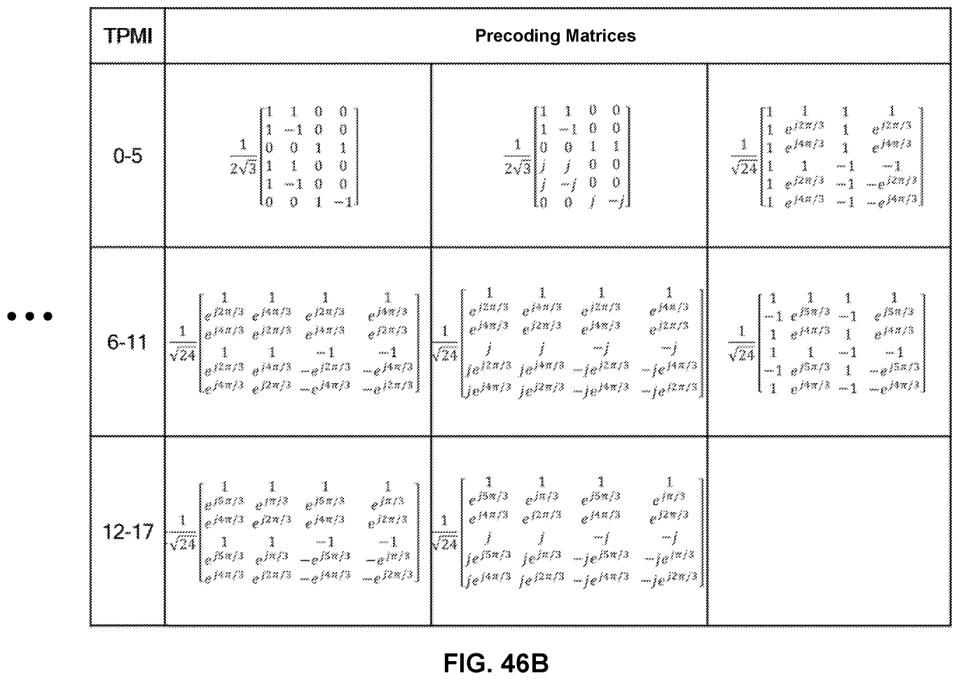

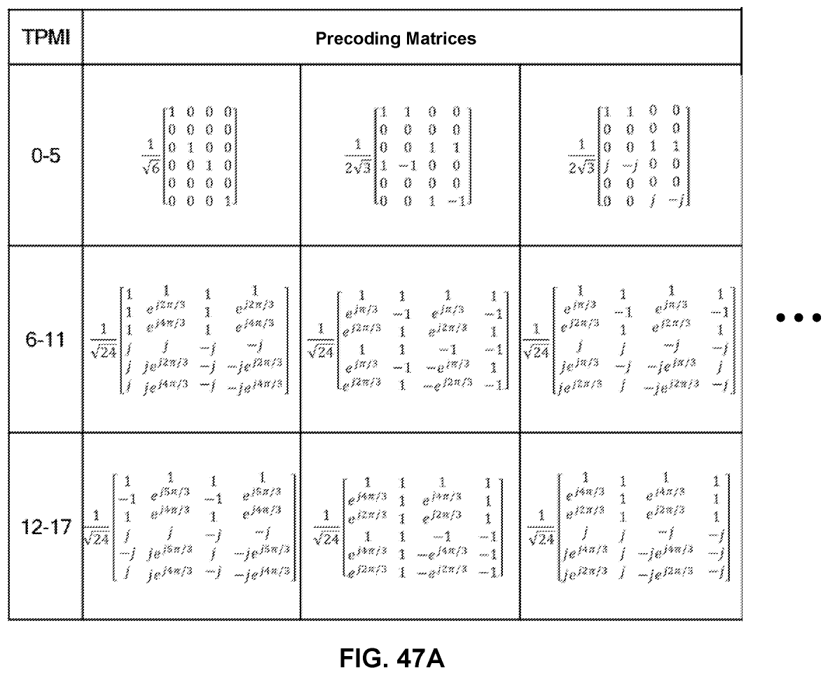

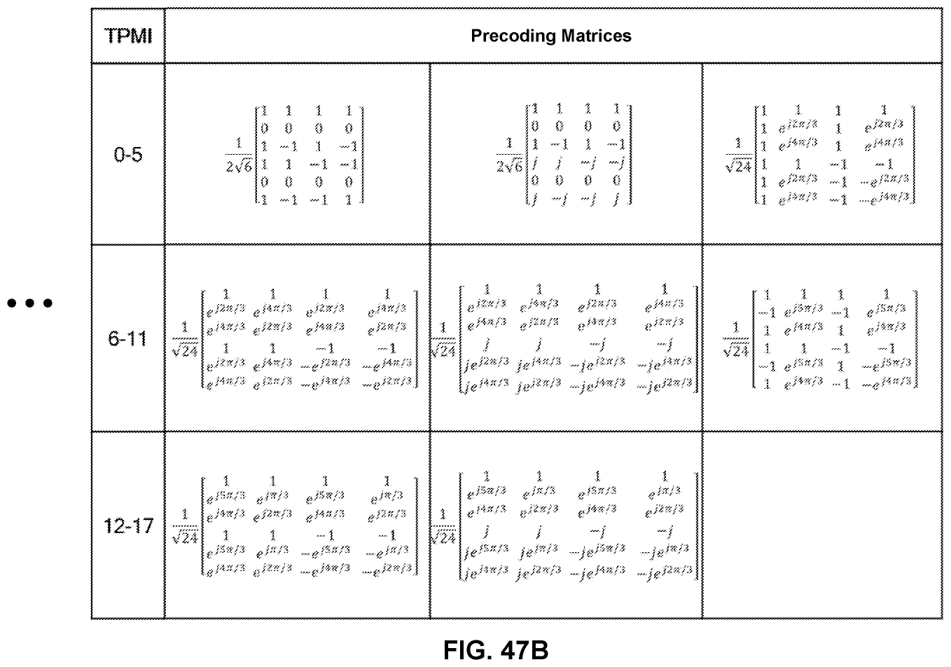

FIGS. 46A-46B show an example table of Rank 4 precoding matrices and corresponding TPMIs for 6 antennas. FIGS. 47A-47B show another example table of Rank 4 precoding matrices and corresponding TPMIs for 6 antennas.

The following provides an overview of some Aspects of the present disclosure:

Aspect 1: A method of wireless communication performed by a wireless communication device, comprising: selecting a codebook for a multiple-input multiple-output (MIMO) communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device; and transmitting or receiving the communication using the codebook.

Aspect 2: The method of Aspect 1, wherein the one or more codebooks are specified as:

$$\frac{1}{2 \sqrt{2}} [ \begin{matrix}1 \\ 0 \\ 0 \\ 0 \\ 0 \\ 0 \\ 0 \\ 0\end{matrix} ] ,$$

$$\frac{1}{2 \sqrt{2}} [ \begin{matrix}0 \\ 0 \\ 1 \\ 0 \\ 0 \\ 0 \\ 0 \\ 0\end{matrix} ] ,$$

$$\frac{1}{2 \sqrt{2}} [ \begin{matrix}0 \\ 0 \\ 0 \\ 0 \\ 1 \\ 0 \\ 0 \\ 0\end{matrix} ] ,$$

$$\frac{1}{2 \sqrt{2}} [ \begin{matrix}0 \\ 0 \\ 0 \\ 0 \\ 0 \\ 0 \\ 1 \\ 0\end{matrix} ] ;$$

$$\frac{1}{2 \sqrt{2}} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ] ,$$

$$\frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] ,$$

$$\frac{1}{2 \sqrt{2}} [ \begin{matrix}1 & 0 \\ 0 & 0 \\ 0 & 0 \\ 0 & 0 \\ 0 & 0 \\ 0 & 0 \\ 0 & 1 \\ 0 & 0\end{matrix} ] ,$$

$$\frac{1}{2 \sqrt{2}} [ \begin{matrix}0 & 0 \\ 0 & 0 \\ 1 & 0 \\ 0 & 0 \\ 0 & 1 \\ 0 & 0 \\ 0 & 0 \\ 0 & 0\end{matrix} ] ,$$

$$\frac{1}{2 \sqrt{2}} [ \begin{matrix}0 & 0 \\ 0 & 0 \\ 1 & 0 \\ 0 & 0 \\ 0 & 0 \\ 0 & 0 \\ 0 & 1 \\ 0 & 0\end{matrix} ] ,$$

$$\frac{1}{2 \sqrt{2}} [ \begin{matrix}0 & 0 \\ 0 & 0 \\ 0 & 0 \\ 0 & 0 \\ 1 & 0 \\ 0 & 0 \\ 0 & 1 \\ 0 & 0\end{matrix} ] ;$$

$$\frac{1}{2 \sqrt{2}} [ \begin{matrix}1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0 \\ 0 & 0 & 0\end{matrix} ] ,$$

$$\frac{1}{2 \sqrt{2}} [ \begin{matrix}1 & 0 & 0 \\ 0 & 0 & 0 \\ 0 & 1 & 0 \\ 0 & 0 & 0 \\ 0 & 0 & 0 \\ 0 & 0 & 0 \\ 0 & 0 & 1 \\ 0 & 0 & 0\end{matrix} ] ,$$

$$\frac{1}{2 \sqrt{2}} [ \begin{matrix}1 & 0 & 0 \\ 0 & 0 & 0 \\ 0 & 0 & 0 \\ 0 & 0 & 0 \\ 0 & 1 & 0 \\ 0 & 0 & 0 \\ 0 & 0 & 1 \\ 0 & 0 & 0\end{matrix} ] ,$$

$$\frac{1}{2 \sqrt{2}} [ \begin{matrix}0 & 0 & 0 \\ 0 & 0 & 0 \\ 1 & 0 & 0 \\ 0 & 0 & 0 \\ 0 & 1 & 0 \\ 0 & 0 & 0 \\ 0 & 0 & 1 \\ 0 & 0 & 0\end{matrix} ] ;$$

$$or$$

$$\frac{1}{2 \sqrt{2}} [ \begin{matrix}1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1 \\ 0 & 0 & 0 & 0\end{matrix} ] .$$

Aspect 3: The method of Aspect 1, wherein the one or more codebooks are from among codebooks specified as:

$$\frac{1}{2 \sqrt{2}} [ \begin{matrix}1 \\ 0 \\ 0 \\ 0 \\ 1 \\ 0 \\ 0 \\ 0\end{matrix} ] ,$$

$$\frac{1}{2 \sqrt{2}} [ \begin{matrix}1 \\ 0 \\ 0 \\ 0 \\ - 1 \\ 0 \\ 0 \\ 0\end{matrix} ] ,$$

$$\frac{1}{2 \sqrt{2}} [ \begin{matrix}1 \\ 0 \\ 0 \\ 0 \\ j \\ 0 \\ 0 \\ 0\end{matrix} ] ,$$

$$\frac{1}{2 \sqrt{2}} [ \begin{matrix}1 \\ 0 \\ 0 \\ 0 \\ - j \\ 0 \\ 0 \\ 0\end{matrix} ] ,$$

$$\frac{1}{2 \sqrt{2}} [ \begin{matrix}0 \\ 1 \\ 0 \\ 0 \\ 0 \\ 1 \\ 0 \\ 0\end{matrix} ] ,$$

$$\frac{1}{2 \sqrt{2}} [ \begin{matrix}0 \\ 1 \\ 0 \\ 0 \\ 0 \\ - 1 \\ 0 \\ 0\end{matrix} ] ,$$

$$\frac{1}{2 \sqrt{2}} [ \begin{matrix}0 \\ 1 \\ 0 \\ 0 \\ 0 \\ j \\ 0 \\ 0\end{matrix} ] ,$$

$$\frac{1}{2 \sqrt{2}} [ \begin{matrix}0 \\ 1 \\ 0 \\ 0 \\ 0 \\ - j \\ 0 \\ 0\end{matrix} ] ,$$

$$\frac{1}{2 \sqrt{2}} [ \begin{matrix}0 \\ 0 \\ 1 \\ 0 \\ 0 \\ 0 \\ 1 \\ 0\end{matrix} ] ,$$

$$\frac{1}{2 \sqrt{2}} [ \begin{matrix}0 \\ 0 \\ 1 \\ 0 \\ 0 \\ 0 \\ - 1 \\ 0\end{matrix} ] ,$$

$$\frac{1}{2 \sqrt{2}} [ \begin{matrix}0 \\ 0 \\ 1 \\ 0 \\ 0 \\ 0 \\ j \\ 0\end{matrix} ] ,$$

$$\frac{1}{2 \sqrt{2}} [ \begin{matrix}0 \\ 0 \\ 1 \\ 0 \\ 0 \\ 0 \\ - j \\ 0\end{matrix} ] ,$$

$$\frac{1}{2 \sqrt{2}} [ \begin{matrix}0 \\ 0 \\ 0 \\ 1 \\ 0 \\ 0 \\ 0 \\ 1\end{matrix} ] ,$$

$$\frac{1}{2 \sqrt{2}} [ \begin{matrix}0 \\ 0 \\ 0 \\ 1 \\ 0 \\ 0 \\ 0 \\ - 1\end{matrix} ] ,$$

$$\frac{1}{2 \sqrt{2}} [ \begin{matrix}0 \\ 0 \\ 0 \\ 1 \\ 0 \\ 0 \\ 0 \\ j\end{matrix} ] ,$$

$$and$$

$$\frac{1}{2 \sqrt{2}} [ \begin{matrix}0 \\ 0 \\ 0 \\ 1 \\ 0 \\ 0 \\ 0 \\ - j\end{matrix} ] ,$$

$$where j is \sqrt{- 1} .$$

Aspect 4: The method of Aspect 1, wherein the one or more codebooks are specified as:

$$\frac{1}{2 \sqrt{2}} [ \begin{matrix}1 & 0 \\ 0 & 0 \\ 0 & 1 \\ 0 & 0 \\ 1 & 0 \\ 0 & 0 \\ 0 & - j \\ 0 & 0\end{matrix} ] ,$$

$$\frac{1}{2 \sqrt{2}} [ \begin{matrix}1 & 0 \\ 0 & 0 \\ 0 & 1 \\ 0 & 0 \\ 1 & 0 \\ 0 & 0 \\ 0 & j \\ 0 & 0\end{matrix} ] ,$$

$$\frac{1}{2 \sqrt{2}} [ \begin{matrix}1 & 0 \\ 0 & 0 \\ 0 & 1 \\ 0 & 0 \\ - j & 0 \\ 0 & 0 \\ 0 & 1 \\ 0 & 0\end{matrix} ] ,$$

$$\frac{1}{2 \sqrt{2}} [ \begin{matrix}1 & 0 \\ 0 & 0 \\ 0 & 1 \\ 0 & 0 \\ - j & 0 \\ 0 & 0 \\ 0 & - 1 \\ 0 & 0\end{matrix} ] ,$$

$$\frac{1}{2 \sqrt{2}} [ \begin{matrix}1 & 0 \\ 0 & 0 \\ 0 & 1 \\ 0 & 0 \\ - 1 & 0 \\ 0 & 0 \\ 0 & - j \\ 0 & 0\end{matrix} ] ,$$

$$\frac{1}{2 \sqrt{2}} [ \begin{matrix}1 & 0 \\ 0 & 0 \\ 0 & 1 \\ 0 & 0 \\ - 1 & 0 \\ 0 & 0 \\ 0 & j \\ 0 & 0\end{matrix} ] ,$$

$$\frac{1}{2 \sqrt{2}} [ \begin{matrix}1 & 0 \\ 0 & 0 \\ 0 & 1 \\ 0 & 0 \\ j & 0 \\ 0 & 0 \\ 0 & 1 \\ 0 & 0\end{matrix} ] ,$$

$$and$$

$$\frac{1}{2 \sqrt{2}} [ \begin{matrix}1 & 0 \\ 0 & 0 \\ 0 & 1 \\ 0 & 0 \\ j & 0 \\ 0 & 0 \\ 0 & - 1 \\ 0 & 0\end{matrix} ] ,$$

$$where j is \sqrt{- 1} .$$

Aspect 5: The method of Aspect 1, wherein the one or more codebooks are specified as:

$$\frac{1}{2 \sqrt{2}} [ \begin{matrix}1 \\ 0 \\ 1 \\ 0 \\ 1 \\ 0 \\ 1 \\ 0\end{matrix} ] ,$$

$$\frac{1}{2 \sqrt{2}} [ \begin{matrix}1 \\ 0 \\ 1 \\ 0 \\ j \\ 0 \\ j \\ 0\end{matrix} ] ,$$

$$\frac{1}{2 \sqrt{2}} [ \begin{matrix}1 \\ 0 \\ 1 \\ 0 \\ - 1 \\ 0 \\ - 1 \\ 0\end{matrix} ] ,$$

$$\frac{1}{2 \sqrt{2}} [ \begin{matrix}1 \\ 0 \\ 1 \\ 0 \\ - j \\ 0 \\ - j \\ 0\end{matrix} ] ,$$

$$\frac{1}{2 \sqrt{2}} [ \begin{matrix}1 \\ 0 \\ j \\ 0 \\ 1 \\ 0 \\ j \\ 0\end{matrix} ] ,$$

$$\frac{1}{2 \sqrt{2}} [ \begin{matrix}1 \\ 0 \\ j \\ 0 \\ j \\ 0 \\ - 1 \\ 0\end{matrix} ] ,$$

$$\frac{1}{2 \sqrt{2}} [ \begin{matrix}1 \\ 0 \\ j \\ 0 \\ - 1 \\ 0 \\ - j \\ 0\end{matrix} ] ,$$

$$\frac{1}{2 \sqrt{2}} [ \begin{matrix}1 \\ 0 \\ j \\ 0 \\ - j \\ 0 \\ 1 \\ 0\end{matrix} ] ,$$

$$\frac{1}{2 \sqrt{2}} [ \begin{matrix}1 \\ 0 \\ - 1 \\ 0 \\ 1 \\ 0 \\ - 1 \\ 0\end{matrix} ] ,$$

$$\frac{1}{2 \sqrt{2}} [ \begin{matrix}1 \\ 0 \\ - 1 \\ 0 \\ j \\ 0 \\ - j \\ 0\end{matrix} ] ,$$

$$\frac{1}{2 \sqrt{2}} [ \begin{matrix}1 \\ 0 \\ - 1 \\ 0 \\ - 1 \\ 0 \\ 1 \\ 0\end{matrix} ] ,$$

$$\frac{1}{2 \sqrt{2}} [ \begin{matrix}1 \\ 0 \\ - 1 \\ 0 \\ - j \\ 0 \\ j \\ 0\end{matrix} ] ,$$

$$\frac{1}{2 \sqrt{2}} [ \begin{matrix}1 \\ 0 \\ - j \\ 0 \\ 1 \\ 0 \\ - j \\ 0\end{matrix} ] ,$$

$$\frac{1}{2 \sqrt{2}} [ \begin{matrix}1 \\ 0 \\ - j \\ 0 \\ j \\ 0 \\ 1 \\ 0\end{matrix} ] ,$$

$$\frac{1}{2 \sqrt{2}} [ \begin{matrix}1 \\ 0 \\ - j \\ 0 \\ - 1 \\ 0 \\ j \\ 0\end{matrix} ] ,$$

$$and$$

$$\frac{1}{2 \sqrt{2}} [ \begin{matrix}1 \\ 0 \\ - j \\ 0 \\ - j \\ 0 \\ - 1 \\ 0\end{matrix} ] ,$$

$$where j is \sqrt{- 1} .$$

Aspect 6: The method of Aspect 1, wherein the one or more codebooks are specified as:

$$\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & - 1 \\ 0 & - 1\end{matrix} ] ,$$

$$\frac{1}{2 \sqrt{2}} [ \begin{matrix}1 & 0 \\ 1 & 0 \\ 0 & 1 \\ 0 & 1 \\ j & 0 \\ j & 0 \\ 0 & - j \\ 0 & - j\end{matrix} ] ,$$

$$\frac{1}{2 \sqrt{2}} [ \begin{matrix}1 & 0 \\ j & 0 \\ 0 & 1 \\ 0 & 1 \\ 1 & 0 \\ j & 0 \\ 0 & - 1 \\ 0 & - j\end{matrix} ] ,$$

$$\frac{1}{2 \sqrt{2}} [ \begin{matrix}1 & 0 \\ j & 0 \\ 0 & 1 \\ 0 & j \\ j & 0 \\ - 1 & 0 \\ 0 & - j \\ 0 & 1\end{matrix} ] ,$$

$$\frac{1}{2 \sqrt{2}} [ \begin{matrix}1 & 0 \\ - 1 & 0 \\ 0 & 1 \\ 0 & - 1 \\ 1 & 0 \\ - 1 & 0 \\ 0 & - 1 \\ 0 & 1\end{matrix} ] ,$$

$$\frac{1}{2 \sqrt{2}} [ \begin{matrix}1 & 0 \\ - 1 & 0 \\ 0 & 1 \\ 0 & - 1 \\ j & 0 \\ - j & 0 \\ 0 & - j \\ 0 & j\end{matrix} ] ,$$

$$\frac{1}{2 \sqrt{2}} [ \begin{matrix}1 & 0 \\ - j & 0 \\ 0 & 1 \\ 0 & - j \\ 1 & 0 \\ - j & 0 \\ 0 & - 1 \\ 0 & j\end{matrix} ] ,$$

$$and$$

$$\frac{1}{2 \sqrt{2}} [ \begin{matrix}1 & 0 \\ - j & 0 \\ 0 & 1 \\ 0 & - j \\ j & 0 \\ 1 & 0 \\ 0 & - j \\ 0 & - 1\end{matrix} ] ,$$

$$where j is \sqrt{- 1} ;$$

$$\frac{1}{2 \sqrt{2}} [ \begin{matrix}1 & 0 \\ 0 & 1 \\ 1 & 0 \\ 0 & 1 \\ 1 & 0 \\ 0 & - 1 \\ 1 & 0 \\ 0 & - 1\end{matrix} ] ,$$

$$\frac{1}{2 \sqrt{2}} [ \begin{matrix}1 & 0 \\ 0 & 1 \\ 1 & 0 \\ 0 & 1 \\ j & 0 \\ 0 & - j \\ j & 0 \\ 0 & - j\end{matrix} ] ,$$

$$\frac{1}{2 \sqrt{2}} [ \begin{matrix}1 & 0 \\ 0 & 1 \\ j & 0 \\ 0 & j \\ 1 & 0 \\ 0 & - 1 \\ j & 0 \\ 0 & - j\end{matrix} ] ,$$

$$\frac{1}{2 \sqrt{2}} [ \begin{matrix}1 & 0 \\ 0 & 1 \\ j & 0 \\ 0 & j \\ j & 0 \\ 0 & - j \\ - 1 & 0 \\ 0 & 1\end{matrix} ] ,$$

$$\frac{1}{2 \sqrt{2}} [ \begin{matrix}1 & 0 \\ 0 & 1 \\ - 1 & 0 \\ 0 & - 1 \\ 1 & 0 \\ 0 & - 1 \\ - 1 & 0 \\ 0 & 1\end{matrix} ] ,$$

$$\frac{1}{2 \sqrt{2}} [ \begin{matrix}1 & 0 \\ 0 & 1 \\ - 1 & 0 \\ 0 & - 1 \\ j & 0 \\ 0 & - j \\ - j & 0 \\ 0 & j\end{matrix} ] ,$$

$$\frac{1}{2 \sqrt{2}} [ \begin{matrix}1 & 0 \\ 0 & 1 \\ - j & 0 \\ 0 & - j \\ 1 & 0 \\ 0 & - 1 \\ - j & 0 \\ 0 & j\end{matrix} ] ,$$

$$and$$

$$\frac{1}{2 \sqrt{2}} [ \begin{matrix}1 & 0 \\ 0 & 1 \\ - j & 0 \\ 0 & - j \\ j & 0 \\ 0 & - j \\ 1 & 0 \\ 0 & - 1\end{matrix} ] ;$$

$$or$$

$$\frac{1}{4} [ \begin{matrix}1 & 1 \\ 0 & 0 \\ 1 & 1 \\ 0 & 0 \\ 1 & - 1 \\ 0 & 0 \\ 1 & - 1 \\ 0 & 0\end{matrix} ] ,$$

$$\frac{1}{4} [ \begin{matrix}1 & 1 \\ 0 & 0 \\ 1 & 1 \\ 0 & 0 \\ j & - j \\ 0 & 0 \\ j & - j \\ 0 & 0\end{matrix} ] ,$$

$$\frac{1}{4} [ \begin{matrix}1 & 1 \\ 0 & 0 \\ j & j \\ 0 & 0 \\ 1 & - 1 \\ 0 & 0 \\ j & - j \\ 0 & 0\end{matrix} ] ,$$

$$\frac{1}{4} [ \begin{matrix}1 & 1 \\ 0 & 0 \\ j & j \\ 0 & 0 \\ j & - j \\ 0 & 0 \\ - 1 & 1 \\ 0 & 0\end{matrix} ] ,$$

$$\frac{1}{4} [ \begin{matrix}1 & 1 \\ 0 & 0 \\ - 1 & - 1 \\ 0 & 0 \\ 1 & - 1 \\ 0 & 0 \\ - 1 & 1 \\ 0 & 0\end{matrix} ] ,$$

$$\frac{1}{4} [ \begin{matrix}1 & 1 \\ 0 & 0 \\ - 1 & - 1 \\ 0 & 0 \\ j & - j \\ 0 & 0 \\ - j & j \\ 0 & 0\end{matrix} ] ,$$

$$\frac{1}{4} [ \begin{matrix}1 & 1 \\ 0 & 0 \\ - j & - j \\ 0 & 0 \\ 1 & - 1 \\ 0 & 0 \\ - j & j \\ 0 & 0\end{matrix} ] ,$$

$$and$$

$$\frac{1}{4} [ \begin{matrix}1 & 1 \\ 0 & 0 \\ - j & - j \\ 0 & 0 \\ j & - j \\ 0 & 0 \\ 1 & - 1 \\ 0 & 0\end{matrix} ] .$$

Aspect 7: The method of Aspect 1, wherein the codebook is specified as:

$$\frac{1}{\sqrt{8}} [ \begin{matrix}[ \begin{matrix}1 \\ {e}^{j π {i}_{1} / 4} \\ {e}^{j 2 π {i}_{1} / 4} \\ {e}^{j 3 π {i}_{1} / 4}\end{matrix} ] \\ {e}^{j π {i}_{2} / 2} [ \begin{matrix}1 \\ {e}^{j π {i}_{1} / 4} \\ {e}^{j 2 π {i}_{1} / 4} \\ {e}^{j 3 π {i}_{1} / 4}\end{matrix} ]\end{matrix} ] , where j is \sqrt{- 1} , where {i}_{1} = 0 , … , 7 , and$$

$$where {i}_{2} = 0 , 1 , 2 , 3 or {i}_{2} = 0 , 2 ; or$$

$$\{ \frac{1}{4} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1 , 1}}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & - {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ]\end{matrix} ] \} , where {i}_{1} = 0 , … , 7 and$$

$$where {i}_{2} = 0 , 1 .$$

Aspect 8: The method of Aspect 1, herein the one or more codebooks are associated with a codebook W specified as

$$W = \frac{1}{\sqrt{8}} [ \begin{matrix}{W}_{4} \\ φ {W}_{4}\end{matrix} ] ,$$

where co-phasing parameter φ∈{1,j,−1,−j} or {1, −1}, and W₄ includes one or more codebooks from among:

$$[ \begin{matrix}1 \\ 1 \\ 1 \\ 1\end{matrix} ] , [ \begin{matrix}1 \\ j \\ - 1 \\ - j\end{matrix} ] , [ \begin{matrix}1 \\ - 1 \\ 1 \\ - 1\end{matrix} ] , [ \begin{matrix}1 \\ - j \\ - 1 \\ j\end{matrix} ] , [ \begin{matrix}1 \\ \frac{1 + j}{\sqrt{2}} \\ j \\ \frac{- 1 + j}{\sqrt{2}}\end{matrix} ] , [ \begin{matrix}1 \\ \frac{- 1 + j}{\sqrt{2}} \\ - j \\ \frac{1 + j}{\sqrt{2}}\end{matrix} ] , [ \begin{matrix}1 \\ \frac{- 1 - j}{\sqrt{2}} \\ j \\ \frac{1 - j}{\sqrt{2}}\end{matrix} ] , [ \begin{matrix}1 \\ \frac{1 - j}{\sqrt{2}} \\ - j \\ \frac{- 1 - j}{\sqrt{2}}\end{matrix} ] ,$$

$$[ \begin{matrix}\begin{matrix}\begin{matrix}1 \\ 1\end{matrix} \\ - 1\end{matrix} \\ 1\end{matrix} ] , [ \begin{matrix}1 \\ j \\ 1 \\ j\end{matrix} ] , [ \begin{matrix}1 \\ - 1 \\ - 1 \\ 1\end{matrix} ] , [ \begin{matrix}\begin{matrix}1 \\ - j \\ 1\end{matrix} \\ - j\end{matrix} ] , [ \begin{matrix}1 \\ 1 \\ 1 \\ - 1\end{matrix} ] , [ \begin{matrix}1 \\ 1 \\ - 1 \\ 1\end{matrix} ] [ \begin{matrix}1 \\ - 1 \\ 1 \\ 1\end{matrix} ] , and [ \begin{matrix}1 \\ - 1 \\ - 1 \\ - 1\end{matrix} ] , where j is \sqrt{- 1} ;$$

$$\frac{1}{2} [ \begin{matrix}1 \\ 1 \\ 1 \\ - 1\end{matrix} ] , \frac{1}{2} [ \begin{matrix}1 \\ 1 \\ j \\ j\end{matrix} ] , \frac{1}{2} [ \begin{matrix}1 \\ 1 \\ - 1 \\ 1\end{matrix} ] , \frac{1}{2} [ \begin{matrix}1 \\ 1 \\ - j \\ - j\end{matrix} ] , \frac{1}{2} [ \begin{matrix}1 \\ j \\ 1 \\ j\end{matrix} ] , \frac{1}{2} [ \begin{matrix}1 \\ j \\ j \\ 1\end{matrix} ] , \frac{1}{2} [ \begin{matrix}1 \\ j \\ - 1 \\ - j\end{matrix} ] , \frac{1}{2} [ \begin{matrix}1 \\ j \\ - j \\ - 1\end{matrix} ] ,$$

$$\frac{1}{2} [ \begin{matrix}1 \\ - 1 \\ 1 \\ 1\end{matrix} ] , \frac{1}{2} [ \begin{matrix}1 \\ - 1 \\ j \\ - j\end{matrix} ] , \frac{1}{2} [ \begin{matrix}1 \\ - 1 \\ - 1 \\ - 1\end{matrix} ] , \frac{1}{2} [ \begin{matrix}1 \\ - 1 \\ - j \\ j\end{matrix} ] , \frac{1}{2} [ \begin{matrix}1 \\ - j \\ j \\ - 1\end{matrix} ] , \frac{1}{2} [ \begin{matrix}1 \\ - j \\ j \\ - 1\end{matrix} ] ,$$

$$\frac{1}{2} [ \begin{matrix}1 \\ - j \\ - 1 \\ j\end{matrix} ] , and \frac{1}{2} [ \begin{matrix}1 \\ - j \\ - j \\ 1\end{matrix} ] ;$$

$$[ \begin{matrix}1 & 1 \\ 1 & - 1 \\ 1 & - 1 \\ 1 & 1\end{matrix} ] , [ \begin{matrix}1 & - j \\ j & 1 \\ - 1 & - j \\ - j & 1\end{matrix} ] [ \begin{matrix}1 & - 1 \\ - 1 & 1 \\ 1 & 1 \\ - 1 & - 1\end{matrix} ] , [ \begin{matrix}1 & j \\ - 1 & 1 \\ - 1 & j \\ j & 1\end{matrix} ] , [ \begin{matrix}1 \frac{- 1 - j}{\sqrt{2}} \\ \frac{1 + j}{\sqrt{2}} j \\ j \frac{- 1 + j}{\sqrt{2}} \\ \frac{- 1 + j}{\sqrt{2}} 1\end{matrix} ] , [ \begin{matrix}1 \frac{1 - j}{\sqrt{2}} \\ \frac{- 1 + j}{\sqrt{2}} - j \\ - j \frac{1 + j}{\sqrt{2}} \\ \frac{1 + j}{\sqrt{2}} 1\end{matrix} ] ,$$

$$[ \begin{matrix}1 & - j \\ \frac{- 1 - j}{\sqrt{2}} & \frac{1 - j}{\sqrt{2}} \\ j & 1 \\ \frac{1 - j}{\sqrt{2}} & \frac{1 + j}{\sqrt{2}}\end{matrix} ] , [ \begin{matrix}1 & j \\ \frac{1 - j}{\sqrt{2}} & \frac{- 1 - j}{\sqrt{2}} \\ - j & 1 \\ \frac{- 1 - j}{\sqrt{2}} & \frac{- 1 + j}{\sqrt{2}}\end{matrix} ] , [ \begin{matrix}1 & 1 \\ 1 & 1 \\ - 1 & 1 \\ - 1 & 1\end{matrix} ] , [ \begin{matrix}1 & - j \\ j & - 1 \\ 1 & j \\ j & 1\end{matrix} ] , [ \begin{matrix}1 & - 1 \\ - 1 & - 1 \\ - 1 & 1 \\ 1 & 1\end{matrix} ] ,$$

$$[ \begin{matrix}1 & 1 \\ - j & j \\ 1 & 1 \\ - j & j\end{matrix} ] , [ \begin{matrix}1 & 1 \\ 1 & 1 \\ 1 & - 1 \\ - 1 & 1\end{matrix} ] , [ \begin{matrix}1 & - 1 \\ 1 & 1 \\ - 1 & 1 \\ 1 & 1\end{matrix} ] , [ \begin{matrix}1 & 1 \\ - 1 & 1 \\ 1 & 1 \\ 1 & - 1\end{matrix} ] , and [ \begin{matrix}1 & - 1 \\ - 1 & 1 \\ - 1 & - 1 \\ - 1 & - 1\end{matrix} ] ;$$

$$[ \begin{matrix}1 & 1 & 1 \\ 1 & 1 & - 1 \\ 1 & - 1 & - 1 \\ 1 & - 1 & 1\end{matrix} ] , [ \begin{matrix}1 & - j & - 1 \\ j & 1 & j \\ - 1 & j & 1 \\ - j & 1 & - j\end{matrix} ] , [ \begin{matrix}1 & - 1 & 1 \\ - 1 & 1 & 1 \\ 1 & 1 & 1 \\ - 1 & - 1 & 1\end{matrix} ] , [ \begin{matrix}1 & j & - 1 \\ - j & 1 & - j \\ - 1 & j & 1 \\ j & 1 & j\end{matrix} ] ,$$

$$[ \begin{matrix}1 \frac{1 - j}{\sqrt{2}} \frac{- 1 - j}{\sqrt{2}} \\ \frac{1 + j}{\sqrt{2}} 1 j \\ j \frac{- 1 - j}{\sqrt{2}} \frac{- 1 + j}{\sqrt{2}} \\ \frac{- 1 + j}{\sqrt{2}} - j 1\end{matrix} ] , [ \begin{matrix}1 \frac{- 1 - j}{\sqrt{2}} \frac{1 - j}{\sqrt{2}} \\ \frac{- 1 + j}{\sqrt{2}} 1 - j \\ - j \frac{1 - j}{\sqrt{2}} \frac{1 + j}{\sqrt{2}} \\ \frac{1 + j}{\sqrt{2}} j 1\end{matrix} ] , [ \begin{matrix}1 - j \frac{1 + j}{\sqrt{2}} \\ \frac{- 1 - j}{\sqrt{2}} \frac{1 - j}{\sqrt{2}} j \\ j 1 \frac{1 - j}{\sqrt{2}} \\ \frac{1 - j}{\sqrt{2}} \frac{1 + j}{\sqrt{2}} 1\end{matrix} ] ,$$

$$[ \begin{matrix}1 j \frac{- 1 + j}{\sqrt{2}} \\ \frac{1 - j}{\sqrt{2}} \frac{- 1 - j}{\sqrt{2}} - j \\ - j 1 \frac{- 1 - j}{\sqrt{2}} \\ \frac{- 1 - j}{\sqrt{2}} \frac{- 1 + j}{\sqrt{2}} 1\end{matrix} ] , [ \begin{matrix}1 & 1 & - 1 \\ 1 & 1 & 1 \\ - 1 & 1 & - 1 \\ - 1 & 1 & 1\end{matrix} ] , [ \begin{matrix}1 & 1 & - j \\ j & - j & - 1 \\ 1 & 1 & j \\ j & - j & 1\end{matrix} ] , [ \begin{matrix}1 & - 1 & - 1 \\ - 1 & 1 & - 1 \\ - 1 & - 1 & 1 \\ 1 & 1 & 1\end{matrix} ] ,$$

$$[ \begin{matrix}1 & 1 & j \\ - j & j & - 1 \\ 1 & 1 & - j \\ - j & j & 1\end{matrix} ] , [ \begin{matrix}1 & 1 & 1 \\ 1 & 1 & - 1 \\ 1 & - 1 & 1 \\ - 1 & 1 & 1\end{matrix} ] , [ \begin{matrix}1 & 1 & - 1 \\ 1 & 1 & 1 \\ - 1 & 1 & 1 \\ 1 & - 1 & 1\end{matrix} ] , [ \begin{matrix}1 & - 1 & 1 \\ - 1 & 1 & 1 \\ 1 & 1 & 1 \\ 1 & 1 & - 1\end{matrix} ] , and$$

$$[ \begin{matrix}1 & - 1 & - 1 \\ - 1 & 1 & - 1 \\ - 1 & - 1 & 1 \\ - 1 & - 1 & - 1\end{matrix} ] ; or [ \begin{matrix}1 & 1 & 1 & 1 \\ 1 & 1 & - 1 & - 1 \\ 1 & - 1 & 1 & - 1 \\ 1 & - 1 & - 1 & 1\end{matrix} ] , [ \begin{matrix}1 & - j & - 1 & j \\ j & 1 & j & 1 \\ - 1 & - j & 1 & j \\ - j & 1 & - j & 1\end{matrix} ] ,$$

$$[ \begin{matrix}1 & - 1 & 1 & - 1 \\ - 1 & 1 & 1 & - 1 \\ 1 & 1 & 1 & 1 \\ - 1 & - 1 & 1 & 1\end{matrix} ] , [ \begin{matrix}1 & j & - 1 & - j \\ - j & 1 & - j & 1 \\ - 1 & j & 1 & - j \\ j & 1 & j & 1\end{matrix} ] , [ \begin{matrix}1 \frac{1 - j}{\sqrt{2}} - j \frac{- 1 - j}{\sqrt{2}} \\ \frac{1 + j}{\sqrt{2}} 1 \frac{- 1 + j}{\sqrt{2}} j \\ j \frac{- 1 - j}{\sqrt{2}} 1 \frac{- 1 + j}{\sqrt{2}} \\ \frac{- 1 + j}{\sqrt{2}} - j \frac{- 1 - j}{\sqrt{2}} 1\end{matrix} ] ,$$

$$[ \begin{matrix}1 \frac{- 1 - j}{\sqrt{2}} j \frac{1 - j}{\sqrt{2}} \\ \frac{- 1 + j}{\sqrt{2}} 1 \frac{1 + j}{\sqrt{2}} - j \\ - j \frac{1 - j}{\sqrt{2}} 1 \frac{1 + j}{\sqrt{2}} \\ \frac{1 + j}{\sqrt{2}} j \frac{1 - j}{\sqrt{2}} 1\end{matrix} ] , [ \begin{matrix}1 - j \frac{- 1 + j}{\sqrt{2}} \frac{1 + j}{\sqrt{2}} \\ \frac{- 1 - j}{\sqrt{2}} \frac{1 - j}{\sqrt{2}} 1 j \\ j 1 \frac{1 + j}{\sqrt{2}} \frac{1 - j}{\sqrt{2}} \\ \frac{1 - j}{\sqrt{2}} \frac{1 + j}{\sqrt{2}} - j 1\end{matrix} ] ,$$

$$[ \begin{matrix}1 j \frac{1 + j}{\sqrt{2}} \frac{- 1 + j}{\sqrt{2}} \\ \frac{1 - j}{\sqrt{2}} \frac{- 1 - j}{\sqrt{2}} 1 - j \\ - j 1 \frac{- 1 + j}{\sqrt{2}} \frac{- 1 - j}{\sqrt{2}} \\ \frac{- 1 - j}{\sqrt{2}} \frac{- 1 + j}{\sqrt{2}} j 1\end{matrix} ] , [ \begin{matrix}1 & 1 & - 1 & - 1 \\ 1 & 1 & 1 & 1 \\ - 1 & 1 & 1 & - 1 \\ - 1 & 1 & - 1 & 1\end{matrix} ] , [ \begin{matrix}1 & - j & 1 & - j \\ j & 1 & - j & - 1 \\ 1 & j & 1 & j \\ j & - 1 & - j & 1\end{matrix} ] ,$$

$$[ \begin{matrix}1 & - 1 & - 1 & 1 \\ - 1 & - 1 & 1 & 1 \\ - 1 & 1 & - 1 & 1 \\ 1 & 1 & 1 & 1\end{matrix} ] , [ \begin{matrix}1 & 1 & j & j \\ - j & j & 1 & - 1 \\ 1 & 1 & - j & - j \\ - j & j & - 1 & 1\end{matrix} ] , [ \begin{matrix}1 & 1 & 1 & - 1 \\ 1 & 1 & - 1 & 1 \\ 1 & - 1 & 1 & 1 \\ - 1 & 1 & 1 & 1\end{matrix} ] ,$$

$$[ \begin{matrix}1 & - 1 & 1 & 1 \\ 1 & 1 & 1 & - 1 \\ - 1 & 1 & 1 & 1 \\ 1 & 1 & - 1 & 1\end{matrix} ] , [ \begin{matrix}1 & - 1 & 1 & 1 \\ 1 & 1 & - 1 & 1 \\ 1 & 1 & 1 & - 1 \\ - 1 & 1 & 1 & 1\end{matrix} ] , and [ \begin{matrix}1 & - 1 & - 1 & - 1 \\ - 1 & 1 & - 1 & - 1 \\ - 1 & - 1 & 1 & - 1 \\ - 1 & - 1 & - 1 & 1\end{matrix} ] .$$

Aspect 9: The method of Aspect 1, wherein the wireless communication device is configured with 8 antennas for the communication, and wherein the method further comprises transmitting or receiving a transmit precoding matrix indicator field that indicates one of 12 precoding matrices for use with 1 antenna, one of 20 precoding matrices for use with 2 antennas, one of 30 precoding matrices for use with 4 antennas, or one of 64 precoding matrices for use with 8 antennas.

Aspect 10: The method of Aspect 1, wherein the wireless communication device is configured with 8 antennas for the communication, and wherein the method further comprises transmitting or receiving a transmit precoding matrix indicator field that indicates one of 27 precoding matrices for use with 1 antenna, one of 36 precoding matrices for use with 2 antennas, one of 30 precoding matrices for use with 4 antennas, or one of 64 precoding matrices for use with 8 antennas.

Aspect 11: The method of Aspect 1, wherein the wireless communication device is configured with 8 antennas for the communication, and wherein the method further comprises transmitting or receiving a transmit precoding matrix indicator field that indicates one of 27 precoding matrices for use with 1 antenna, one of 36 precoding matrices for use with 2 antennas, one of 58 precoding matrices for use with 4 antennas, or one of 64 precoding matrices for use with 8 antennas.

Aspect 12: The method of Aspect 1, wherein the wireless communication device is configured with 8 antennas for the communication, and wherein the method further comprises transmitting or receiving a transmit precoding matrix indicator field that includes 4 bits to indicate a precoder for use with 1 antenna, 5 bits to indicate a precoder for use with 2 antennas, 6 bits to indicate a precoder for use with 4 antennas, or 7 bits to indicate a precoder for use with 8 antennas.

Aspect 13: The method of Aspect 1, wherein the wireless communication device is configured with 8 antennas for the communication, and wherein the method further comprises transmitting or receiving a transmit precoding matrix indicator field that indicates one of 12 precoding matrices for use with 1 antenna, one of 52 precoding matrices for use with 2 antennas or 4 antennas, or one of 64 precoding matrices for use with 8 antennas.

Aspect 14: The method of Aspect 1, wherein the one or more codebooks include codebooks specified as:

$$\frac{1}{2 \sqrt{2}} [ \begin{matrix}1 & 0 & 0 & 0 \\ 0 & 1 & 0 & 0 \\ 1 & 0 & 0 & 0 \\ 0 & 0 & 1 & 0 \\ 1 & 0 & 0 & 0 \\ 0 & - 1 & 0 & 0 \\ 1 & 0 & 0 & 0 \\ 0 & 0 & 0 & 1\end{matrix} ] and \frac{1}{2 \sqrt{2}} [ \begin{matrix}1 & 0 & 0 & 0 \\ 0 & 1 & 0 & 0 \\ 1 & 0 & 0 & 0 \\ 0 & 0 & 1 & 0 \\ j & 0 & 0 & 0 \\ 0 & - j & 0 & 0 \\ j & 0 & 0 & 0 \\ 0 & 0 & 0 & 1\end{matrix} ] , where j is \sqrt{- 1} ; or$$

$$\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 1 & 1 \\ 1 & 0 & 0 & 0 \\ 0 & - 1 & 0 & 0 \\ 0 & 0 & 1 & 0 \\ 0 & 0 & 0 & - 1\end{matrix} ] and \frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ j & 0 & 0 & 0 \\ 0 & - j & 0 & 0 \\ 0 & 0 & j & 0 \\ 0 & 0 & 0 & - j\end{matrix} ] .$$

Aspect 15: The method of Aspect 1, wherein the one or more codebooks include codebooks specified as:

$$\frac{1}{2 \sqrt{2}} [ \begin{matrix}1 & 0 & 0 \\ 0 & 1 & 0 \\ 0 & 0 & 1 \\ 0 & 0 & 0 \\ 1 & 0 & 0 \\ 0 & j & 0 \\ 0 & 0 & - 1 \\ 0 & 0 & 0\end{matrix} ] , \frac{1}{2 \sqrt{2}} [ \begin{matrix}1 & 0 & 0 \\ 0 & 1 & 0 \\ 0 & 0 & 1 \\ 0 & 0 & 0 \\ j & 0 & 0 \\ 0 & - 1 & 0 \\ 0 & 0 & - j \\ 0 & 0 & 0\end{matrix} ] , \frac{1}{2 \sqrt{2}} [ \begin{matrix}1 & 0 & 0 \\ 0 & 1 & 0 \\ 0 & 0 & 1 \\ 0 & 0 & 0 \\ - 1 & 0 & 0 \\ 0 & - j & 0 \\ 0 & 0 & 1 \\ 0 & 0 & 0\end{matrix} ] , and$$

$$\frac{1}{2 \sqrt{2}} [ \begin{matrix}1 & 0 & 0 \\ 0 & 1 & 0 \\ 0 & 0 & 1 \\ 0 & 0 & 0 \\ - j & 0 & 0 \\ 0 & 1 & 0 \\ 0 & 0 & j \\ 0 & 0 & 0\end{matrix} ] , where j is \sqrt{- 1} ; or \frac{1}{2 \sqrt{2}} [ \begin{matrix}1 & 0 & 0 \\ 0 & 0 & 0 \\ 0 & 1 & 0 \\ 0 & 0 & 0 \\ 1 & 0 & 0 \\ 0 & 0 & 0 \\ 0 & 0 & 1 \\ 0 & 0 & 0\end{matrix} ] , \frac{1}{2 \sqrt{2}} [ \begin{matrix}1 & 0 & 0 \\ 0 & 0 & 0 \\ 0 & 1 & 0 \\ 0 & 0 & 0 \\ - 1 & 0 & 0 \\ 0 & 0 & 0 \\ 0 & 0 & 1 \\ 0 & 0 & 0\end{matrix} ] .$$

Aspect 16: The method of Aspect 1, wherein the one or more codebooks are

$$\frac{1}{2 \sqrt{2}} [ \begin{matrix}1 & 0 & 0 \\ 0 & 1 & 0 \\ 1 & 0 & 0 \\ 0 & 0 & 1 \\ 1 & 0 & 0 \\ 0 & - 1 & 0 \\ 1 & 0 & 0 \\ 0 & 0 & - 1\end{matrix} ] , \frac{1}{2 \sqrt{2}} [ \begin{matrix}1 & 0 & 0 \\ 0 & 1 & 0 \\ 1 & 0 & 0 \\ 0 & 0 & 1 \\ j & 0 & 0 \\ 0 & - j & 0 \\ j & 0 & 0 \\ 0 & 0 & - j\end{matrix} ] , \frac{1}{2 \sqrt{2}} [ \begin{matrix}1 & 0 & 0 \\ 0 & 1 & 0 \\ - 1 & 0 & 0 \\ 0 & 0 & - 1 \\ 1 & 0 & 0 \\ 0 & - 1 & 0 \\ - 1 & 0 & 0 \\ 0 & 0 & 1\end{matrix} ] , and$$

$$\frac{1}{2 \sqrt{2}} [ \begin{matrix}1 & 0 & 0 \\ 0 & 1 & 0 \\ - 1 & 0 & 0 \\ 0 & 0 & - 1 \\ j & 0 & 0 \\ 0 & - j & 0 \\ - j & 0 & 0 \\ 0 & 0 & j\end{matrix} ] , where j is \sqrt{- 1} .$$

Aspect 17: The method of Aspect 1, wherein the one or more codebooks are specified as:

$$\frac{1}{2 \sqrt{6}} [ \begin{matrix}1 & 1 & 1 \\ 0 & 0 & 0 \\ 1 & - 1 & 1 \\ 0 & 0 & 0 \\ 1 & 1 & - 1 \\ 0 & 0 & 0 \\ 1 & - 1 & - 1 \\ 0 & 0 & 0\end{matrix} ] , \frac{1}{2 \sqrt{6}} [ \begin{matrix}1 & 1 & 1 \\ 0 & 0 & 0 \\ 1 & - 1 & 1 \\ 0 & 0 & 0 \\ j & j & - j \\ 0 & 0 & 0 \\ j & - j & - j \\ 0 & 0 & 0\end{matrix} ] , \frac{1}{2 \sqrt{6}} [ \begin{matrix}1 & 1 & 1 \\ 0 & 0 & 0 \\ - 1 & 1 & - 1 \\ 0 & 0 & 0 \\ 1 & 1 & - 1 \\ 0 & 0 & 0 \\ - 1 & 1 & 1 \\ 0 & 0 & 0\end{matrix} ] , and$$

$$\frac{1}{2 \sqrt{6}} [ \begin{matrix}1 & 1 & 1 \\ 0 & 0 & 0 \\ - 1 & 1 & - 1 \\ 0 & 0 & 0 \\ j & j & - j \\ 0 & 0 & 0 \\ - j & j & j \\ 0 & 0 & 0\end{matrix} ] , where j is \sqrt{- 1} .$$

Aspect 18: The method of Aspect 1, wherein the one or more codebooks are specified as:

$$\{ \frac{1}{2 \sqrt{6}} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & - {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ]\end{matrix} ] \} ,$$

$$where j is \sqrt{- 1} , where {i}_{1} = 0 , … , 7 , and where {i}_{2} = 0 , 1 ; or$$

$$\frac{1}{2 \sqrt{6}} [ \begin{matrix}1 & 1 & 1 \\ 1 & j & 1 \\ 1 & - 1 & 1 \\ 1 & - j & 1 \\ 1 & 1 & - 1 \\ 1 & j & - 1 \\ 1 & - 1 & - 1 \\ 1 & - j & - 1\end{matrix} ] , \frac{1}{2 \sqrt{6}} [ \begin{matrix}1 & 1 & 1 \\ 1 & j & 1 \\ 1 & - 1 & 1 \\ 1 & - j & 1 \\ j & j & - j \\ j & - 1 & - j \\ j & - j & - j \\ j & 1 & - j\end{matrix} ] , \frac{1}{2 \sqrt{6}} [ \begin{matrix}1 & 1 & 1 \\ j & - 1 & j \\ - 1 & 1 & - 1 \\ - j & - 1 & - j \\ 1 & 1 & - 1 \\ j & - 1 & - j \\ - 1 & 1 & 1 \\ - j & - 1 & j\end{matrix} ] ,$$

$$\frac{1}{2 \sqrt{6}} [ \begin{matrix}1 & 1 & 1 \\ j & - 1 & j \\ - 1 & 1 & - 1 \\ - j & - 1 & - j \\ j & j & - j \\ - 1 & - j & 1 \\ - j & j & j \\ 1 & - j & - 1\end{matrix} ] , \frac{1}{2 \sqrt{6}} [ \begin{matrix}1 & 1 & 1 \\ - 1 & - j & - 1 \\ 1 & - 1 & 1 \\ - 1 & j & - 1 \\ 1 & 1 & - 1 \\ - 1 & - j & 1 \\ 1 & - 1 & - 1 \\ - 1 & j & 1\end{matrix} ] , \frac{1}{2 \sqrt{6}} [ \begin{matrix}1 & 1 & 1 \\ - 1 & - j & - 1 \\ 1 & - 1 & 1 \\ - 1 & j & - 1 \\ j & j & - j \\ - j & 1 & j \\ j & - j & - j \\ - j & - 1 & j\end{matrix} ] ,$$

$$\frac{1}{2 \sqrt{6}} [ \begin{matrix}1 & 1 & 1 \\ - j & 1 & - j \\ - 1 & 1 & - 1 \\ j & 1 & j \\ 1 & 1 & - 1 \\ - j & 1 & j \\ - 1 & 1 & 1 \\ j & 1 & - j\end{matrix} ] , and \frac{1}{2 \sqrt{6}} [ \begin{matrix}1 & 1 & 1 \\ - j & 1 & - j \\ - 1 & 1 & - 1 \\ j & 1 & j \\ j & j & - j \\ 1 & j & - 1 \\ - j & j & j \\ - 1 & j & 1\end{matrix} ] .$$

Aspect 19: The method of Aspect 1, wherein the one or more codebooks are specified as:

$$\frac{1}{4} [ \begin{matrix}1 & 1 & 0 & 0 \\ 1 & - 1 & 0 & 0 \\ 0 & 0 & 1 & 1 \\ 0 & 0 & 1 & - 1 \\ 1 & 1 & 0 & 0 \\ 1 & - 1 & 0 & 0 \\ 0 & 0 & - 1 & - 1 \\ 0 & 0 & - 1 & 1\end{matrix} ] and \frac{1}{4} [ \begin{matrix}1 & 1 & 0 & 0 \\ 1 & - 1 & 0 & 0 \\ 0 & 0 & 1 & 1 \\ 0 & 0 & 1 & - 1 \\ j & j & 0 & 0 \\ j & - j & 0 & 0 \\ 0 & 0 & - j & - j \\ 0 & 0 & - j & j\end{matrix} ] , where j is \sqrt{- 1} ; or$$

$$\frac{1}{4} [ \begin{matrix}1 & 1 & 0 & 0 \\ 0 & 0 & 0 & 0 \\ 0 & 0 & 1 & 1 \\ 0 & 0 & 0 & 0 \\ 1 & - 1 & 0 & 0 \\ 0 & 0 & 0 & 0 \\ 0 & 0 & 1 & - 1 \\ 0 & 0 & 0 & 0\end{matrix} ] and \frac{1}{4} [ \begin{matrix}1 & 1 & 0 & 0 \\ 0 & 0 & 0 & 0 \\ 0 & 0 & 1 & 1 \\ 0 & 0 & 0 & 0 \\ j & - j & 0 & 0 \\ 0 & 0 & 0 & 0 \\ 0 & 0 & j & - j \\ 0 & 0 & 0 & 0\end{matrix} ] .$$

Aspect 20: The method of Aspect 1, wherein the codebook is specified as:

$$\{ \frac{1}{4 \sqrt{2}} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] \\ [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] \\ - {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & - {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & \end{matrix} ] \} ,$$

$$where j is \sqrt{- 1} , where {i}_{1} = 0 , … , 7 , and where {i}_{2} = 0 , 1 ; or$$

$$\frac{1}{4 \sqrt{2}} [ \begin{matrix}1 & 1 & 1 & 1 \\ 1 & j & 1 & j \\ 1 & - 1 & 1 & j \\ 1 & - j & 1 & - j \\ 1 & 1 & - 1 & 1 \\ 1 & j & - 1 & - j \\ 1 & - 1 & - 1 & 1 \\ 1 & - j & - 1 & j\end{matrix} ] , \frac{1}{4 \sqrt{2}} [ \begin{matrix}1 & 1 & 1 & 1 \\ 1 & j & 1 & j \\ 1 & - 1 & 1 & - 1 \\ 1 & - j & 1 & - j \\ j & j & - j & - j \\ j & - 1 & - j & - 1 \\ j & - j & - j & - j \\ j & 1 & - j & 1\end{matrix} ] ,$$

$$\frac{1}{4 \sqrt{2}} [ \begin{matrix}1 & 1 & 1 & 1 \\ j & - 1 & j & - 1 \\ - 1 & 1 & - 1 & 1 \\ - j & - 1 & - j & - 1 \\ 1 & 1 & - 1 & - 1 \\ j & - 1 & - j & 1 \\ - 1 & 1 & 1 & - 1 \\ - j & - 1 & j & 1\end{matrix} ] , \frac{1}{4 \sqrt{2}} [ \begin{matrix}1 & 1 & 1 & 1 \\ - 1 & - j & - 1 & - 1 \\ - 1 & 1 & - 1 & - 1 \\ - j & - 1 & - j & - 1 \\ j & j & - j & - j \\ - 1 & - j & 1 & j \\ - j & j & j & - j \\ 1 & - j & - 1 & j\end{matrix} ] ,$$

$$\frac{1}{4 \sqrt{2}} [ \begin{matrix}1 & 1 & 1 & 1 \\ - 1 & - j & - 1 & - j \\ 1 & - 1 & 1 & - 1 \\ - 1 & j & - 1 & j \\ 1 & 1 & - 1 & - 1 \\ - 1 & - j & 1 & j \\ 1 & - 1 & - 1 & 1 \\ - 1 & j & 1 & - j\end{matrix} ] , \frac{1}{4 \sqrt{2}} [ \begin{matrix}1 & 1 & 1 & 1 \\ - 1 & - j & - 1 & - j \\ 1 & - 1 & 1 & 1 \\ - 1 & j & - 1 & j \\ j & j & - j & - j \\ - j & 1 & j & - 1 \\ j & - j & - j & j \\ - j & - 1 & j & 1\end{matrix} ] ,$$

$$\frac{1}{4 \sqrt{2}} [ \begin{matrix}1 & 1 & 1 & 1 \\ - j & 1 & - j & 1 \\ - 1 & 1 & - 1 & 1 \\ j & 1 & j & 1 \\ 1 & 1 & - 1 & - 1 \\ - j & 1 & j & - 1 \\ - 1 & 1 & 1 & - 1 \\ j & 1 & - j & - 1\end{matrix} ] , and \frac{1}{4 \sqrt{2}} [ \begin{matrix}1 & 1 & 1 & 1 \\ - j & 1 & - j & 1 \\ - 1 & 1 & - 1 & 1 \\ j & 1 & j & 1 \\ j & j & - j & - j \\ 1 & - j & - 1 & - j \\ - j & j & j & - j \\ - 1 & j & 1 & - j\end{matrix} ] .$$

Aspect 21: The method of Aspect 1, wherein the one or more codebooks are specified as:

$$\frac{1}{\sqrt{6}} [ \begin{matrix}1 \\ 0 \\ 0 \\ 1 \\ 0 \\ 0\end{matrix} ] , \frac{1}{\sqrt{6}} [ \begin{matrix}1 \\ 0 \\ 0 \\ j \\ 0 \\ 0\end{matrix} ] , \frac{1}{\sqrt{6}} [ \begin{matrix}1 \\ 0 \\ 0 \\ - 1 \\ 0 \\ 0\end{matrix} ] , \frac{1}{\sqrt{6}} [ \begin{matrix}1 \\ 0 \\ 0 \\ - j \\ 0 \\ 0\end{matrix} ] , \frac{1}{\sqrt{6}} [ \begin{matrix}0 \\ 0 \\ 1 \\ 0 \\ 0 \\ 1\end{matrix} ] , \frac{1}{\sqrt{6}} [ \begin{matrix}0 \\ 0 \\ 1 \\ 0 \\ 0 \\ j\end{matrix} ] ,$$

$$\frac{1}{\sqrt{6}} [ \begin{matrix}0 \\ 0 \\ 1 \\ 0 \\ 0 \\ - 1\end{matrix} ] , and \frac{1}{\sqrt{6}} [ \begin{matrix}0 \\ 0 \\ 1 \\ 0 \\ 0 \\ - j\end{matrix} ] , where j is \sqrt{- 1} ; or \frac{1}{\sqrt{6}} [ \begin{matrix}1 \\ 0 \\ 1 \\ 1 \\ 0 \\ 1\end{matrix} ] , \frac{1}{\sqrt{6}} [ \begin{matrix}1 \\ 0 \\ 1 \\ j \\ 0 \\ j\end{matrix} ] ,$$

$$\frac{1}{\sqrt{6}} [ \begin{matrix}1 \\ 0 \\ 1 \\ - 1 \\ 0 \\ - 1\end{matrix} ] , \frac{1}{\sqrt{6}} [ \begin{matrix}1 \\ 0 \\ 1 \\ - j \\ 0 \\ - j\end{matrix} ] , \frac{1}{\sqrt{6}} [ \begin{matrix}1 \\ 0 \\ j \\ 1 \\ 0 \\ j\end{matrix} ] , \frac{1}{\sqrt{6}} [ \begin{matrix}1 \\ 0 \\ j \\ j \\ 0 \\ - 1\end{matrix} ] , \frac{1}{\sqrt{6}} [ \begin{matrix}1 \\ 0 \\ j \\ - 1 \\ 0 \\ - j\end{matrix} ] , \frac{1}{\sqrt{6}} [ \begin{matrix}1 \\ 0 \\ j \\ - j \\ 0 \\ 1\end{matrix} ] ,$$

$$\frac{1}{\sqrt{6}} [ \begin{matrix}1 \\ 0 \\ - 1 \\ 1 \\ 0 \\ - 1\end{matrix} ] , \frac{1}{\sqrt{6}} [ \begin{matrix}1 \\ 0 \\ - 1 \\ j \\ 0 \\ - j\end{matrix} ] , \frac{1}{\sqrt{6}} [ \begin{matrix}1 \\ 0 \\ - 1 \\ - 1 \\ 0 \\ 1\end{matrix} ] , \frac{1}{\sqrt{6}} [ \begin{matrix}1 \\ 0 \\ - j \\ 1 \\ 0 \\ - j\end{matrix} ] , \frac{1}{\sqrt{6}} [ \begin{matrix}1 \\ 0 \\ - j \\ j \\ 0 \\ 1\end{matrix} ] ,$$

$$\frac{1}{\sqrt{6}} [ \begin{matrix}1 \\ 0 \\ - j \\ - 1 \\ 0 \\ j\end{matrix} ] , and \frac{1}{\sqrt{6}} [ \begin{matrix}1 \\ 0 \\ - j \\ - j \\ 0 \\ - 1\end{matrix} ] .$$

Aspect 22: The method of Aspect 1, wherein the codebook is specified as:

$$\{ \frac{1}{\sqrt{6}} [ \begin{matrix}[ \begin{matrix}1 \\ {e}^{j \frac{π}{3} {i}_{1}} \\ {e}^{j \frac{2 π}{3} {i}_{1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} , where j is \sqrt{- 1} , where {i}_{1} = 0 , … , 5 , and$$

$$where {i}_{2} = 0 , 1 , 2 , 3 or {i}_{2} = 0 , 2 ;$$

$$\{ \frac{1}{2 \sqrt{3}} [ \begin{matrix}[ \begin{matrix}1 \\ {e}^{j \frac{π}{3} {i}_{1}} \\ {e}^{j \frac{2 π}{3} {i}_{1 , 1}}\end{matrix} ] & [ \begin{matrix}1 \\ {e}^{j \frac{π}{3} {i}_{1}} \\ {e}^{j \frac{2 π}{3} {i}_{1 , 1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} ;$$

$$\{ \frac{1}{3 \sqrt{2}} [ \begin{matrix}[ \begin{matrix}1 \\ {e}^{j \frac{π}{3} {i}_{1}} \\ {e}^{j \frac{2 π}{3} {i}_{1}}\end{matrix} ] & [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & [ \begin{matrix}1 \\ {e}^{j \frac{π}{3} {i}_{1}} \\ {e}^{j \frac{2 π}{3} {i}_{1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} ; or$$

$$\{ \frac{1}{2 \sqrt{6}} [ \begin{matrix}[ \begin{matrix}1 \\ {e}^{j \frac{π}{3} {i}_{1}} \\ {e}^{j \frac{2 π}{3} {i}_{1}}\end{matrix} ] & [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & [ \begin{matrix}1 \\ {e}^{j \frac{π}{3} {i}_{1}} \\ {e}^{j \frac{2 π}{3} {i}_{1}}\end{matrix} ] \\ [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ] \\ - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] & - {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ] & \end{matrix} ] \} ,$$

$$where {i}_{1} = 0 , … , 5 and where {i}_{2} = 0 , 1 .$$

Aspect 23: The method of Aspect 1, wherein the one or more codebooks are specified as:

$$\frac{1}{\sqrt{6}} [ \begin{matrix}1 & 0 \\ 0 & 0 \\ 0 & 1 \\ 1 & 0 \\ 0 & 0 \\ 0 & - j\end{matrix} ] , \frac{1}{\sqrt{6}} [ \begin{matrix}1 & 0 \\ 0 & 0 \\ 0 & 1 \\ 1 & 0 \\ 0 & 0 \\ 0 & j\end{matrix} ] , \frac{1}{\sqrt{6}} [ \begin{matrix}1 & 0 \\ 0 & 0 \\ 0 & 1 \\ - j & 0 \\ 0 & 0 \\ 0 & 1\end{matrix} ] , \frac{1}{\sqrt{6}} [ \begin{matrix}1 & 0 \\ 0 & 0 \\ 0 & 1 \\ - j & 0 \\ 0 & 0 \\ 0 & - 1\end{matrix} ] , \frac{1}{\sqrt{6}} [ \begin{matrix}1 & 0 \\ 0 & 0 \\ 0 & 1 \\ - 1 & 0 \\ 0 & 0 \\ 0 & - j\end{matrix} ] ,$$

$$\frac{1}{\sqrt{6}} [ \begin{matrix}1 & 0 \\ 0 & 0 \\ 0 & 1 \\ - 1 & 0 \\ 0 & 0 \\ 0 & j\end{matrix} ] , \frac{1}{\sqrt{6}} [ \begin{matrix}1 & 0 \\ 0 & 0 \\ 0 & 1 \\ j & 0 \\ 0 & 0 \\ 0 & 1\end{matrix} ] , and \frac{1}{\sqrt{6}} [ \begin{matrix}1 & 0 \\ 0 & 0 \\ 0 & 1 \\ j & 0 \\ 0 & 0 \\ 0 & - 1\end{matrix} ] , where j is \sqrt{- 1} ; or$$

$$\frac{1}{\sqrt{6}} [ \begin{matrix}1 & 0 \\ 1 & 0 \\ 0 & 1 \\ 1 & 0 \\ 1 & 0 \\ 0 & - 1\end{matrix} ] , \frac{1}{\sqrt{6}} [ \begin{matrix}1 & 0 \\ 1 & 0 \\ 0 & 1 \\ j & 0 \\ j & 0 \\ 0 & - j\end{matrix} ] , \frac{1}{\sqrt{6}} [ \begin{matrix}1 & 0 \\ j & 0 \\ 0 & 1 \\ 1 & 0 \\ j & 0 \\ 0 & - 1\end{matrix} ] , \frac{1}{\sqrt{6}} [ \begin{matrix}1 & 0 \\ j & 0 \\ 0 & 1 \\ j & 0 \\ - 1 & 0 \\ 0 & - j\end{matrix} ] ,$$

$$\frac{1}{\sqrt{6}} [ \begin{matrix}1 & 0 \\ - 1 & 0 \\ 0 & 1 \\ 1 & 0 \\ - 1 & 0 \\ 0 & - 1\end{matrix} ] , \frac{1}{\sqrt{6}} [ \begin{matrix}1 & 0 \\ - 1 & 0 \\ 0 & 1 \\ j & 0 \\ - j & 0 \\ 0 & - j\end{matrix} ] , \frac{1}{\sqrt{6}} [ \begin{matrix}1 & 0 \\ - j & 0 \\ 0 & 1 \\ 1 & 0 \\ - j & 0 \\ 0 & - 1\end{matrix} ] , and \frac{1}{\sqrt{6}} [ \begin{matrix}1 & 0 \\ - j & 0 \\ 0 & 1 \\ j & 0 \\ 1 & 0 \\ 0 & - j\end{matrix} ] .$$

Aspect 24: The method of Aspect 1, wherein the one or more codebooks are specified as:

$$\frac{1}{\sqrt{6}} [ \begin{matrix}1 & 0 \\ 0 & 1 \\ 1 & 0 \\ 1 & 0 \\ 0 & - 1 \\ 1 & 0\end{matrix} ] , \frac{1}{\sqrt{6}} [ \begin{matrix}1 & 0 \\ 0 & 1 \\ 1 & 0 \\ j & 0 \\ 0 & - j \\ j & 0\end{matrix} ] , \frac{1}{\sqrt{6}} [ \begin{matrix}1 & 0 \\ 0 & 1 \\ j & 0 \\ 1 & 0 \\ 0 & - 1 \\ j & 0\end{matrix} ] , \frac{1}{\sqrt{6}} [ \begin{matrix}1 & 0 \\ 0 & 1 \\ j & 0 \\ j & 0 \\ 0 & - j \\ - 1 & 0\end{matrix} ] , \frac{1}{\sqrt{6}} [ \begin{matrix}1 & 0 \\ 0 & 1 \\ - 1 & 0 \\ 1 & 0 \\ 0 & - 1 \\ - 1 & 0\end{matrix} ] ,$$

$$\frac{1}{\sqrt{6}} [ \begin{matrix}1 & 0 \\ 0 & 1 \\ - 1 & 0 \\ j & 0 \\ 0 & - j \\ - j & 0\end{matrix} ] , \frac{1}{\sqrt{6}} [ \begin{matrix}1 & 0 \\ 0 & 1 \\ - j & 0 \\ 1 & 0 \\ 0 & - 1 \\ - j & 0\end{matrix} ] , and \frac{1}{\sqrt{6}} [ \begin{matrix}1 & 0 \\ 0 & 1 \\ - j & 0 \\ j & 0 \\ 0 & - j \\ 1 & 0\end{matrix} ] , where j is \sqrt{- 1} .$$

Aspect 25: The method of Aspect 1, wherein the one or more codebooks are specified as:

$$\frac{1}{2 \sqrt{3}} [ \begin{matrix}1 & 1 \\ 0 & 0 \\ 1 & 1 \\ 1 & - 1 \\ 0 & 0 \\ 1 & - 1\end{matrix} ] , \frac{1}{2 \sqrt{3}} [ \begin{matrix}1 & 1 \\ 0 & 0 \\ 1 & 1 \\ j & - j \\ 0 & 0 \\ j & - j\end{matrix} ] , \frac{1}{2 \sqrt{3}} [ \begin{matrix}1 & 1 \\ 0 & 0 \\ j & j \\ 1 & - 1 \\ 0 & 0 \\ j & - j\end{matrix} ] , \frac{1}{2 \sqrt{3}} [ \begin{matrix}1 & 1 \\ 0 & 0 \\ j & j \\ j & - j \\ 0 & 0 \\ - 1 & 1\end{matrix} ] ,$$

$$\frac{1}{2 \sqrt{3}} [ \begin{matrix}1 & 1 \\ 0 & 0 \\ - 1 & - 1 \\ 1 & - 1 \\ 0 & 0 \\ - 1 & 1\end{matrix} ] , \frac{1}{2 \sqrt{3}} [ \begin{matrix}1 & 1 \\ 0 & 0 \\ - 1 & - 1 \\ j & - j \\ 0 & 0 \\ - j & j\end{matrix} ] , \frac{1}{2 \sqrt{3}} [ \begin{matrix}1 & 1 \\ 0 & 0 \\ - j & - j \\ 1 & - 1 \\ 0 & 0 \\ - j & j\end{matrix} ] , and \frac{1}{2 \sqrt{3}} [ \begin{matrix}1 & 1 \\ 0 & 0 \\ - j & - j \\ j & - j \\ 0 & 0 \\ 1 & - 1\end{matrix} ] ,$$

$$where j is \sqrt{- 1} .$$

Aspect 26: The method of Aspect 1, wherein the one or more codebooks are specified as:

$$\frac{1}{\sqrt{6}} [ \begin{matrix}1 & 0 & 0 \\ 0 & 1 & 0 \\ 0 & 0 & 1 \\ 1 & 0 & 0 \\ 0 & j & 0 \\ 0 & 0 & - 1\end{matrix} ] , \frac{1}{\sqrt{6}} [ \begin{matrix}1 & 0 & 0 \\ 0 & 1 & 0 \\ 0 & 0 & 1 \\ j & 0 & 0 \\ 0 & - 1 & 0 \\ 0 & 0 & - j\end{matrix} ] , \frac{1}{\sqrt{6}} [ \begin{matrix}1 & 0 & 0 \\ 0 & 1 & 0 \\ 0 & 0 & 1 \\ - 1 & 0 & 0 \\ 0 & - j & 0 \\ 0 & 0 & 1\end{matrix} ] , and$$

$$\frac{1}{\sqrt{6}} [ \begin{matrix}1 & 0 & 0 \\ 0 & 1 & 0 \\ 0 & 0 & 1 \\ - j & 0 & 0 \\ 0 & 1 & 0 \\ 0 & 0 & j\end{matrix} ] , where j is \sqrt{- 1} ; or$$

$$\frac{1}{\sqrt{6}} [ \begin{matrix}1 & 0 & 0 \\ 0 & 0 & 0 \\ 0 & 1 & 0 \\ 1 & 0 & 0 \\ 0 & 0 & 0 \\ 0 & 0 & 1\end{matrix} ] and \frac{1}{\sqrt{6}} [ \begin{matrix}1 & 0 & 0 \\ 0 & 0 & 0 \\ 0 & 1 & 0 \\ - 1 & 0 & 0 \\ 0 & 0 & 0 \\ 0 & 0 & 1\end{matrix} ] .$$

Aspect 27: The method of Aspect 1, wherein the one or more codebooks are specified as:

$$\frac{1}{\sqrt{6}} [ \begin{matrix}1 & 0 & 0 \\ 1 & 0 & 0 \\ 0 & 1 & 0 \\ 1 & 0 & 0 \\ 1 & 0 & 0 \\ 0 & 0 & 1\end{matrix} ] , \frac{1}{\sqrt{6}} [ \begin{matrix}1 & 0 & 0 \\ 1 & 0 & 0 \\ 0 & 1 & 0 \\ - 1 & 0 & 0 \\ - 1 & 0 & 0 \\ 0 & 0 & 1\end{matrix} ] , \frac{1}{\sqrt{6}} [ \begin{matrix}1 & 0 & 0 \\ j & 0 & 0 \\ 0 & 1 & 0 \\ 1 & 0 & 0 \\ j & 0 & 0 \\ 0 & 0 & 1\end{matrix} ] , and \frac{1}{\sqrt{6}} [ \begin{matrix}1 & 0 & 0 \\ j & 0 & 0 \\ 0 & 1 & 0 \\ - 1 & 0 & 0 \\ - j & 0 & 0 \\ 0 & 0 & 1\end{matrix} ] ,$$

$$where j is \sqrt{- 1} ; or$$

$$\frac{1}{\sqrt{6}} [ \begin{matrix}1 & 0 & 0 \\ 0 & 1 & 0 \\ 1 & 0 & 0 \\ 1 & 0 & 0 \\ 0 & 0 & 1 \\ 1 & 0 & 0\end{matrix} ] , \frac{1}{\sqrt{6}} [ \begin{matrix}1 & 0 & 0 \\ 0 & 1 & 0 \\ 1 & 0 & 0 \\ - 1 & 0 & 0 \\ 0 & 0 & 1 \\ - 1 & 0 & 0\end{matrix} ] , \frac{1}{\sqrt{6}} [ \begin{matrix}1 & 0 & 0 \\ 0 & 1 & 0 \\ j & 0 & 0 \\ 1 & 0 & 0 \\ 0 & 0 & 1 \\ j & 0 & 0\end{matrix} ] , and \frac{1}{\sqrt{6}} [ \begin{matrix}1 & 0 & 0 \\ 0 & 1 & 0 \\ j & 0 & 0 \\ - 1 & 0 & 0 \\ 0 & 0 & 1 \\ - j & 0 & 0\end{matrix} ] .$$

Aspect 28: The method of Aspect 1, wherein the one or more codebooks are specified as:

$$\frac{1}{3 \sqrt{2}} [ \begin{matrix}1 & 1 & 1 \\ 0 & 0 & 0 \\ 1 & - 1 & 1 \\ 1 & 1 & - 1 \\ 0 & 0 & 0 \\ 1 & - 1 & - 1\end{matrix} ] , \frac{1}{3 \sqrt{2}} [ \begin{matrix}1 & 1 & 1 \\ 0 & 0 & 0 \\ 1 & - 1 & 1 \\ j & j & - j \\ 0 & 0 & 0 \\ j & - j & - j\end{matrix} ] , \frac{1}{3 \sqrt{2}} [ \begin{matrix}1 & 1 & 1 \\ 0 & 0 & 0 \\ - 1 & 1 & - 1 \\ 1 & 1 & - 1 \\ 0 & 0 & 0 \\ - 1 & 1 & 1\end{matrix} ] , and$$

$$\frac{1}{3 \sqrt{2}} [ \begin{matrix}1 & 1 & 1 \\ 0 & 0 & 0 \\ - 1 & 1 & - 1 \\ j & j & - j \\ 0 & 0 & 0 \\ - j & j & j\end{matrix} ] , where j is \sqrt{- 1} .$$

Aspect 29: The method of Aspect 1, wherein the one or more codebooks are specified as:

$$\{ \frac{1}{\sqrt{6}} [ \begin{matrix}1 & 0 & 0 & 0 \\ 0 & 1 & 0 & 0 \\ 0 & 0 & 1 & 0 \\ 1 & 0 & 0 & 0 \\ 0 & - 1 & 0 & 0 \\ 0 & 0 & 0 & 1\end{matrix} ] , \frac{1}{\sqrt{6}} [ \begin{matrix}1 & 0 & 0 & 0 \\ 0 & 1 & 0 & 0 \\ 0 & 0 & 1 & 0 \\ j & 0 & 0 & 0 \\ 0 & - j & 0 & 0 \\ 0 & 0 & 0 & 1\end{matrix} ] \} or$$

$$\{ \frac{1}{2 \sqrt{3}} [ \begin{matrix}1 & 1 & 0 & 0 \\ 0 & 0 & 0 & 0 \\ 0 & 0 & 1 & 1 \\ 1 & - 1 & 0 & 0 \\ 0 & 0 & 0 & 0 \\ 0 & 0 & 1 & - 1\end{matrix} ] , \frac{1}{2 \sqrt{3}} [ \begin{matrix}1 & 1 & 0 & 0 \\ 0 & 0 & 0 & 0 \\ 0 & 0 & 1 & 1 \\ j & - j & 0 & 0 \\ 0 & 0 & 0 & 0 \\ 0 & 0 & j & - j\end{matrix} ] \} ,$$

$$where j is \sqrt{- 1} .$$

Aspect 30: The method of Aspect 1, wherein the one or more codebooks are specified as:

$$\{ \frac{1}{2 \sqrt{3}} [ \begin{matrix}1 & 1 & 0 & 0 \\ 1 & - 1 & 0 & 0 \\ 0 & 0 & 1 & 1 \\ 1 & 1 & 0 & 0 \\ 1 & - 1 & 0 & 0 \\ 0 & 0 & 1 & - 1\end{matrix} ] , \frac{1}{2 \sqrt{3}} [ \begin{matrix}1 & 1 & 0 & 0 \\ 0 & - 1 & 0 & 0 \\ 0 & 0 & 1 & 1 \\ j & j & 0 & 0 \\ j & - j & 0 & 0 \\ 0 & 0 & j & - j\end{matrix} ] \} or$$

$$\{ \frac{1}{2 \sqrt{6}} [ \begin{matrix}1 & 1 & 1 & 1 \\ 0 & 0 & 0 & 0 \\ 1 & - 1 & 1 & - 1 \\ 1 & 1 & - 1 & - 1 \\ 0 & 0 & 0 & 0 \\ 1 & - 1 & - 1 & 1\end{matrix} ] , \frac{1}{2 \sqrt{6}} [ \begin{matrix}1 & 1 & 0 & 0 \\ 0 & 0 & 0 & 0 \\ 1 & - 1 & 1 & - 1 \\ j & j & - j & - j \\ 0 & 0 & 0 & 0 \\ j & - j & - j & j\end{matrix} ] \} ,$$

$$where j is \sqrt{- 1} .$$

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A wireless communication device for wireless communication, comprising:
a memory; and
one or more processors, coupled to the memory, configured to:
select a codebook for a multiple-input multiple-output (MIMO) communication from among one or more codebooks that include one or more of non-coherent codebooks for 6 or 8 antennas of the wireless communication device, partially-coherent codebooks for multiple paired antennas of the 6 or 8 antennas of the wireless communication device, or full-coherent codebooks for the 6 or 8 antennas of the wireless communication device; and
transmit or receive the communication using the codebook.

2. The wireless communication device of claim 1, wherein the one or more codebooks are specified as:
$$\frac{1}{2 \sqrt{2}} [ \begin{matrix}1 \\ 0 \\ 0 \\ 0 \\ 0 \\ 0 \\ 0 \\ 0\end{matrix} ] , \frac{1}{2 \sqrt{2}} [ \begin{matrix}0 \\ 0 \\ 1 \\ 0 \\ 0 \\ 0 \\ 0 \\ 0\end{matrix} ] , \frac{1}{2 \sqrt{2}} [ \begin{matrix}0 \\ 0 \\ 0 \\ 0 \\ 1 \\ 0 \\ 0 \\ 0\end{matrix} ] , \frac{1}{2 \sqrt{2}} [ \begin{matrix}0 \\ 0 \\ 0 \\ 0 \\ 0 \\ 0 \\ 1 \\ 0\end{matrix} ] ;$$
$$\frac{1}{2 \sqrt{2}} [ \begin{matrix}1 & 0 \\ 0 & 0 \\ 0 & 1 \\ 0 & 0 \\ 0 & 0 \\ 0 & 0 \\ 0 & 0 \\ 0 & 0\end{matrix} ] , \frac{1}{2 \sqrt{2}} [ \begin{matrix}1 & 0 \\ 0 & 0 \\ 0 & 0 \\ 0 & 0 \\ 0 & 1 \\ 0 & 0 \\ 0 & 0 \\ 0 & 0\end{matrix} ] , \frac{1}{2 \sqrt{2}} [ \begin{matrix}1 & 0 \\ 0 & 0 \\ 0 & 0 \\ 0 & 0 \\ 0 & 0 \\ 0 & 0 \\ 0 & 1 \\ 0 & 0\end{matrix} ] , \\ \frac{1}{2 \sqrt{2}} [ \begin{matrix}0 & 0 \\ 0 & 0 \\ 1 & 0 \\ 0 & 0 \\ 0 & 1 \\ 0 & 0 \\ 0 & 0 \\ 0 & 0\end{matrix} ] , \frac{1}{2 \sqrt{2}} [ \begin{matrix}0 & 0 \\ 0 & 0 \\ 1 & 0 \\ 0 & 0 \\ 0 & 0 \\ 0 & 0 \\ 0 & 1 \\ 0 & 0\end{matrix} ] , \frac{1}{2 \sqrt{2}} [ \begin{matrix}0 & 0 \\ 0 & 0 \\ 0 & 0 \\ 0 & 0 \\ 1 & 0 \\ 0 & 0 \\ 0 & 1 \\ 0 & 0\end{matrix} ] ;$$
$$\frac{1}{2 \sqrt{2}} [ \begin{matrix}1 & 0 & 0 \\ 0 & 0 & 0 \\ 0 & 1 & 0 \\ 0 & 0 & 0 \\ 0 & 0 & 1 \\ 0 & 0 & 0 \\ 0 & 0 & 0 \\ 0 & 0 & 0\end{matrix} ] , \frac{1}{2 \sqrt{2}} [ \begin{matrix}1 & 0 & 0 \\ 0 & 0 & 0 \\ 0 & 1 & 0 \\ 0 & 0 & 0 \\ 0 & 0 & 0 \\ 0 & 0 & 0 \\ 0 & 0 & 1 \\ 0 & 0 & 0\end{matrix} ] , \frac{1}{2 \sqrt{2}} [ \begin{matrix}1 & 0 & 0 \\ 0 & 0 & 0 \\ 0 & 0 & 0 \\ 0 & 0 & 0 \\ 0 & 1 & 0 \\ 0 & 0 & 0 \\ 0 & 0 & 1 \\ 0 & 0 & 0\end{matrix} ] , \frac{1}{2 \sqrt{2}} [ \begin{matrix}0 & 0 & 0 \\ 0 & 0 & 0 \\ 1 & 0 & 0 \\ 0 & 0 & 0 \\ 0 & 1 & 0 \\ 0 & 0 & 0 \\ 0 & 0 & 1 \\ 0 & 0 & 0\end{matrix} ] ; or$$
$$\frac{1}{2 \sqrt{2}} [ \begin{matrix}1 & 0 & 0 & 0 \\ 0 & 0 & 0 & 0 \\ 0 & 1 & 0 & 0 \\ 0 & 0 & 0 & 0 \\ 0 & 0 & 1 & 0 \\ 0 & 0 & 0 & 0 \\ 0 & 0 & 0 & 1 \\ 0 & 0 & 0 & 0\end{matrix} ] .$$

3. The wireless communication device of claim 1, wherein the one or more codebooks are from among codebooks specified as:
$$\frac{1}{2 \sqrt{2}} [ \begin{matrix}1 \\ 0 \\ 0 \\ 0 \\ 1 \\ 0 \\ 0 \\ 0\end{matrix} ] , \frac{1}{2 \sqrt{2}} [ \begin{matrix}1 \\ 0 \\ 0 \\ 0 \\ - 1 \\ 0 \\ 0 \\ 0\end{matrix} ] , \frac{1}{2 \sqrt{2}} [ \begin{matrix}1 \\ 0 \\ 0 \\ 0 \\ j \\ 0 \\ 0 \\ 0\end{matrix} ] , \frac{1}{2 \sqrt{2}} [ \begin{matrix}1 \\ 0 \\ 0 \\ 0 \\ - j \\ 0 \\ 0 \\ 0\end{matrix} ] , \frac{1}{2 \sqrt{2}} [ \begin{matrix}0 \\ 1 \\ 0 \\ 0 \\ 0 \\ 1 \\ 0 \\ 0\end{matrix} ] , \\ \frac{1}{2 \sqrt{2}} [ \begin{matrix}0 \\ 1 \\ 0 \\ 0 \\ 0 \\ - 1 \\ 0 \\ 0\end{matrix} ] , \frac{1}{2 \sqrt{2}} [ \begin{matrix}0 \\ 1 \\ 0 \\ 0 \\ 0 \\ j \\ 0 \\ 0\end{matrix} ] , \frac{1}{2 \sqrt{2}} [ \begin{matrix}0 \\ 1 \\ 0 \\ 0 \\ 0 \\ - j \\ 0 \\ 0\end{matrix} ] , \frac{1}{2 \sqrt{2}} [ \begin{matrix}0 \\ 0 \\ 1 \\ 0 \\ 0 \\ 0 \\ 1 \\ 0\end{matrix} ] , \frac{1}{2 \sqrt{2}} [ \begin{matrix}0 \\ 0 \\ 1 \\ 0 \\ 0 \\ 0 \\ - 1 \\ 0\end{matrix} ] , \\ \frac{1}{2 \sqrt{2}} [ \begin{matrix}0 \\ 0 \\ 1 \\ 0 \\ 0 \\ 0 \\ j \\ 0\end{matrix} ] , \frac{1}{2 \sqrt{2}} [ \begin{matrix}0 \\ 0 \\ 1 \\ 0 \\ 0 \\ 0 \\ - j \\ 0\end{matrix} ] , \frac{1}{2 \sqrt{2}} [ \begin{matrix}0 \\ 0 \\ 0 \\ 1 \\ 0 \\ 0 \\ 0 \\ 1\end{matrix} ] , \frac{1}{2 \sqrt{2}} [ \begin{matrix}0 \\ 0 \\ 0 \\ 1 \\ 0 \\ 0 \\ 0 \\ - 1\end{matrix} ] , \frac{1}{2 \sqrt{2}} [ \begin{matrix}0 \\ 0 \\ 0 \\ 1 \\ 0 \\ 0 \\ 0 \\ j\end{matrix} ] , and \frac{1}{2 \sqrt{2}} [ \begin{matrix}0 \\ 0 \\ 0 \\ 1 \\ 0 \\ 0 \\ 0 \\ - j\end{matrix} ] ,$$
$$where j is \sqrt{- 1} .$$

4. The wireless communication device of claim 1, wherein the one or more codebooks are specified as:
$$\frac{1}{2 \sqrt{2}} [ \begin{matrix}1 & 0 \\ 0 & 0 \\ 0 & 1 \\ 0 & 0 \\ 1 & 0 \\ 0 & 0 \\ 0 & - j \\ 0 & 0\end{matrix} ] , \frac{1}{2 \sqrt{2}} [ \begin{matrix}1 & 0 \\ 0 & 0 \\ 0 & 1 \\ 0 & 0 \\ 1 & 0 \\ 0 & 0 \\ 0 & j \\ 0 & 0\end{matrix} ] , \frac{1}{2 \sqrt{2}} [ \begin{matrix}1 & 0 \\ 0 & 0 \\ 0 & 1 \\ 0 & 0 \\ - j & 0 \\ 0 & 0 \\ 0 & 1 \\ 0 & 0\end{matrix} ] , \frac{1}{2 \sqrt{2}} [ \begin{matrix}1 & 0 \\ 0 & 0 \\ 0 & 1 \\ 0 & 0 \\ - j & 0 \\ 0 & 0 \\ 0 & - 1 \\ 0 & 0\end{matrix} ] , \\ \frac{1}{2 \sqrt{2}} [ \begin{matrix}1 & 0 \\ 0 & 0 \\ 0 & 1 \\ 0 & 0 \\ - 1 & 0 \\ 0 & 0 \\ 0 & - j \\ 0 & 0\end{matrix} ] , \frac{1}{2 \sqrt{2}} [ \begin{matrix}1 & 0 \\ 0 & 0 \\ 0 & 1 \\ 0 & 0 \\ - 1 & 0 \\ 0 & 0 \\ 0 & j \\ 0 & 0\end{matrix} ] , \frac{1}{2 \sqrt{2}} [ \begin{matrix}1 & 0 \\ 0 & 0 \\ 0 & 1 \\ 0 & 0 \\ j & 0 \\ 0 & 0 \\ 0 & 1 \\ 0 & 0\end{matrix} ] , and \frac{1}{2 \sqrt{2}} [ \begin{matrix}1 & 0 \\ 0 & 0 \\ 0 & 1 \\ 0 & 0 \\ j & 0 \\ 0 & 0 \\ 0 & - 1 \\ 0 & 0\end{matrix} ] ,$$
$$where j is \sqrt{- 1} .$$

5. The wireless communication device of claim 1, wherein the one or more codebooks are specified as:
$$\frac{1}{2 \sqrt{2}} [ \begin{matrix}1 \\ 0 \\ 1 \\ 0 \\ 1 \\ 0 \\ 1 \\ 0\end{matrix} ] , \frac{1}{2 \sqrt{2}} [ \begin{matrix}1 \\ 0 \\ 1 \\ 0 \\ j \\ 0 \\ j \\ 0\end{matrix} ] , \frac{1}{2 \sqrt{2}} [ \begin{matrix}1 \\ 0 \\ 1 \\ \begin{matrix}0 \\ - 1 \\ 0 \\ - 1 \\ 0\end{matrix}\end{matrix} ] , \frac{1}{2 \sqrt{2}} [ \begin{matrix}1 \\ 0 \\ 1 \\ 0 \\ - j \\ 0 \\ - j \\ 0\end{matrix} ] , \frac{1}{2 \sqrt{2}} [ \begin{matrix}1 \\ 0 \\ j \\ 0 \\ 1 \\ 0 \\ j \\ 0\end{matrix} ] , \\ \frac{1}{2 \sqrt{2}} [ \begin{matrix}1 \\ 0 \\ j \\ 0 \\ j \\ \begin{matrix}0 \\ - 1 \\ 0\end{matrix}\end{matrix} ] , \frac{1}{2 \sqrt{2}} [ \begin{matrix}1 \\ 0 \\ j \\ 0 \\ - 1 \\ 0 \\ - j \\ 0\end{matrix} ] , \frac{1}{2 \sqrt{2}} [ \begin{matrix}1 \\ 0 \\ j \\ 0 \\ - j \\ 0 \\ 1 \\ 0\end{matrix} ] , \frac{1}{2 \sqrt{2}} [ \begin{matrix}1 \\ 0 \\ - 1 \\ 0 \\ 1 \\ 0 \\ - 1 \\ 0\end{matrix} ] , \frac{1}{2 \sqrt{2}} [ \begin{matrix}1 \\ \begin{matrix}0 \\ - 1 \\ 0\end{matrix} \\ j \\ 0 \\ - j \\ 0\end{matrix} ] , \\ \frac{1}{2 \sqrt{2}} [ \begin{matrix}1 \\ \begin{matrix}0 \\ - 1 \\ 0 \\ - 1 \\ 0\end{matrix} \\ 1 \\ 0\end{matrix} ] , \frac{1}{2 \sqrt{2}} [ \begin{matrix}1 \\ 0 \\ - 1 \\ 0 \\ - j \\ 0 \\ j \\ 0\end{matrix} ] , \frac{1}{2 \sqrt{2}} [ \begin{matrix}1 \\ 0 \\ - j \\ 0 \\ 1 \\ 0 \\ - j \\ 0\end{matrix} ] , \frac{1}{2 \sqrt{2}} [ \begin{matrix}1 \\ 0 \\ - j \\ 0 \\ j \\ 0 \\ 1 \\ 0\end{matrix} ] , \frac{1}{2 \sqrt{2}} [ \begin{matrix}1 \\ 0 \\ - j \\ 0 \\ - 1 \\ 0 \\ j \\ 0\end{matrix} ] , and$$
$$\frac{1}{2 \sqrt{2}} [ \begin{matrix}1 \\ 0 \\ - j \\ 0 \\ - j \\ 0 \\ - 1 \\ 0\end{matrix} ] , where j is \sqrt{- 1} .$$

6. The wireless communication device of claim 1, wherein the one or more codebooks are specified as:
$$\frac{1}{2 \sqrt{2}} [ \begin{matrix}1 & 0 \\ 1 & 0 \\ 0 & 1 \\ 0 & 1 \\ 1 & 0 \\ 1 & 0 \\ 0 & - 1 \\ 0 & - 1\end{matrix} ] , \frac{1}{2 \sqrt{2}} [ \begin{matrix}1 & 0 \\ 1 & 0 \\ 0 & 1 \\ 0 & 1 \\ j & 0 \\ j & 0 \\ 0 & - j \\ 0 & - j\end{matrix} ] , \frac{1}{2 \sqrt{2}} [ \begin{matrix}1 & 0 \\ j & 0 \\ 0 & 1 \\ 0 & 1 \\ 1 & 0 \\ j & 0 \\ 0 & - 1 \\ 0 & - j\end{matrix} ] , \frac{1}{2 \sqrt{2}} [ \begin{matrix}1 & 0 \\ j & 0 \\ 0 & 1 \\ 0 & j \\ j & 0 \\ - 1 & 0 \\ 0 & - j \\ 0 & 1\end{matrix} ] , \\ \frac{1}{2 \sqrt{2}} [ \begin{matrix}1 & 0 \\ - 1 & 0 \\ 0 & 1 \\ 0 & - 1 \\ 1 & 0 \\ - 1 & 0 \\ 0 & - 1 \\ 0 & 1\end{matrix} ] , \frac{1}{2 \sqrt{2}} [ \begin{matrix}1 & 0 \\ - 1 & 0 \\ 0 & 1 \\ 0 & - 1 \\ j & 0 \\ - j & 0 \\ 0 & - j \\ 0 & j\end{matrix} ] , \frac{1}{2 \sqrt{2}} [ \begin{matrix}1 & 0 \\ ‐ j & 0 \\ 0 & 1 \\ 0 & - j \\ 1 & 0 \\ ‐ j & 0 \\ 0 & - 1 \\ 0 & j\end{matrix} ] , and \frac{1}{2 \sqrt{2}} [ \begin{matrix}1 & 0 \\ - j & 0 \\ 0 & 1 \\ 0 & - j \\ j & 0 \\ 1 & 0 \\ 0 & - j \\ 0 & - 1\end{matrix} ] ,$$
$$where j is \sqrt{- 1} ;$$
$$\frac{1}{2 \sqrt{2}} [ \begin{matrix}1 & 0 \\ 0 & 1 \\ 1 & 0 \\ 0 & 1 \\ 1 & 0 \\ 0 & - 1 \\ 1 & 0 \\ 0 & - 1\end{matrix} ] , \frac{1}{2 \sqrt{2}} [ \begin{matrix}1 & 0 \\ 0 & 1 \\ 1 & 0 \\ 0 & 1 \\ j & 0 \\ 0 & - j \\ j & 0 \\ 0 & - j\end{matrix} ] , \frac{1}{2 \sqrt{2}} [ \begin{matrix}1 & 0 \\ 0 & 1 \\ j & 0 \\ 0 & j \\ 1 & 0 \\ 0 & - 1 \\ j & 0 \\ 0 & - j\end{matrix} ] , \frac{1}{2 \sqrt{2}} [ \begin{matrix}1 & 0 \\ 0 & 1 \\ j & 0 \\ 0 & j \\ j & 0 \\ 0 & - j \\ - 1 & 0 \\ 0 & 1\end{matrix} ] , \\ \frac{1}{2 \sqrt{2}} [ \begin{matrix}1 & 0 \\ 0 & 1 \\ - 1 & 0 \\ 0 & - 1 \\ 1 & 0 \\ 0 & - 1 \\ - 1 & 0 \\ 0 & 1\end{matrix} ] , \frac{1}{2 \sqrt{2}} [ \begin{matrix}1 & 0 \\ 0 & 1 \\ - 1 & 0 \\ 0 & - 1 \\ j & 0 \\ 0 & - j \\ - j & 0 \\ 0 & j\end{matrix} ] , \frac{1}{2 \sqrt{2}} [ \begin{matrix}1 & 0 \\ 0 & 1 \\ - j & 0 \\ 0 & - j \\ 1 & 0 \\ 0 & - 1 \\ - j & 0 \\ 0 & j\end{matrix} ] , and$$
$$\frac{1}{2 \sqrt{2}} [ \begin{matrix}1 & 0 \\ 0 & 1 \\ - j & 0 \\ 0 & - j \\ j & 0 \\ 0 & - j \\ 1 & 0 \\ 0 & - 1\end{matrix} ] ; or$$
$$\frac{1}{4} [ \begin{matrix}1 & 1 \\ 0 & 0 \\ 1 & 1 \\ 0 & 0 \\ 1 & - 1 \\ 0 & 0 \\ 1 & - 1 \\ 0 & 0\end{matrix} ] , \frac{1}{4} [ \begin{matrix}1 & 1 \\ 0 & 0 \\ 1 & 1 \\ 0 & 0 \\ j & - j \\ 0 & 0 \\ j & - j \\ 0 & 0\end{matrix} ] , \frac{1}{4} [ \begin{matrix}1 & 1 \\ 0 & 0 \\ j & j \\ 0 & 0 \\ 1 & - 1 \\ 0 & 0 \\ j & - j \\ 0 & 0\end{matrix} ] , \frac{1}{4} [ \begin{matrix}1 & 1 \\ 0 & 0 \\ j & j \\ 0 & 0 \\ j & - j \\ 0 & 0 \\ - 1 & 1 \\ 0 & 0\end{matrix} ] , \\ \frac{1}{4} [ \begin{matrix}1 & 1 \\ 0 & 0 \\ - 1 & - 1 \\ 0 & 0 \\ 1 & - 1 \\ 0 & 0 \\ - 1 & 1 \\ 0 & 0\end{matrix} ] , \frac{1}{4} [ \begin{matrix}1 & 1 \\ 0 & 0 \\ - 1 & 1 \\ 0 & 0 \\ j & - j \\ 0 & 0 \\ - j & j \\ 0 & 0\end{matrix} ] , \frac{1}{4} [ \begin{matrix}1 & 1 \\ 0 & 0 \\ - j & - j \\ 0 & 0 \\ 1 & - 1 \\ 0 & 0 \\ - j & j \\ 0 & 0\end{matrix} ] , and \frac{1}{4} [ \begin{matrix}1 & 1 \\ 0 & 0 \\ - j & - j \\ 0 & 0 \\ j & - j \\ 0 & 0 \\ 1 & - 1 \\ 0 & 0\end{matrix} ] .$$

7. The wireless communication device of claim 1, wherein the codebook is specified as:
$$\frac{1}{\sqrt{8}} [ \begin{matrix}[ \begin{matrix}1 \\ {e}^{j π {i}_{1} / 4} \\ {e}^{j 2 π {i}_{1} / 4} \\ {e}^{j 3 π {i}_{1} / 4}\end{matrix} ] \\ {e}^{j π {i}_{2} / 2} [ \begin{matrix}1 \\ {e}^{j π {i}_{1} / 4} \\ {e}^{j 2 π {i}_{1} / 4} \\ {e}^{j 3 π {i}_{1} / 4}\end{matrix} ]\end{matrix} ] ,$$
$$where j is \sqrt{- 1} ,$$
$$where {i}_{1} = 0 , … , 7 , and$$
$$where {i}_{2} = 0 , 1 , 2 , 3 or$$
$${i}_{2} = 0 , 2 ; or$$
$$\{ \frac{1}{4} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1 , 1}}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & - {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ]\end{matrix} ] \} ,$$
$$where {i}_{1} = 0 , … , 7 and$$
$$where {i}_{2} = 0 , 1 .$$

8. The wireless communication device of claim 1, wherein the one or more codebooks are associated with a codebook W specified as
$$W = \frac{1}{\sqrt{8}} [ \begin{matrix}{W}_{4} \\ φ {W}_{4}\end{matrix} ] ,$$
where co-phasing parameter φ∈{1,j,−1,−j} or {1, −1}, and W₄ includes one or more codebooks from among:
$$[ \text{} \begin{matrix}1 \\ 1 \\ 1 \\ 1\end{matrix} ] , [ \text{} \begin{matrix}1 \\ j \\ - 1 \\ - j\end{matrix} ] , [ \text{} \begin{matrix}1 \\ - 1 \\ 1 \\ - 1\end{matrix} ] , [ \text{} \begin{matrix}1 \\ - j \\ - 1 \\ j\end{matrix} ] , [ \text{} \begin{matrix}1 \\ \frac{1 + j}{\sqrt{2}} \\ j \\ \frac{- 1 + j}{\sqrt{2}}\end{matrix} ] , [ \begin{matrix}1 \\ \frac{1 + j}{\sqrt{2}} \\ - j \\ \frac{1 + j}{\sqrt{2}}\end{matrix} ] , [ \text{} \begin{matrix}1 \\ \frac{- 1 - j}{\sqrt{2}} \\ j \\ \frac{1 - j}{\sqrt{2}}\end{matrix} ] , [ \text{} \begin{matrix}1 \\ \frac{1 - j}{\sqrt{2}} \\ - j \\ \frac{- 1 - j}{\sqrt{2}}\end{matrix} ] ,$$
$$[ \text{} \begin{matrix}1 \\ 1 \\ - 1 \\ 1\end{matrix} ] \text{} , [ \begin{matrix}1 \\ j \\ 1 \\ j\end{matrix} ] , [ \begin{matrix}1 \\ - 1 \\ - 1 \\ 1\end{matrix} ] , [ \begin{matrix}1 \\ - j \\ 1 \\ - j\end{matrix} ] , [ \begin{matrix}1 \\ 1 \\ 1 \\ - 1\end{matrix} ] , [ \begin{matrix}1 \\ 1 \\ - 1 \\ 1\end{matrix} ] , [ \begin{matrix}1 \\ - 1 \\ 1 \\ 1\end{matrix} ] , and [ \begin{matrix}1 \\ - 1 \\ - 1 \\ - 1\end{matrix} ] ,$$
$$where j is \sqrt{- 1} ;$$
$$\frac{1}{2} [ \begin{matrix}1 \\ 1 \\ 1 \\ - 1\end{matrix} ] , \frac{1}{2} [ \begin{matrix}1 \\ 1 \\ j \\ j\end{matrix} ] , \frac{1}{2} [ \begin{matrix}1 \\ 1 \\ - 1 \\ 1\end{matrix} ] , \frac{1}{2} [ \begin{matrix}1 \\ 1 \\ - j \\ - j\end{matrix} ] , \frac{1}{2} [ \begin{matrix}1 \\ j \\ 1 \\ j\end{matrix} ] , \frac{1}{2} [ \begin{matrix}1 \\ j \\ j \\ 1\end{matrix} ] , \frac{1}{2} [ \begin{matrix}1 \\ j \\ - 1 \\ - j\end{matrix} ] , \frac{1}{2} [ \begin{matrix}1 \\ j \\ - j \\ - 1\end{matrix} ] ,$$
$$\frac{1}{2} [ \begin{matrix}1 \\ - 1 \\ 1 \\ 1\end{matrix} ] , \frac{1}{2} [ \begin{matrix}1 \\ - 1 \\ j \\ - j\end{matrix} ] , \frac{1}{2} [ \begin{matrix}1 \\ - 1 \\ - 1 \\ - 1\end{matrix} ] , \frac{1}{2} [ \begin{matrix}1 \\ - 1 \\ - j \\ j\end{matrix} ] , \frac{1}{2} [ \begin{matrix}1 \\ - j \\ j \\ - 1\end{matrix} ] , \frac{1}{2} [ \begin{matrix}1 \\ - j \\ j \\ - 1\end{matrix} ] , \frac{1}{2} [ \begin{matrix}1 \\ - j \\ - 1 \\ j\end{matrix} ] , and$$
$$\frac{1}{2} [ \begin{matrix}1 \\ - j \\ - j \\ 1\end{matrix} ] ; [ \begin{matrix}1 & 1 \\ 1 & - 1 \\ 1 & - 1 \\ 1 & 1\end{matrix} ] , [ \begin{matrix}1 & - j \\ j & 1 \\ - 1 & - j \\ - j & 1\end{matrix} ] , [ \begin{matrix}1 & - 1 \\ - 1 & 1 \\ 1 & 1 \\ - 1 & - 1\end{matrix} ] , [ \text{} \begin{matrix}1 & j \\ - 1 & 1 \\ - 1 & j \\ j & 1\end{matrix} ] , [ \begin{matrix}1 \frac{- 1 - j}{\sqrt{2}} \\ \frac{1 + j}{\sqrt{2}} j \\ j \frac{- 1 + j}{\sqrt{2}} \\ \frac{- 1 + j}{\sqrt{2}} 1\end{matrix} ] ,$$
$$[ \begin{matrix}1 \frac{1 - j}{\sqrt{2}} \\ \frac{- 1 + j}{\sqrt{2}} - j \\ - j \frac{1 + j}{\sqrt{2}} \\ \frac{1 + j}{\sqrt{2}} 1\end{matrix} ] , [ \begin{matrix}1 & - j \\ \frac{- 1 - j}{\sqrt{2}} & \frac{1 - j}{\sqrt{2}} \\ j & 1 \\ \frac{1 - j}{\sqrt{2}} & \frac{1 + j}{\sqrt{2}}\end{matrix} ] , [ \begin{matrix}1 & j \\ \frac{1 - j}{\sqrt{2}} & \frac{- 1 - j}{\sqrt{2}} \\ - j & 1 \\ \frac{- 1 - j}{\sqrt{2}} & \frac{- 1 + j}{\sqrt{2}}\end{matrix} ] , [ \begin{matrix}1 & 1 \\ 1 & 1 \\ - 1 & 1 \\ - 1 & 1\end{matrix} ] ,$$
$$[ \begin{matrix}1 & - j \\ j & - 1 \\ 1 & j \\ j & 1\end{matrix} ] , [ \begin{matrix}1 & - 1 \\ - 1 & - 1 \\ - 1 & 1 \\ 1 & 1\end{matrix} ] , [ \begin{matrix}1 & 1 \\ - j & j \\ 1 & 1 \\ - j & j\end{matrix} ] , [ \begin{matrix}1 & 1 \\ 1 & 1 \\ 1 & - 1 \\ - 1 & 1\end{matrix} ] , [ \begin{matrix}1 & - 1 \\ 1 & 1 \\ - 1 & 1 \\ 1 & 1\end{matrix} ] , [ \begin{matrix}1 & 1 \\ - 1 & 1 \\ 1 & 1 \\ 1 & - 1\end{matrix} ] , and$$
$$[ \begin{matrix}1 & - 1 \\ - 1 & 1 \\ - 1 & - 1 \\ - 1 & - 1\end{matrix} ] ; [ \begin{matrix}1 & 1 & 1 \\ 1 & 1 & - 1 \\ 1 & - 1 & - 1 \\ 1 & - 1 & 1\end{matrix} ] , [ \begin{matrix}1 & - j & - 1 \\ j & 1 & j \\ - 1 & j & 1 \\ - j & 1 & - j\end{matrix} ] , [ \begin{matrix}1 & - 1 & 1 \\ - 1 & 1 & 1 \\ 1 & 1 & 1 \\ - 1 & - 1 & 1\end{matrix} ] , [ \begin{matrix}1 & j & - 1 \\ - j & 1 & - j \\ - 1 & j & 1 \\ j & 1 & j\end{matrix} ] ,$$
$$[ \begin{matrix}1 \frac{1 - j}{\sqrt{2}} \frac{- 1 - j}{\sqrt{2}} \\ \frac{1 + j}{\sqrt{2}} 1 j \\ j \frac{- 1 - j}{\sqrt{2}} \frac{- 1 + j}{\sqrt{2}} \\ \frac{- 1 + j}{\sqrt{2}} - j 1\end{matrix} ] , [ \begin{matrix}1 \frac{- 1 - j}{\sqrt{2}} \frac{1 - j}{\sqrt{2}} \\ \frac{- 1 + j}{\sqrt{2}} 1 - j \\ - j \frac{1 - j}{\sqrt{2}} \frac{1 + j}{\sqrt{2}} \\ \frac{1 + j}{\sqrt{2}} j 1\end{matrix} ] , [ \begin{matrix}1 - j \frac{1 + j}{\sqrt{2}} \\ \frac{- 1 - j}{\sqrt{2}} \frac{1 - j}{\sqrt{2}} j \\ j 1 \frac{1 - j}{\sqrt{2}} \\ \frac{1 - j}{\sqrt{2}} \frac{1 + j}{\sqrt{2}} 1\end{matrix} ] ,$$
$$[ \begin{matrix}1 j \frac{- 1 + j}{\sqrt{2}} \\ \frac{1 - j}{\sqrt{2}} \frac{- 1 - j}{\sqrt{2}} - j \\ - j 1 \frac{- 1 - j}{\sqrt{2}} \\ \frac{- 1 - j}{\sqrt{2}} \frac{- 1 + j}{\sqrt{2}} 1\end{matrix} ] , [ \begin{matrix}1 & 1 & - 1 \\ 1 & 1 & 1 \\ - 1 & 1 & - 1 \\ - 1 & 1 & 1\end{matrix} ] , [ \begin{matrix}1 & 1 & - j \\ j & - j & - 1 \\ 1 & 1 & j \\ j & - j & 1\end{matrix} ] , [ \begin{matrix}1 & - 1 & - 1 \\ - 1 & 1 & - 1 \\ - 1 & - 1 & 1 \\ 1 & 1 & 1\end{matrix} ] ,$$
$$[ \begin{matrix}1 & 1 & j \\ - j & j & - 1 \\ 1 & 1 & - j \\ - j & j & 1\end{matrix} ] , [ \begin{matrix}1 & 1 & 1 \\ 1 & 1 & - 1 \\ 1 & - 1 & 1 \\ - 1 & 1 & 1\end{matrix} ] , [ \begin{matrix}1 & 1 & - 1 \\ 1 & 1 & 1 \\ - 1 & 1 & 1 \\ 1 & - 1 & 1\end{matrix} ] ,$$
$$[ \begin{matrix}1 & - 1 & 1 \\ - 1 & 1 & 1 \\ 1 & 1 & 1 \\ 1 & 1 & - 1\end{matrix} ] , and [ \begin{matrix}1 & - 1 & - 1 \\ - 1 & 1 & - 1 \\ - 1 & - 1 & 1 \\ - 1 & - 1 & - 1\end{matrix} ] ; or$$
$$[ \begin{matrix}1 & 1 & 1 & 1 \\ 1 & 1 & - 1 & - 1 \\ 1 & - 1 & 1 & - 1 \\ 1 & - 1 & - 1 & 1\end{matrix} ] , [ \begin{matrix}1 & - j & - 1 & j \\ j & 1 & j & 1 \\ - 1 & - j & 1 & j \\ - j & 1 & - j & 1\end{matrix} ] , [ \begin{matrix}1 & - 1 & 1 & - 1 \\ - 1 & 1 & 1 & - 1 \\ 1 & 1 & 1 & 1 \\ - 1 & - 1 & 1 & 1\end{matrix} ] ,$$
$$[ \begin{matrix}1 & j & - 1 & - j \\ - j & 1 & - j & 1 \\ - 1 & j & 1 & - j \\ j & 1 & j & 1\end{matrix} ] , [ \begin{matrix}1 \frac{1 - j}{\sqrt{2}} - j \frac{- 1 - j}{\sqrt{2}} \\ \frac{1 + j}{\sqrt{2}} 1 \frac{- 1 + j}{\sqrt{2}} j \\ j \frac{- 1 - j}{\sqrt{2}} 1 \frac{- 1 + j}{\sqrt{2}} \\ \frac{- 1 + j}{\sqrt{2}} - j \frac{- 1 - j}{\sqrt{2}} 1\end{matrix} ] , [ \begin{matrix}1 \frac{- 1 - j}{\sqrt{2}} j \frac{1 - j}{\sqrt{2}} \\ \frac{- 1 + j}{\sqrt{2}} 1 \frac{1 + j}{\sqrt{2}} - j \\ - j \frac{1 - j}{\sqrt{2}} 1 \frac{1 + j}{\sqrt{2}} \\ \frac{1 + j}{\sqrt{2}} j \frac{1 - j}{\sqrt{2}} 1\end{matrix} ] ,$$
$$[ \begin{matrix}1 - j \frac{- 1 + j}{\sqrt{2}} \frac{1 + j}{\sqrt{2}} \\ \frac{- 1 - j}{\sqrt{2}} \frac{1 - j}{\sqrt{2}} 1 j \\ j 1 \frac{1 + j}{\sqrt{2}} \frac{1 - j}{\sqrt{2}} \\ \frac{1 - j}{\sqrt{2}} \frac{1 + j}{\sqrt{2}} - j 1\end{matrix} ] , [ \begin{matrix}1 j \frac{1 + j}{\sqrt{2}} \frac{- 1 + j}{\sqrt{2}} \\ \frac{1 - j}{\sqrt{2}} \frac{- 1 - j}{\sqrt{2}} 1 - j \\ - j 1 \frac{- 1 + j}{\sqrt{2}} \frac{- 1 - j}{\sqrt{2}} \\ \frac{- 1 - j}{\sqrt{2}} \frac{- 1 + j}{\sqrt{2}} j 1\end{matrix} ] , [ \begin{matrix}1 & 1 & - 1 & - 1 \\ 1 & 1 & 1 & 1 \\ - 1 & 1 & 1 & - 1 \\ - 1 & 1 & - 1 & 1\end{matrix} ] ,$$
$$[ \begin{matrix}1 & - j & 1 & - j \\ j & 1 & - j & - 1 \\ 1 & j & 1 & j \\ j & - 1 & - j & 1\end{matrix} ] , [ \begin{matrix}1 & - 1 & - 1 & 1 \\ - 1 & - 1 & 1 & 1 \\ - 1 & 1 & - 1 & 1 \\ 1 & 1 & 1 & 1\end{matrix} ] , [ \begin{matrix}1 & 1 & j & j \\ - j & j & 1 & - 1 \\ 1 & 1 & - j & - j \\ - j & j & - 1 & 1\end{matrix} ] ,$$
$$[ \begin{matrix}1 & 1 & 1 & - 1 \\ 1 & 1 & - 1 & 1 \\ 1 & - 1 & 1 & 1 \\ - 1 & 1 & 1 & 1\end{matrix} ] , [ \begin{matrix}1 & - 1 & 1 & 1 \\ 1 & 1 & 1 & - 1 \\ - 1 & 1 & 1 & 1 \\ 1 & 1 & - 1 & 1\end{matrix} ] , [ \begin{matrix}1 & - 1 & 1 & 1 \\ 1 & 1 & - 1 & 1 \\ 1 & 1 & 1 & - 1 \\ - 1 & 1 & 1 & 1\end{matrix} ] , and$$
$$[ \begin{matrix}1 & - 1 & - 1 & - 1 \\ - 1 & 1 & - 1 & - 1 \\ - 1 & - 1 & 1 & - 1 \\ - 1 & - 1 & - 1 & 1\end{matrix} ] .$$

9. The wireless communication device of claim 1, wherein the wireless communication device is configured with 8 antennas for the communication, and wherein the one or more processors are configured to transmit or receive a transmit precoding matrix indicator field that indicates one of 12 precoding matrices for use with 1 antenna, one of 20 precoding matrices for use with 2 antennas, one of 30 precoding matrices for use with 4 antennas, or one of 64 precoding matrices for use with 8 antennas.

10. The wireless communication device of claim 1, wherein the wireless communication device is configured with 8 antennas for the communication, and wherein the one or more processors are configured to transmit or receive a transmit precoding matrix indicator field that indicates one of 27 precoding matrices for use with 1 antenna, one of 36 precoding matrices for use with 2 antennas, one of 30 precoding matrices for use with 4 antennas, or one of 64 precoding matrices for use with 8 antennas.

11. The wireless communication device of claim 1, wherein the wireless communication device is configured with 8 antennas for the communication, and wherein the one or more processors are configured to transmit or receive a transmit precoding matrix indicator field that indicates one of 27 precoding matrices for use with 1 antenna, one of 36 precoding matrices for use with 2 antennas, one of 58 precoding matrices for use with 4 antennas, or one of 64 precoding matrices for use with 8 antennas.

12. The wireless communication device of claim 1, wherein the wireless communication device is configured with 8 antennas for the communication, and wherein the one or more processors are configured to transmit or receive a transmit precoding matrix indicator field that includes 4 bits to indicate a precoder for use with 1 antenna, 5 bits to indicate a precoder for use with 2 antennas, 6 bits to indicate a precoder for use with 4 antennas, or 7 bits to indicate a precoder for use with 8 antennas.

13. The wireless communication device of claim 1, wherein the wireless communication device is configured with 8 antennas for the communication, and wherein the one or more processors are configured to transmit or receive a transmit precoding matrix indicator field that indicates one of 12 precoding matrices for use with 1 antenna, one of 52 precoding matrices for use with 2 antennas or 4 antennas, or one of 64 precoding matrices for use with 8 antennas.

14. The wireless communication device of claim 1, wherein the one or more codebooks include codebooks specified as:
$$\frac{1}{2 \sqrt{2}} [ \begin{matrix}1 & 0 & 0 & 0 \\ 0 & 1 & 0 & 0 \\ 1 & 0 & 0 & 0 \\ 0 & 0 & 1 & 0 \\ 1 & 0 & 0 & 0 \\ 0 & - 1 & 0 & 0 \\ 1 & 0 & 0 & 0 \\ 0 & 0 & 0 & 1\end{matrix} ] and \frac{1}{2 \sqrt{2}} [ \begin{matrix}1 & 0 & 0 & 0 \\ 0 & 1 & 0 & 0 \\ 1 & 0 & 0 & 0 \\ 0 & 0 & 1 & 0 \\ j & 0 & 0 & 0 \\ 0 & - j & 0 & 0 \\ j & 0 & 0 & 0 \\ 0 & 0 & 0 & 1\end{matrix} ] ,$$
$$where j is \sqrt{- 1} ; or$$
$$\frac{1}{2 \sqrt{2}} [ \begin{matrix}1 & 0 & 0 & 0 \\ 0 & 1 & 0 & 0 \\ 0 & 0 & 1 & 0 \\ 0 & 0 & 1 & 1 \\ 1 & 0 & 0 & 0 \\ 0 & - 1 & 0 & 0 \\ 0 & 0 & 1 & 0 \\ 0 & 0 & 0 & - 1\end{matrix} ] and \frac{1}{2 \sqrt{2}} [ \begin{matrix}1 & 0 & 0 & 0 \\ 0 & 1 & 0 & 0 \\ 0 & 0 & 1 & 0 \\ 0 & 0 & 0 & 1 \\ j & 0 & 0 & 0 \\ 0 & - j & 0 & 0 \\ 0 & 0 & j & 0 \\ 0 & 0 & 0 & - j\end{matrix} ] .$$

15. The wireless communication device of claim 1, wherein the one or more codebooks include codebooks specified as:
$$\frac{1}{2 \sqrt{2}} [ \begin{matrix}1 & 0 & 0 \\ 0 & 1 & 0 \\ 0 & 0 & 1 \\ 0 & 0 & 0 \\ 1 & 0 & 0 \\ 0 & j & 0 \\ 0 & 0 & - 1 \\ 0 & 0 & 0\end{matrix} ] , \frac{1}{2 \sqrt{2}} [ \begin{matrix}1 & 0 & 0 \\ 0 & 1 & 0 \\ 0 & 0 & 1 \\ 0 & 0 & 0 \\ j & 0 & 0 \\ 0 & - 1 & 0 \\ 0 & 0 & - j \\ 0 & 0 & 0\end{matrix} ] , \frac{1}{2 \sqrt{2}} [ \begin{matrix}1 & 0 & 0 \\ 0 & 1 & 0 \\ 0 & 0 & 1 \\ 0 & 0 & 0 \\ - 1 & 0 & 0 \\ 0 & - j & 0 \\ 0 & 0 & 1 \\ 0 & 0 & 0\end{matrix} ] , and$$
$$\frac{1}{2 \sqrt{2}} [ \begin{matrix}1 & 0 & 0 \\ 0 & 1 & 0 \\ 0 & 0 & 1 \\ 0 & 0 & 0 \\ - j & 0 & 0 \\ 0 & 1 & 0 \\ 0 & 0 & j \\ 0 & 0 & 0\end{matrix} ] , where j is \sqrt{- 1} ; or$$
$$\frac{1}{2 \sqrt{2}} [ \begin{matrix}1 & 0 & 0 \\ 0 & 0 & 0 \\ 0 & 1 & 0 \\ 0 & 0 & 0 \\ 1 & 0 & 0 \\ 0 & 0 & 0 \\ 0 & 0 & 1 \\ 0 & 0 & 0\end{matrix} ] and \frac{1}{2 \sqrt{2}} [ \begin{matrix}1 & 0 & 0 \\ 0 & 0 & 0 \\ 0 & 1 & 0 \\ 0 & 0 & 0 \\ - 1 & 0 & 0 \\ 0 & 0 & 0 \\ 0 & 0 & 1 \\ 0 & 0 & 0\end{matrix} ] .$$

16. The wireless communication device of claim 1, wherein the one or more codebooks are specified as:
$$\frac{1}{2 √ 2} [ \begin{matrix}1 & 0 & 0 \\ 0 & 1 & 0 \\ 1 & 0 & 0 \\ 0 & 0 & 1 \\ 1 & 0 & 0 \\ 0 & - 1 & 0 \\ 1 & 0 & 0 \\ 0 & 0 & - 1\end{matrix} ] , \frac{1}{2 √ 2} [ \begin{matrix}1 & 0 & 0 \\ 0 & 1 & 0 \\ 1 & 0 & 0 \\ 0 & 0 & 1 \\ j & 0 & 0 \\ 0 & - j & 0 \\ j & 0 & 0 \\ 0 & 0 & - j\end{matrix} ] , \frac{1}{2 √ 2} [ \begin{matrix}1 & 0 & 0 \\ 0 & 1 & 0 \\ - 1 & 0 & 0 \\ 0 & 0 & - 1 \\ 1 & 0 & 0 \\ 0 & - 1 & 0 \\ - 1 & 0 & 0 \\ 0 & 0 & 1\end{matrix} ] , and \frac{1}{2 √ 2} [ \begin{matrix}1 & 0 & 0 \\ 0 & 1 & 0 \\ - 1 & 0 & 0 \\ 0 & 0 & - 1 \\ j & 0 & 0 \\ 0 & - j & 0 \\ - j & 0 & 0 \\ 0 & 0 & j\end{matrix} ] , where j is \sqrt{- 1} .$$

17. The wireless communication device of claim 1, wherein the one or more codebooks are specified as:
$$\frac{1}{2 √ 6} [ \begin{matrix}1 & 1 & 1 \\ 0 & 0 & 0 \\ 1 & - 1 & 1 \\ 0 & 0 & 0 \\ 1 & 1 & - 1 \\ 0 & 0 & 0 \\ 1 & - 1 & - 1 \\ 0 & 0 & 0\end{matrix} ] , \frac{1}{2 √ 6} [ \begin{matrix}1 & 1 & 1 \\ 0 & 0 & 0 \\ 1 & - 1 & 1 \\ 0 & 0 & 0 \\ j & j & - j \\ 0 & 0 & 0 \\ 1 & - j & - j \\ 0 & 0 & 0\end{matrix} ] , \frac{1}{2 √ 6} [ \begin{matrix}1 & 1 & 1 \\ 0 & 0 & 0 \\ - 1 & 1 & - 1 \\ 0 & 0 & 0 \\ 1 & 1 & - 1 \\ 0 & 0 & 0 \\ - 1 & 1 & 1 \\ 0 & 0 & 0\end{matrix} ] , and \frac{1}{2 √ 6} [ \begin{matrix}1 & 1 & 1 \\ 0 & 0 & 0 \\ 1 & - 1 & 1 \\ 0 & 0 & 0 \\ j & j & - j \\ 0 & 0 & 0 \\ 1 & - j & - j \\ 0 & 0 & 0\end{matrix} ] , where j is \sqrt{- 1} .$$

18. The wireless communication device of claim 1, wherein the one or more codebooks are specified as:
$$\{ \frac{1}{2 √ 6} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & - {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ]\end{matrix} ] \} ,$$
$$where j is \sqrt{- 1} , where {i}_{1} = 0 , … , 7 , and where {i}_{2} = 0 , 1 ; or$$
$$\frac{1}{2 √ 6} [ \begin{matrix}1 & 1 & 1 \\ 1 & j & 1 \\ 1 & - 1 & 1 \\ 1 & - j & 1 \\ 1 & 1 & - 1 \\ 1 & j & - 1 \\ 1 & - 1 & - 1 \\ 1 & - j & - 1\end{matrix} ] , \frac{1}{2 √ 6} [ \begin{matrix}1 & 1 & 1 \\ 1 & j & 1 \\ 1 & - 1 & 1 \\ 1 & - j & 1 \\ j & j & - j \\ j & - 1 & - j \\ j & - j & - j \\ j & 1 & - j\end{matrix} ] , \frac{1}{2 √ 6} [ \begin{matrix}1 & 1 & 1 \\ j & - 1 & j \\ - 1 & 1 & - 1 \\ - j & - 1 & - j \\ 1 & 1 & - 1 \\ j & - 1 & - j \\ - 1 & 1 & 1 \\ - j & - 1 & j\end{matrix} ] , \frac{1}{2 √ 6} [ \begin{matrix}1 & 1 & 1 \\ j & - 1 & j \\ - 1 & 1 & - 1 \\ - j & - 1 & - j \\ j & j & - j \\ - 1 & - j & 1 \\ - j & j & j \\ 1 & - j & - 1\end{matrix} ] , \frac{1}{2 √ 6} [ \begin{matrix}1 & 1 & 1 \\ - 1 & - j & - 1 \\ 1 & - 1 & 1 \\ - 1 & j & - 1 \\ 1 & 1 & - 1 \\ - 1 & - j & 1 \\ 1 & - 1 & - 1 \\ - 1 & j & 1\end{matrix} ] , \frac{1}{2 √ 6} [ \begin{matrix}1 & 1 & 1 \\ - 1 & - j & - 1 \\ 1 & - 1 & 1 \\ - 1 & j & - 1 \\ j & j & - j \\ - j & 1 & j \\ j & - j & - j \\ - j & - 1 & j\end{matrix} ] , \frac{1}{2 √ 6} [ \begin{matrix}1 & 1 & 1 \\ - j & 1 & - j \\ - 1 & 1 & - 1 \\ j & 1 & j \\ 1 & 1 & - 1 \\ - j & 1 & j \\ - 1 & 1 & 1 \\ j & 1 & - j\end{matrix} ] , and \frac{1}{2 √ 6} [ \begin{matrix}1 & 1 & 1 \\ - j & 1 & - j \\ - 1 & 1 & - 1 \\ j & 1 & j \\ j & j & - j \\ 1 & j & - 1 \\ - j & j & j \\ - 1 & j & 1\end{matrix} ] .$$

19. The wireless communication device of claim 1, wherein the one or more codebooks are specified as:
$$\frac{1}{4} [ \begin{matrix}1 & 1 & 0 & 0 \\ 1 & - 1 & 0 & 0 \\ 0 & 0 & 1 & 1 \\ 0 & 0 & 1 & - 1 \\ 1 & 1 & 0 & 0 \\ 1 & - 1 & 0 & 0 \\ 0 & 0 & - 1 & - 1 \\ 0 & 0 & - 1 & 1\end{matrix} ] and \frac{1}{4} [ \begin{matrix}1 & 1 & 0 & 0 \\ 1 & - 1 & 0 & 0 \\ 0 & 0 & 1 & 1 \\ 0 & 0 & 1 & - 1 \\ j & j & 0 & 0 \\ j & - j & 0 & 0 \\ 0 & 0 & - j & - j \\ 0 & 0 & - j & j\end{matrix} ] ,$$
$$where j is \sqrt{- 1} ; or$$
$$\frac{1}{4} [ \begin{matrix}1 & 1 & 0 & 0 \\ 0 & 0 & 0 & 0 \\ 0 & 0 & 1 & 1 \\ 0 & 0 & 0 & 0 \\ 1 & - 1 & 0 & 0 \\ 0 & 0 & 0 & 0 \\ 0 & 0 & 1 & - 1 \\ 0 & 0 & 0 & 0\end{matrix} ] and \frac{1}{4} [ \begin{matrix}1 & 1 & 0 & 0 \\ 0 & 0 & 0 & 0 \\ 0 & 0 & 1 & 1 \\ 0 & 0 & 0 & 0 \\ j & - j & 0 & 0 \\ 0 & 0 & 0 & 0 \\ 0 & 0 & j & - j \\ 0 & 0 & 0 & 0\end{matrix} ] .$$

20. The wireless communication device of claim 1, wherein the codebook is specified as:
$$\{ \frac{1}{4 √ 2} [ \begin{matrix}[ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] \\ {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ] & - {e}^{j \frac{π}{2} {i}_{2}} [ \begin{matrix}1 \\ {e}^{j \frac{π}{4} {i}_{1}} \\ {e}^{j \frac{2 π}{4} {i}_{1}} \\ {e}^{j \frac{3 π}{4} {i}_{1}}\end{matrix} ] & - {e}^{j \frac{π}{2} {i}_{2}} [ \begin{matrix}1 \\ {e}^{j \frac{π}{4} ( {i}_{1} + 2 )} \\ {e}^{j \frac{2 π}{4} ( {i}_{1} + 2 )} \\ {e}^{j \frac{3 π}{4} ( {i}_{1} + 2 )}\end{matrix} ]\end{matrix} ] \} ,$$
$$where j is \sqrt{- 1} , where {i}_{1} = 0 , … , 7 , and where {i}_{2} = 0 , 1 ; or$$
$$\frac{1}{4 √ 2} [ \begin{matrix}1 & 1 & 1 & 1 \\ 1 & j & 1 & j \\ 1 & - 1 & 1 & j \\ 1 & - j & 1 & - j \\ 1 & 1 & - 1 & 1 \\ 1 & j & - 1 & - j \\ 1 & - 1 & - 1 & 1 \\ 1 & - j & - 1 & j\end{matrix} ] , \frac{1}{4 √ 2} [ \begin{matrix}1 & 1 & 1 & 1 \\ 1 & j & 1 & j \\ 1 & - 1 & 1 & - 1 \\ 1 & - j & 1 & - j \\ j & j & - j & - j \\ j & - 1 & - j & - 1 \\ j & - j & - j & - j \\ j & 1 & - j & 1\end{matrix} ] , \frac{1}{4 √ 2} [ \begin{matrix}1 & 1 & 1 & 1 \\ j & - 1 & j & - 1 \\ - 1 & 1 & - 1 & 1 \\ - j & - 1 & - j & - 1 \\ 1 & 1 & - 1 & - 1 \\ j & - 1 & - j & 1 \\ - 1 & 1 & 1 & - 1 \\ - j & - 1 & j & 1\end{matrix} ] , \frac{1}{4 √ 2} [ \begin{matrix}1 & 1 & 1 & 1 \\ j & - 1 & j & - 1 \\ - 1 & 1 & - 1 & - 1 \\ - j & - 1 & - j & - 1 \\ j & j & - j & - j \\ - 1 & - j & 1 & j \\ - j & j & j & - j \\ 1 & - j & - 1 & j\end{matrix} ] , \frac{1}{4 √ 2} [ \begin{matrix}1 & 1 & 1 & 1 \\ - 1 & - j & - 1 & - j \\ 1 & - 1 & 1 & - 1 \\ - 1 & j & - 1 & j \\ 1 & 1 & - 1 & - 1 \\ - 1 & - j & 1 & j \\ 1 & - 1 & - 1 & 1 \\ - 1 & j & 1 & - j\end{matrix} ] , \frac{1}{4 √ 2} [ \begin{matrix}1 & 1 & 1 & 1 \\ - 1 & - j & - 1 & - j \\ 1 & - 1 & 1 & 1 \\ - 1 & j & - 1 & j \\ j & j & - j & - j \\ - j & 1 & j & - 1 \\ j & - j & - j & j \\ - j & - 1 & j & 1\end{matrix} ] , \frac{1}{4 √ 2} [ \begin{matrix}1 & 1 & 1 & 1 \\ - j & 1 & - j & 1 \\ - 1 & 1 & - 1 & 1 \\ j & 1 & j & 1 \\ 1 & 1 & - 1 & - 1 \\ - j & 1 & j & - 1 \\ - 1 & 1 & 1 & - 1 \\ j & 1 & - j & - 1\end{matrix} ] , and \frac{1}{4 √ 2} [ \begin{matrix}1 & 1 & 1 & 1 \\ - j & 1 & - j & 1 \\ - 1 & 1 & - 1 & 1 \\ j & 1 & j & 1 \\ j & j & - j & - j \\ 1 & j & - 1 & - j \\ - j & j & j & - j \\ - 1 & j & 1 & - j\end{matrix} ] .$$

21. The wireless communication device of claim 1, wherein the one or more codebooks are specified as:
$$\frac{1}{√ 6} [ \begin{matrix}1 \\ 0 \\ 0 \\ 1 \\ 0 \\ 0\end{matrix} ] , \frac{1}{√ 6} [ \begin{matrix}1 \\ 0 \\ 0 \\ j \\ 0 \\ 0\end{matrix} ] , \frac{1}{√ 6} [ \begin{matrix}1 \\ 0 \\ 0 \\ ‐ 1 \\ 0 \\ 0\end{matrix} ] , \frac{1}{√ 6} [ \begin{matrix}1 \\ 0 \\ 0 \\ - j \\ 0 \\ 0\end{matrix} ] , \frac{1}{√ 6} [ \begin{matrix}0 \\ 0 \\ 1 \\ 0 \\ 0 \\ 1\end{matrix} ] , \frac{1}{√ 6} [ \begin{matrix}0 \\ 0 \\ 1 \\ 0 \\ 0 \\ j\end{matrix} ] , \frac{1}{√ 6} [ \begin{matrix}0 \\ 0 \\ 1 \\ 0 \\ 0 \\ ‐ 1\end{matrix} ] , and \frac{1}{√ 6} [ \begin{matrix}0 \\ 0 \\ 1 \\ 0 \\ 0 \\ ‐ j\end{matrix} ] , where j is \sqrt{- 1} ; or \\ \frac{1}{√ 6} [ \begin{matrix}1 \\ 0 \\ 1 \\ 1 \\ 0 \\ 1\end{matrix} ] , \frac{1}{√ 6} [ \begin{matrix}1 \\ 0 \\ 1 \\ j \\ 0 \\ j\end{matrix} ] , \frac{1}{√ 6} [ \begin{matrix}1 \\ 0 \\ 1 \\ ‐ 1 \\ 0 \\ ‐ 1\end{matrix} ] , \frac{1}{√ 6} [ \begin{matrix}1 \\ 0 \\ 1 \\ ‐ j \\ 0 \\ ‐ j\end{matrix} ] , \frac{1}{√ 6} [ \begin{matrix}1 \\ 0 \\ j \\ 1 \\ 0 \\ j\end{matrix} ] , \frac{1}{√ 6} [ \begin{matrix}1 \\ 0 \\ j \\ j \\ 0 \\ ‐ 1\end{matrix} ] , \frac{1}{√ 6} [ \begin{matrix}1 \\ 0 \\ j \\ ‐ 1 \\ 0 \\ ‐ j\end{matrix} ] , \frac{1}{√ 6} [ \begin{matrix}1 \\ 0 \\ j \\ ‐ j \\ 0 \\ 1\end{matrix} ] , \frac{1}{√ 6} [ \begin{matrix}1 \\ 0 \\ ‐ 1 \\ 1 \\ 0 \\ ‐ 1\end{matrix} ] , \frac{1}{√ 6} [ \begin{matrix}1 \\ 0 \\ ‐ 1 \\ j \\ 0 \\ ‐ j\end{matrix} ] , \frac{1}{√ 6} [ \begin{matrix}1 \\ 0 \\ ‐ 1 \\ ‐ 1 \\ 0 \\ 1\end{matrix} ] , \frac{1}{√ 6} [ \begin{matrix}1 \\ 0 \\ ‐ j \\ 1 \\ 0 \\ - j\end{matrix} ] , \frac{1}{√ 6} [ \begin{matrix}1 \\ 0 \\ ‐ j \\ j \\ 0 \\ 1\end{matrix} ] , \frac{1}{√ 6} [ \begin{matrix}1 \\ 0 \\ ‐ j \\ - 1 \\ 0 \\ j\end{matrix} ] , and \frac{1}{√ 6} [ \begin{matrix}1 \\ 0 \\ ‐ j \\ ‐ j \\ 0 \\ ‐ 1\end{matrix} ] .$$

22. The wireless communication device of claim 1, wherein the codebook is specified as:
$$\{ \frac{1}{√ 6} [ \begin{matrix}[ \begin{matrix}1 \\ {e}^{j \frac{π}{3} {i}_{1}} \\ {e}^{j \frac{2 π}{3} {i}_{1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} ,$$
$$where j is \sqrt{- 1} , where {i}_{1} = 0 , … , 5 , and where {i}_{2} = 0 , 1 , 2 , 3 or {i}_{2} = 0 , 2 ;$$
$$\{ \frac{1}{2 √ 3} [ \begin{matrix}[ \begin{matrix}1 \\ {e}^{j \frac{π}{3} {i}_{1}} \\ {e}^{j \frac{2 π}{3} {i}_{1 , 1}}\end{matrix} ] [ \begin{matrix}1 \\ {e}^{j \frac{π}{3} {i}_{1}} \\ {e}^{j \frac{2 π}{3} {i}_{1 , 1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1 , 1}}\end{matrix} ] - {e}^{j \frac{π}{2} {i}_{2}} [ \begin{matrix}1 \\ {e}^{j \frac{π}{3} {i}_{1}} \\ {e}^{j \frac{2 π}{3} {i}_{1 , 1}}\end{matrix} ]\end{matrix} ] \} ; \{ \frac{1}{3 √ 2} [ \begin{matrix}[ \begin{matrix}1 \\ {e}^{j \frac{π}{3} {i}_{1}} \\ {e}^{j \frac{2 π}{3} {i}_{1}}\end{matrix} ] [ \begin{matrix}1 \\ {e}^{j \frac{π}{3} ( {i}_{1} + 2 )} \\ {e}^{j \frac{2 π}{3} ( {i}_{1} + 2 )}\end{matrix} ] [ \begin{matrix}1 \\ {e}^{j \frac{π}{3} {i}_{1}} \\ {e}^{j \frac{2 π}{3} {i}_{1}}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ] - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ]\end{matrix} ] \} ;$$
$$or$$
$$\{ \frac{1}{2 √ 6} [ \begin{matrix}[ \begin{matrix}1 \\ {e}^{j \frac{π}{3} {i}_{1}} \\ {e}^{j \frac{2 π}{3} {i}_{1}}\end{matrix} ] [ \begin{matrix}1 \\ {e}^{j \frac{π}{3} ( {i}_{1} + 2 )} \\ {e}^{j \frac{2 π}{3} ( {i}_{1} + 2 )}\end{matrix} ] [ \begin{matrix}1 \\ {e}^{j \frac{π}{3} {i}_{1}} \\ {e}^{j \frac{2 π}{3} {i}_{1}}\end{matrix} ] [ \begin{matrix}1 \\ {e}^{j \frac{π}{3} ( {i}_{1} + 2 )} \\ {e}^{j \frac{2 π}{3} ( {i}_{1} + 2 )}\end{matrix} ] \\ {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ] - {e}^{j \frac{π}{2} {i}_{2}} [ \begin{matrix}1 \\ {e}^{j \frac{π}{3} {i}_{1}} \\ {e}^{j \frac{2 π}{3} {i}_{1}}\end{matrix} ] - {e}^{j \frac{π}{2} {i}_{2}} [ \begin{matrix}1 \\ {e}^{j \frac{π}{3} ( {i}_{1} + 2 )} \\ {e}^{j \frac{2 π}{3} ( {i}_{1} + 2 )}\end{matrix} ]\end{matrix} ] \} ,$$
$$where {i}_{1} = 0 , … , 5 , and where {i}_{2} = 0 , 1.$$

23. The wireless communication device of claim 1, wherein the one or more codebooks are specified as:
$$\frac{1}{√ 6} [ \begin{matrix}1 & 0 \\ 0 & 0 \\ 0 & 1 \\ 1 & 0 \\ 0 & 0 \\ 0 & - j\end{matrix} ] , \frac{1}{√ 6} [ \begin{matrix}1 & 0 \\ 0 & 0 \\ 0 & 1 \\ 1 & 0 \\ 0 & 0 \\ 0 & j\end{matrix} ] , \frac{1}{√ 6} [ \begin{matrix}1 & 0 \\ 0 & 0 \\ 0 & 1 \\ - j & 0 \\ 0 & 0 \\ 0 & 1\end{matrix} ] , \frac{1}{√ 6} [ \begin{matrix}1 & 0 \\ 0 & 0 \\ 0 & 1 \\ - j & 0 \\ 0 & 0 \\ 0 & - 1\end{matrix} ] , \frac{1}{√ 6} [ \begin{matrix}1 & 0 \\ 0 & 0 \\ 0 & 1 \\ - 1 & 0 \\ 0 & 0 \\ 0 & - j\end{matrix} ] , \frac{1}{√ 6} [ \begin{matrix}1 & 0 \\ 0 & 0 \\ 0 & 1 \\ - 1 & 0 \\ 0 & 0 \\ 0 & j\end{matrix} ] , \frac{1}{√ 6} [ \begin{matrix}1 & 0 \\ 0 & 0 \\ 0 & 1 \\ j & 0 \\ 0 & 0 \\ 0 & 1\end{matrix} ] , and \frac{1}{√ 6} [ \begin{matrix}1 & 0 \\ 0 & 0 \\ 0 & 1 \\ j & 0 \\ 0 & 0 \\ 0 & - 1\end{matrix} ] , where j is \sqrt{- 1} ; or \frac{1}{√ 6} [ \begin{matrix}1 & 0 \\ 0 & 0 \\ 0 & 1 \\ 1 & 0 \\ 0 & 0 \\ 0 & - 1\end{matrix} ] , \frac{1}{√ 6} [ \begin{matrix}1 & 0 \\ 1 & 0 \\ 0 & 1 \\ j & 0 \\ j & 0 \\ 0 & - j\end{matrix} ] , \frac{1}{√ 6} [ \begin{matrix}1 & 0 \\ j & 0 \\ 0 & 1 \\ 1 & 0 \\ j & 0 \\ 0 & - 1\end{matrix} ] , \frac{1}{√ 6} [ \begin{matrix}1 & 0 \\ j & 0 \\ 0 & 1 \\ j & 0 \\ - 1 & 0 \\ 0 & - 1\end{matrix} ] , \frac{1}{√ 6} [ \begin{matrix}1 & 0 \\ - 1 & 0 \\ 0 & 1 \\ 1 & 0 \\ - 1 & 0 \\ 0 & - 1\end{matrix} ] , \frac{1}{√ 6} [ \begin{matrix}1 & 0 \\ - 1 & 0 \\ 0 & 1 \\ j & 0 \\ - j & 0 \\ 0 & - j\end{matrix} ] , \frac{1}{√ 6} [ \begin{matrix}1 & 0 \\ - j & 0 \\ 0 & 1 \\ 1 & 0 \\ - j & 0 \\ 0 & - 1\end{matrix} ] , and \frac{1}{√ 6} [ \begin{matrix}1 & 0 \\ - j & 0 \\ 0 & 1 \\ j & 0 \\ 1 & 0 \\ 0 & - j\end{matrix} ] .$$

24. The wireless communication device of claim 1, wherein the one or more codebooks are specified as:
$$\frac{1}{√ 6} [ \begin{matrix}1 & 0 \\ 0 & 1 \\ 1 & 1 \\ 1 & 0 \\ 0 & - 1 \\ 1 & 0\end{matrix} ] , \frac{1}{√ 6} [ \begin{matrix}1 & 0 \\ 0 & 1 \\ 1 & 0 \\ j & 0 \\ 0 & - j \\ j & 0\end{matrix} ] , \frac{1}{√ 6} [ \begin{matrix}1 & 0 \\ 0 & 1 \\ j & 0 \\ 1 & 0 \\ 0 & - 1 \\ j & 0\end{matrix} ] , \frac{1}{√ 6} [ \begin{matrix}1 & 0 \\ 0 & 1 \\ j & 0 \\ j & 0 \\ 0 & - j \\ - 1 & 0\end{matrix} ] , \frac{1}{√ 6} [ \begin{matrix}1 & 0 \\ 0 & 1 \\ - 1 & 0 \\ 1 & 0 \\ 0 & - 1 \\ - 1 & 0\end{matrix} ] , \frac{1}{√ 6} [ \begin{matrix}1 & 0 \\ 0 & 1 \\ - 1 & 0 \\ j & 0 \\ 0 & - j \\ - j & 0\end{matrix} ] , \frac{1}{√ 6} [ \begin{matrix}1 & 0 \\ 0 & 1 \\ - j & 1 \\ 1 & 0 \\ 0 & - 1 \\ - j & 0\end{matrix} ] , and \frac{1}{√ 6} [ \begin{matrix}1 & 0 \\ 0 & 1 \\ - j & 0 \\ j & 0 \\ 0 & - j \\ 1 & 0\end{matrix} ] , where j is \sqrt{- 1} .$$

25. The wireless communication device of claim 1, wherein the one or more codebooks are specified as:
$$\frac{1}{2 √ 3} [ \begin{matrix}1 & 1 \\ 0 & 0 \\ 1 & 1 \\ 1 & - 1 \\ 0 & 0 \\ 1 & - 1\end{matrix} ] , \frac{1}{2 √ 3} [ \begin{matrix}1 & 1 \\ 0 & 0 \\ 1 & 1 \\ j & - j \\ 0 & 0 \\ j & - j\end{matrix} ] , \frac{1}{2 √ 3} [ \begin{matrix}1 & 1 \\ 0 & 0 \\ j & j \\ 1 & - 1 \\ 0 & 0 \\ j & - j\end{matrix} ] , \frac{1}{2 √ 3} [ \begin{matrix}1 & 1 \\ 0 & 0 \\ j & j \\ j & - j \\ 0 & 0 \\ 1 & 1\end{matrix} ] , \frac{1}{2 √ 3} [ \begin{matrix}1 & 1 \\ 0 & 0 \\ 1 & - 1 \\ 1 & - 1 \\ 0 & 0 \\ - 1 & 1\end{matrix} ] , \frac{1}{2 √ 3} [ \begin{matrix}1 & 1 \\ 0 & 0 \\ - 1 & - 1 \\ j & - j \\ 0 & 0 \\ - j & j\end{matrix} ] , \frac{1}{2 √ 3} [ \begin{matrix}1 & 1 \\ 0 & 0 \\ - j & - j \\ 1 & - 1 \\ 0 & 0 \\ - j & j\end{matrix} ] , and \frac{1}{2 √ 3} [ \begin{matrix}1 & 1 \\ 0 & 0 \\ - j & - j \\ j & - j \\ 0 & 0 \\ 1 & - 1\end{matrix} ] , where j is \sqrt{- 1} .$$

26. The wireless communication device of claim 1, wherein the one or more codebooks are specified as:
$$\frac{1}{√ 6} [ \begin{matrix}1 & 0 & 0 \\ 0 & 1 & 0 \\ 0 & 0 & 1 \\ 1 & 0 & 0 \\ 0 & j & 0 \\ 0 & 0 & - 1\end{matrix} ] , \frac{1}{√ 6} [ \begin{matrix}1 & 0 & 0 \\ 0 & 1 & 0 \\ 0 & 0 & 1 \\ j & 0 & 0 \\ 0 & - 1 & 0 \\ 0 & 0 & - j\end{matrix} ] , \frac{1}{√ 6} [ \begin{matrix}1 & 0 & 0 \\ 0 & 1 & 0 \\ 0 & 0 & 1 \\ - 1 & 0 & 0 \\ 0 & - j & 0 \\ 0 & 0 & 1\end{matrix} ] , and \frac{1}{√ 6} [ \begin{matrix}1 & 0 & 0 \\ 0 & 1 & 0 \\ 0 & 0 & 1 \\ - j & 0 & 0 \\ 0 & 1 & 0 \\ 0 & 0 & j\end{matrix} ] , where j is \sqrt{- 1} ; or \frac{1}{√ 6} [ \begin{matrix}1 & 0 & 0 \\ 0 & 0 & 0 \\ 0 & 1 & 0 \\ 1 & 0 & 0 \\ 0 & 0 & 0 \\ 0 & 0 & 1\end{matrix} ] and \frac{1}{√ 6} [ \begin{matrix}1 & 0 & 0 \\ 0 & 0 & 0 \\ 0 & 1 & 0 \\ - 1 & 0 & 0 \\ 0 & 0 & 0 \\ 0 & 0 & 1\end{matrix} ] .$$

27. The wireless communication device of claim 1, wherein the one or more codebooks are specified as:
$$\frac{1}{√ 6} [ \begin{matrix}1 & 0 & 0 \\ 1 & 0 & 0 \\ 0 & 1 & 0 \\ 1 & 0 & 0 \\ 1 & 0 & 0 \\ 0 & 0 & 1\end{matrix} ] , \frac{1}{√ 6} [ \begin{matrix}1 & 0 & 0 \\ 1 & 0 & 0 \\ 0 & 1 & 0 \\ - 1 & 0 & 0 \\ - 1 & 0 & 0 \\ 0 & 0 & 1\end{matrix} ] , \frac{1}{√ 6} [ \begin{matrix}1 & 0 & 0 \\ j & 0 & 0 \\ 0 & 1 & 0 \\ 1 & 0 & 0 \\ j & 0 & 0 \\ 0 & 0 & 1\end{matrix} ] , and \frac{1}{√ 6} [ \begin{matrix}1 & 0 & 0 \\ j & 0 & 0 \\ 0 & 1 & 0 \\ - 1 & 0 & 0 \\ - j & 0 & 0 \\ 0 & 0 & 1\end{matrix} ] , where j is \sqrt{- 1} ; or \frac{1}{√ 6} [ \begin{matrix}1 & 0 & 0 \\ 0 & 1 & 0 \\ 1 & 0 & 0 \\ 1 & 0 & 0 \\ 0 & 0 & 1 \\ 1 & 0 & 0\end{matrix} ] , \frac{1}{√ 6} [ \begin{matrix}1 & 0 & 0 \\ 0 & 1 & 0 \\ 1 & 0 & 0 \\ - 1 & 0 & 0 \\ 0 & 0 & 1 \\ - 1 & 0 & 0\end{matrix} ] , \frac{1}{√ 6} [ \begin{matrix}1 & 0 & 0 \\ 0 & 1 & 0 \\ j & 0 & 0 \\ 1 & 0 & 0 \\ 0 & 0 & 1 \\ j & 0 & 0\end{matrix} ] , and \frac{1}{√ 6} [ \begin{matrix}1 & 0 & 0 \\ 0 & 1 & 0 \\ j & 0 & 0 \\ - 1 & 0 & 0 \\ 0 & 0 & 1 \\ - j & 0 & 0\end{matrix} ] .$$

28. The wireless communication device of claim 1, wherein the one or more codebooks are specified as:
$$\frac{1}{3 √ 2} [ \begin{matrix}1 & 1 & 1 \\ 0 & 0 & 0 \\ 1 & - 1 & 1 \\ 1 & 1 & - 1 \\ 0 & 0 & 0 \\ 1 & - 1 & - 1\end{matrix} ] , \frac{1}{3 √ 2} [ \begin{matrix}1 & 1 & 1 \\ 0 & 0 & 0 \\ 1 & - 1 & 1 \\ j & j & - j \\ 0 & 0 & 0 \\ j & - j & - j\end{matrix} ] , \frac{1}{3 √ 2} [ \begin{matrix}1 & 1 & 1 \\ 0 & 0 & 0 \\ - 1 & 1 & - 1 \\ 1 & 1 & - 1 \\ 0 & 0 & 0 \\ - 1 & 1 & 1\end{matrix} ] , and \frac{1}{3 √ 2} [ \begin{matrix}1 & 1 & 1 \\ 0 & 0 & 0 \\ - 1 & 1 & - 1 \\ j & j & - j \\ 0 & 0 & 0 \\ - j & j & j\end{matrix} ] , where j is \sqrt{- 1} .$$

29. The wireless communication device of claim 1, wherein the one or more codebooks are specified as:
$$\{ \frac{1}{√ 6} [ \begin{matrix}1 & 0 & 0 & 0 \\ 0 & 1 & 0 & 0 \\ 0 & 0 & 1 & 0 \\ 1 & 0 & 0 & 0 \\ 0 & - 1 & 0 & 0 \\ 0 & 0 & 0 & 1\end{matrix} ] , \frac{1}{√ 6} [ \begin{matrix}1 & 0 & 0 & 0 \\ 0 & 1 & 0 & 0 \\ 0 & 0 & 1 & 0 \\ j & 0 & 0 & 0 \\ 0 & - j & 0 & 0 \\ 0 & 0 & 0 & 1\end{matrix} ] \} or \{ \frac{1}{2 √ 3} [ \begin{matrix}1 & 1 & 0 & 0 \\ 0 & 0 & 0 & 0 \\ 0 & 0 & 1 & 1 \\ 1 & - 1 & 0 & 0 \\ 0 & 0 & 0 & 0 \\ 0 & 0 & 1 & - 1\end{matrix} ] , \frac{1}{2 √ 3} [ \begin{matrix}1 & 1 & 0 & 0 \\ 0 & 0 & 0 & 0 \\ 0 & 0 & 1 & 1 \\ j & - j & 0 & 0 \\ 0 & 0 & 0 & 0 \\ 0 & 0 & j & - j\end{matrix} ] \} , where j is \sqrt{- 1} .$$

30. The wireless communication device of claim 1, wherein the one or more codebooks are specified as:
$$\{ \frac{1}{2 √ 3} [ \begin{matrix}1 & 1 & 0 & 0 \\ 0 & - 1 & 0 & 0 \\ 0 & 0 & 1 & 1 \\ 1 & 1 & 0 & 0 \\ 1 & - 1 & 0 & 0 \\ 0 & 0 & 1 & - 1\end{matrix} ] , \frac{1}{2 √ 3} [ \begin{matrix}1 & 1 & 0 & 0 \\ 0 & - 1 & 0 & 0 \\ 0 & 0 & 1 & 1 \\ j & j & 0 & 0 \\ j & - j & 0 & 0 \\ 0 & 0 & j & - j\end{matrix} ] \} or \{ \frac{1}{2 √ 6} [ \begin{matrix}1 & 1 & 1 & 1 \\ 0 & 0 & 0 & 0 \\ 1 & - 1 & 1 & - 1 \\ 1 & 1 & - 1 & - 1 \\ 0 & 0 & 0 & 0 \\ 1 & - 1 & - 1 & 1\end{matrix} ] , \frac{1}{2 √ 6} [ \begin{matrix}1 & 1 & 1 & 1 \\ 0 & 0 & 0 & 0 \\ 1 & - 1 & 1 & - 1 \\ j & j & - j & - j \\ 0 & 0 & 0 & 0 \\ j & - j & - j & j\end{matrix} ] \} , where j is \sqrt{- 1} .$$
